(19) United States
(12) Patent Application Publication
(10) Pub. No.: US 2022/0276175 A1
(43) Pub. Date: Sep. 1, 2022

(54) DEVICES FOR INSPECTING ADEQUATE EXPOSURE OF A TISSUE SAMPLE TO A TREATMENT MEDIUM AND METHODS AND USES THEREFOR

(71) Applicants: Danoush Hosseinzadeh, Toronto (CA); Pathcore Inc., Toronto (CA)

(72) Inventors: Danoush Hosseinzadeh, Toronto, Ontario (CA); Natali Yakeemovich, Toronto, Ontario (CA)

(73) Assignees: Danoush Hosseinzadeh, Toronto, ON (CA); Pathcore Inc., Toronto, ON (CA)

(21) Appl. No.: 17/622,746

(22) PCT Filed: Jun. 26, 2020
(86) PCT No.: PCT/CA2020/050890

§ 371 Date: Dec. 24, 2021

(30) Foreign Application Priority Data
Jun. 26, 2019 (SE) 19507938

(51) Int. Cl. G01N 21/78; C09D 131/04; B01L 3/12; B01L 3/00

(52) U.S. Cl. CPC G01N 21/78; C09D 131/04; B01L 3/12; B01L 3/50; B01L 2200/0647; B01L 2300/0822

(57) ABSTRACT

Provided are devices for measuring the exposure of a tissue sample to a treatment medium, wherein the device provides for inspection without direct inspection of the tissue sample. The inspection may comprise visual inspection of the device. Treatment containers comprising these devices and methods of use of the devices and treatment containers are also provided.

### TECHNICAL FIELD

This invention relates to the field of quality assurance in pathology and more particularly to tissue sampling, tissue fixation and/or tissue processing and devices for inspecting tissue samples in order to determine if adequate exposure of the tissue sample to a treatment medium has or has not been achieved.

### BACKGROUND

United States patent application publication number 2008/0038771 discloses methods for identifying Quantifiable Internal Reference Standards (QIRS) for immunohistochemistry (IHC). Also disclosed are methods for using QIRS to quantify test antigens in IHC.

United States patent application publication number 2010/0329535 discloses methods, systems and computer program products for normalizing histology slide images. A color vector for pixels of the histology slide images is determined. An intensity profile of a stain for the pixels of the histology slide images is normalized. Normalized image data of the histology slide images is provided including the color vector and the normalized intensity profile of a stain for the pixels of the histology slide images.

U.S. Pat. No. 8,023,714 discloses that a portion of imagery data is obtained from a digital slide and a protocol of image analysis/diagnostic tasks is performed on the portion of imagery data by a pathologist or an image analysis module. The result of each task (e.g., success or no success) is recorded and a score is determined for the portion of the imagery data. Multiple portions of imagery data from the digital slide are analyzed and scored and the various scores from the multiple portions of imagery data are calculated to determine an overall score for the digital slide. Regions of the digital slide can be scored separately. Multiple rounds of scoring (by different pathologists and/or different image analysis algorithms) may be employed to increase the accuracy of the score for a digital slide or region thereof.

U.S. Pat. No. 8,885,900 discloses systems and methods for improving quality assurance in pathology using automated quality assessment and digital image enhancements on digital slides prior to analysis by the pathologist. A digital pathology system (slide scanning instrument and software) creates, assesses and improves the quality of a digital slide. The improved digital slide image has a higher image quality that results in increased efficiency and accuracy in the analysis and diagnosis of such digital slides when they are reviewed on a monitor by a pathologist. These improved digital slides yield a more objective diagnosis than reading the corresponding glass slide under a microscope.

### SUMMARY

This invention is based, at least in part, on the identification that tissue samples may not be adequately exposed to treatment mediums and that such inadequate exposure is not readily identified until the tissue sample is rendered unsuitable for its intended purpose.

In illustrative embodiments there is provided a device for measuring an exposure of a tissue sample to a treatment medium, wherein the device provides for inspection without direct inspection of the tissue sample.

In illustrative embodiments there is provided a device for measuring an exposure of a tissue sample to a treatment medium, wherein visual inspection of the device after the device and the tissue sample are contacted with the treatment medium provides for measuring the exposure without direct inspection of the tissue sample.

In illustrative embodiments there is provided a device described herein wherein the inspection comprises a perceivable colour change in the device after the exposure of the tissue sample to the treatment medium is adequate.

In illustrative embodiments there is provided a device for measuring an adequate exposure of a tissue sample to a treatment medium, wherein visual inspection of the device after the device and the tissue sample are contacted with the treatment medium provides for measuring the adequate exposure without direct inspection of the tissue sample, the device comprising: a) a compound operable to change a perceived colour of the device when the compound is adequately exposed to the treatment medium; b) a surface for supporting the compound; and c) a transparent body connected to the surface, the transparent body being impenetrable by the treatment medium and being operable to control contact between the compound and the treatment medium when in the treatment container, wherein the compound is protected from complete immediate exposure to the treatment medium by being between the surface and the transparent body.

In illustrative embodiments there is provided a device described herein wherein: a) the compound comprises at least one high dispersed colloidal particle component selected from the group consisting of Silica, Alumina, Titania, mixed oxides, and mixtures thereof and the compound further comprises the at least one component mixed with a polymer; and b the surface for supporting the compound is coloured to provide a contrast to enhance a colour change effected by the compound when the compound is adequately exposed to the treatment medium and the change to the perceived colour of the device is effected by an increase in the transparency of the compound.

In illustrative embodiments there is provided a device described herein wherein the polymer is selected from the group consisting of: a polyvinylpyrrolidone (PVP), a poly-butyl-methacrylate (PBMA), a polypropylene, and a complex copolymer.

In illustrative embodiments there is provided a device described herein wherein the polymer is a complex of poly-vinyl-butyral co-vinyl-alcohol-co-vinyl acetate (PVB-PVA).

In illustrative embodiments there is provided a device described herein wherein the transparent body comprises a hole.

In illustrative embodiments there is provided a device described herein wherein the surface for supporting the compound is a polymeric film selected from the group consisting of: polyvinyl, polyethylene, polypropylene or copolymers.

In illustrative embodiments there is provided a device described herein wherein the surface for supporting the compound is coloured to provide a contrast to enhance the perception of a colour change effected by the compound when the compound is exposed to the treatment medium and the change to the perceived colour of the device is effected by an increase in the transparency of the compound.

In illustrative embodiments there is provided a device described herein wherein the surface is red.

In illustrative embodiments there is provided a device described herein wherein the surface is a surface of a treatment container.

In illustrative embodiments there is provided a device described herein wherein the transparent body is glass.

In illustrative embodiments there is provided a device described herein wherein the transparent body is a polymeric film.

In illustrative embodiments there is provided a device described herein wherein the polymeric film is selected from the group consisting of: a polyvinylpyrrolidone (PVP), a poly-butyl-methacrylate (PBMA), a polypropylene, and a complex copolymer.

In illustrative embodiments there is provided a device described herein wherein the polymeric film is a complex of poly-vinyl-butyral co-vinyl-alcohol-co-vinyl acetate (PVB-PVA).

In illustrative embodiments there is provided a device for measuring an adequate exposure of a tissue sample to a treatment medium, wherein visual inspection of the device after the device and the tissue sample are contacted with the treatment medium provides for measuring the adequate exposure without direct inspection of the tissue sample, the device comprising: a) a foam layer; b) a film layer coating at least a portion of the outside of the foam layer; c) a density increasing agent; d) a softening agent; and e) at least one foam stabilizing agent.

In illustrative embodiments there is provided a device described herein wherein the adequate exposure is indicated by a change in a position of the device relative to a top surface of the treatment medium.

In illustrative embodiments there is provided a device described herein wherein the foam layer comprises gelatin.

In illustrative embodiments there is provided a device described herein the film layer comprises gelatin.

In illustrative embodiments there is provided a device described herein wherein the density increasing agent is selected from at least one of the group consisting of Aluminosilicate, and Titanium Dioxide.

In illustrative embodiments there is provided a device described herein wherein the softening agent comprises at least one selected from the group consisting of: polypropylene glycol, and glycerin.

In illustrative embodiments there is provided a device described herein wherein the foam stabilizing agent comprises Sodium Dodecyl Sulfonate, N-Hydroxysuccinimde, and 1-ethyl-3-(3-dimethylaminoproply)carbodiimide.

In illustrative embodiments there is provided a device described herein wherein a) the foam layer comprises gelatin; b) the film layer comprises gelatin; c) the density increasing agent is selected from at least one of the group consisting of Aluminosilicate, and Titanium Dioxide; d) the softening agent comprises at least one selected from the group consisting of: polypropylene glycol, and glycerin; and e) the foam stabilizing agent comprises Sodium Dodecyl Sulfonate, N-Hydroxysuccinimde, and 1-ethyl-3-(3-dimethylaminoproply)carbodiimide.

In illustrative embodiments there is provided a device for measuring an exposure of a tissue sample to a treatment medium, wherein visual inspection of the device after the device and the tissue sample are contacted with the treatment medium provides for measuring the exposure without direct inspection of the tissue sample and the visual inspection comprises a change in a position of the device relative to a top surface of the treatment medium.

In illustrative embodiments there is provided a device described herein wherein the treatment medium comprises at least one of formalin, ethanol or xylene.

In illustrative embodiments there is provided a method for visually determining that a tissue sample has been adequately exposed to a treatment medium, the method comprising: a) adding a tissue sample to a treatment container; b) adding a device described herein to the treatment container; c) adding the treatment medium to the treatment container; and d) exposing the tissue sample and the device to the treatment medium at about the same time and until the device provides a visual indication that adequate exposure has been attained.

In illustrative embodiments there is provided a method described herein wherein the treatment container is provided with the treatment medium already within the treatment container prior to adding the tissue sample and the device.

In illustrative embodiments there is provided a method described herein wherein the device is included as part of the treatment container and upon adding the tissue sample, the device is exposed to the treatment medium and about the same time as the tissue sample.

In illustrative embodiments there is provided a method described herein wherein the treatment container comprises the device attached to a surface of the treatment container, which surface is exposed to the treatment medium when the tissue sample is added.

In illustrative embodiments there is provided a method described herein wherein the method further comprises inspection of the device by a computerized method wherein an output of a digital image capture device is further processed by a computer to quantify a change in the device, thereby determining adequate exposure.

In illustrative embodiments there is provided a treatment container for exposing a tissue sample to a treatment medium, the treatment container comprising a device described herein.

In illustrative embodiments there is provided a treatment container described herein described herein wherein the device is affixed to an inside surface of the treatment container.

In illustrative embodiments there is provided a treatment container described herein wherein the treatment container is a flask, a Petri dish, a test tube, bottle, jar, tub, bucket, cassette, a specially designed container for tissue sample processing, a specially designed container for tissue sample handling, or a specially designed container for tissue sample storage.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

In drawings which illustrate embodiments of the invention,

FIG. 1A is an illustration of an embodiment of a device according to the present invention prior to exposure to a treatment medium.

FIG. 1B is an illustration of an embodiment of a device according to the present invention after exposure to a treatment medium.

FIG. 2A is an illustration of a profile view of an embodiment of a device according to the present invention.

FIG. 2B is an illustration of a bottom view of an embodiment of a device according to the present invention.

### DETAILED DESCRIPTION

In illustrative embodiments of the present invention there is provided a device for measuring the exposure of a tissue sample to a treatment medium, wherein the device provides for inspection without direct inspection of the tissue sample.

As used herein, the phrase “tissue sample” or “tissue specimen” refers to a solid portion and/or a soft portion of an organ of human or non-human origin that is to be processed in a manner that allows for it to be further analyzed and/or processed and/or tested. Body fluids, such as blood, urine, synovial fluid, sputum, pus, effusions, pelvic washings, peritoneal or biliary brushings and other body fluids are generally termed “cytology samples” or “cytology specimens”. Cytology samples/specimens are also considered to be of tissue origin, but as used herein, such fluid samples are explicitly excluded from the definition of “tissue sample” when the sample is primarily in fluid form. In many cases, such fluids are a part of a solid and/or soft portion of a biological body and since they often contain cells representing the organ from which they were removed, the fluids do comprise a portion of a “tissue sample”, but largely in disaggregated form and do not involve microtomy. In contrast, “tissue samples” as used herein retain organ-specific architecture and spatial relationships. Examples of “tissue samples” as used herein include, but are not limited to, organs or portions of organs, such as liver, parts of the gastrointestinal tract, lungs, heart, liver, spleen, lymph nodes, kidneys, genitourinary organs, bones, muscles, fat, collagen, connective tissue, tendons, skin, blood vessels, masses (cancerous or otherwise), portions thereof, and/or mixtures thereof.

As used herein “fluid” refers to a substance that is in liquid or gaseous form and has no fixed shape. The phrase “mostly fluid” refers to a substance that behaves like a fluid in that it has no fixed shape, but may have non-fluid portions within the substance, such as particulate substances, and/or suspended solids.

As used herein the phrase “direct inspection” refers to an analysis and/or measurement of a target, for example a tissue sample, that requires the target to be a part of the inspection process. “Direct inspection” often requires a physical interaction with the target, but need not necessarily require physical interaction. Examples of non-physical interactions that would be considered “direct inspection” include, but are not limited to, ultra-sound, magnetic resonance imaging (MRI) and other imaging techniques. Such imaging techniques constitute “direct inspection” when imaging of the target is undertaken. “Indirect inspection”, as used herein, refers to the analysis and/or measurement of something other than the target in order to obtain and/or infer information about the target. The target is often a tissue sample. Indirect inspection allows for information to be obtained and/or inferred about the target while minimizing the potential for contamination of and/or mechanical damage to the target.

As used herein, the phrase “visual inspection” refers to direct inspection and/or indirect inspection of a target using the visible part of the electromagnetic spectrum as an input to the inspecting device. The inspecting device may be an eye, a camera and or any visual light detecting device or sensor. The device may or may not be connected to other electronic equipment that may be programmed to analyze the results. In some cases, the device will display an image on a screen and/or on a solid medium, such as photographic paper, which image is then analyzable by a human. In some cases, the detectable change in the visible spectrum is a change in the relative locations of two objects with respect to one another. For example, the location of an object relative to a top surface of the treatment medium may change from being located at or near the top surface in a floating manner at the beginning of treatment with the object sinking lower towards the end of treatment or vice versa. In some cases, the detectable change in the visible spectrum is a change in the shape of an object at the end of a treatment when compared to the shape of the object at the beginning of the treatment. In some cases, the detectable change in the visible spectrum is a change in colour or a perceivable change in colour of an object.

As used herein, the phrase “perceivable colour change” refers to a change to the wavelengths detectable in the range of the electromagnetic spectrum from about 390 nm to about 700 nm. Such a “perceivable colour change” may be the result of a direct change in colour of a component, and/or may be the result from a change in the transparency of a component which then may permit the colour of a second component to become more perceivable or to become less perceivable.

As used herein, the phrase “treatment medium” refers to a fluid and/or mostly fluid environment that tissue samples may be exposed to in order to facilitate further analysis of tissue samples. Treatment mediums may be used for transportation of a tissue sample, for preservation of a tissue sample and/or for altering the composition of a tissue sample so that the tissue sample is in a condition that renders it suitable for a next step that the tissue sample is to be subjected to. Treatment mediums are well known to a person of skill in the art, see for example, Histopathology: Methods and Protocols (Methods in Molecular Biology) 2014th Edition by Christina E. Day (Editor) Often treatment mediums comprise a variety of different components, but are often referred to by the active component of the treatment medium. For example, an “ethanol treatment medium” may not be 100% ethanol, but rather may comprise some portion of ethanol in a mixture with one or more other components. Examples of treatment mediums include, but are not limited to, ethanol treatment mediums, xylene treatment mediums, formalin treatment mediums, and mixtures thereof.

As used herein, the phrase “adequate exposure time” and/or “adequate exposure” refers to the amount of exposure, often in terms of time, that results in a tissue sample being suitable for use for a next step in a process. Such exposure changes depending on a number of factors, such as, but not limited to, the type of treatment medium, the concentration of the treatment medium, the size of the tissue sample, the shape of the tissue sample, the temperature during exposure, the method of exposure, etc. Typical “adequate exposure” and/or “adequate exposure time” are understood to a person of skill in the art for a given step in a tissue sample process. See, for example, Bancroft's Theory and Practice of Histological Techniques: Expert Consult: by Kim S Suvarna MBBS BSc FRCP FRCPath (Author), Christopher Layton PhD (Author), John D. Bancroft (Author); Biological Staining Methods by Gurr, G. T. Published by George T. Gurr Division, 1969; and Conn's Biological Stains. A Handbook of Dyes, Stains and Flurochromes for Use in Biology and Medicine, 10th edition. Ed. by R. W. Horobin and J. A. Kiernan. (Pp. xvi+555, some figures.) Bios Scientific Publishers, Oxford, U K. 2002. ISBN: 185996 009 5.

For example, the standard treatment process for a typical biopsy tissue sample, is to expose the sample to a fixative composed of neutral buffered 10% formalin, which is 3.7% formaldehyde in water with 1% methanol, for 8-24 hours. Fixation is an essential step in processing of biopsy tissue samples for examination by optical microscopy and for archival preservation. Fixation helps to preserve cellular architecture and composition of cells in the tissue to allow them to withstand subsequent processing. Fixation also preserves the proteins, carbohydrate and other bio-active moieties in their spatial relationship to the cell, so that they can be studied after subsequent tissue processing, paraffin embedding, microtomy and staining. Formaldehyde is an aldehyde fixative which preserves tissue components by cross-linking proteins. (Thavarajah R, Mudimbaimannar VK, Elizabeth J, Rao UK, Ranganathan K. Chemical and physical basics of routine formaldehyde fixation. J Oral Maxillofac Pathol. 2012; 16(3):400-5).

The fixed tissue is then processed in an automated tissue processor in order to remove water and fat and then impregnating it with paraffin prior to embedding in paraffin blocks. The processing steps include sequential dehydration from an aqueous environment to an alcohol environment (most often ethanol), subsequent replacement of the ethanol by xylene (or xylene substitute) in a process referred to as clearing, and replacement of the xylene with paraffin (impregnation) (Hewitt SM, Lewis FA, Cao Y, Conrad R C, Cronin M, Danenberg K D, Goralski T J, Langmore J P, Raja R G, Williams P M, Palma J F, Warrington J A. Tissue handling and specimen preparation in surgical pathology: issues concerning the recovery of nucleic acids from formalin-fixed, paraffin-embedded tissue. Arch Pathol Lab Med. 2008 December; 132(12):1929-35).

The usual steps in the tissue processing protocol are as follows:
1. 70% ethanol for 1 hour.
2. 95% ethanol (95% ethanol/5% methanol) for 1 hour.
3. First absolute ethanol for 1 hour.
4. Second absolute ethanol 1½ hours.
5. Third absolute ethanol 1½ hours.
6. Fourth absolute ethanol 2 hours.
7. First clearing agent (xylene or substitute) 1 hour.
8. Second First clearing agent (Xylene or substitute) 1 hour.
9. First wax (Paraplast X-tra) at 58° C. for 1 hour.
10. Second wax (Paraplast X-tra) at 58° C. 1 hour.

These steps can be modified in rapid processing protocols and the exposure times set out are typical exposures times and are suitable for many tissue samples, but not all tissue samples will necessarily achieve “adequate exposure”, particularly if tissue sample is large and/or the treatment medium is not fresh.

In some embodiments, “adequate exposure” refers to achieving at least a baseline amount of exposure or more. In other embodiments, “adequate exposure” refers to not exceeding at most a maximum amount of exposure. In still other embodiments, “adequate exposure” refers to being between a baseline amount of exposure and a maximum amount of exposure. A device of the present invention may be configured to measure a threshold value or provide a more discrete value within a range.

In some embodiments, adequate exposure refers to whether or not the treatment medium at a particular concentration, has had sufficient time to adequately penetrate the tissue sample. In some circumstances, treatment mediums may be used to treat tissue samples more than once. In such circumstances, it is expected that the concentration of treatment medium will change, often reduce, with each subsequent use. Some embodiments of the present invention may provide for inspection of adequate exposure irrespective of the starting or ending concentration of the treatment medium. In other words, some embodiments of the present invention are adapted to provide a suitable visual cue only when the treatment medium has sufficiently penetrated the sample, which penetration is, at least, treatment-medium-concentration dependent and not solely time dependent.

In general, materials for use in devices according to the present invention should not chemically interact, or at most minimally chemically interact, with the tissue sample. Further, materials in devices of the present invention should be robust enough and/or contained sufficiently so that the tissue sample is not adversely contaminated with materials from the device.

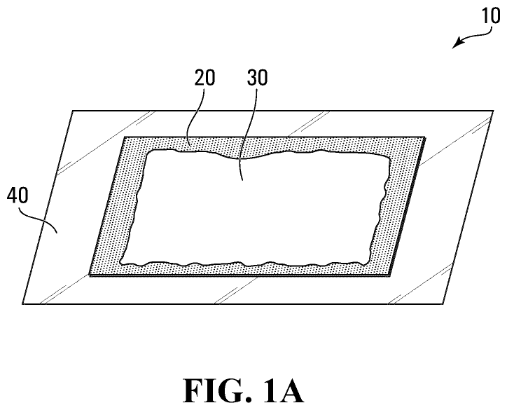

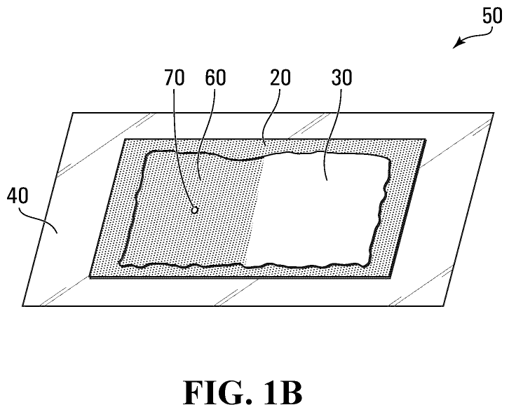

Referring to FIG. 1A, illustrative embodiments of the present provide a device shown generally at 10, that comprises a compound 30 operable to change a perceived colour of the device when the compound is exposed to the treatment medium. The device further comprises a surface 20 for supporting the compound 30, and a transparent body 40 connected to the surface 20. The compound 30 is prevented from complete immediate exposure to the treatment medium by being between the surface 20 and the body 40. The body 40 is impenetrable by the treatment medium and the body 40 is operable to control contact between the compound 30 and the treatment medium when in the treatment container.

The surface 20 for supporting the compound 30 supports the compound 30 physically by maintaining the compound 30 in a consistent physical location relative to the surface 20. The surface 20 should not repel the compound 30. Suitable materials may be selected, in part, by considering the properties of the compound 30 operable to change a perceived colour of the device. The surface 20 may simply be a material that provides platform on which the compound 30 rests with no chemical interaction between the compound 30 and the surface 20. Alternatively, the surface 20 may be adapted to chemically bond to the compound 30 in a manner that does not render the compound 30 inoperable.

The surface 20 for supporting the compound 30 may be made from any material that is suitable for use when treating a tissue sample with a treatment medium. The material should not chemically interact, or at most minimally chemically interact, with any of the tissue sample, the treatment medium or the compound 30 operable to change a perceived colour of the device. Further, the surface 20 should be impenetrable to the treatment medium as well as to the compound 30 operable to change the perceived colour of the device. Some non-limiting examples of materials that may be suitable for use as surfaces 20 in devices of the present invention include, but are not limited to, glass, plastics, inert metals (such as surgical steel) and ceramics. In some embodiments, the surface 20 is a polymeric film. Some non-limiting examples of polymeric films include, but are not limited to, polyvinyls, polyethylenes, polypropylenes and/or copolymers. In some embodiments, the surface 20 is a surface of a treatment container, which treatment container is the container to be used to expose the tissue sample to the treatment medium.

Referring now to FIG. 1B, a device of the present invention is shown generally at 50. The surface 20 for supporting the compound 30 may be coloured to provide a contrast to enhance a colour change effected by the compound 30 when then compound 30 is exposed to the treatment medium and the change to the perceived colour of the device is effected by an increase or a decrease in the transparency of the compound 30. For example, in some embodiments, the surface 20 is coloured red and the compound 30, prior to being exposed to the treatment medium, is coloured white. In these embodiments, upon exposure of the compound 30 to the treatment medium, the compound 30 changes from white to clear (i.e. more transparent and/or translucent), thereby becoming compound 60. In these embodiments, the red colour of the surface 20 is more easily perceived when the compound 60 is clear than when the compound 30 is white. For clarity, compound 30 and compound 60 may or may not be the same compound however, in any event, compound 60 has been exposed to the treatment medium for a sufficient amount of time to change the properties the compound 30 into the properties of compound 60. In these embodiments, there is a perceivable change of colour of the device from white to red once the device is adequately exposed to a treatment medium.

The compound 30 operable to change a perceived colour of the device when the compound 30 is exposed to the treatment medium is a compound that undergoes a change when the compound is exposed to the treatment medium. In some embodiments, the compound 30 changes colour upon exposure to the treatment medium. In other embodiments, the compound 30 becomes more transparent upon exposure to the treatment medium. In other embodiments still, the compound 30 becomes less transparent upon exposure to the treatment medium.

The particular compound 30 suitable for use in a device according to the present invention may be selected depending on the type of exposure that is desired to be measured. For example, if the exposure of a tissue sample to an ethanol treatment medium or a xylene treatment medium is desired, then a compound 30 that changes transparency when exposed to ethanol or xylene, such as silica, alumina, titania, and/or mixed oxides such as aluminum silicate, and/or titania-silica, may be selected. Often, the compound 30 does not change chemically when it is exposed to the active component of the treatment medium.

In some embodiments, the compound 30 operable to change a perceived colour of the device is a mixture of two or more components. For example, a first component may be selected from silica, alumina, titania, and/or mixed oxides such as aluminum silicate, and/or titania-silica. A second component may be a different selection from the same group. Further, the compound 30 may be a first component (and/or one or more second components) mixed with a polymer. The polymer may be selected from a polyvinylpyrrolidone (PVP, poly-1-ethenylpyrrolidin-2-one), a poly-butyl-methacrylate (PBMA, poly-butyl 2-methylprop-2-enoate), and/or a complex copolymer such as poly-vinyl-butyral co-vinyl-alcohol-co-vinyl acetate (PVB-PVA). Some specific, non-limiting examples include but are not limited to, PBMA-2, PBMA-4, PBMA-6, PBMA-8, PVA-PVB-2, PVA-PVB-4, PVA-PVB-6, PVA-PVB-8, PVP-2, and/or PVP-4. In some embodiments, the compound 30 is a mixture of 1) one or more components selected from the group consisting of: silica, alumina, titania, and/or mixed oxides such as aluminum silicate, and/or titania-silica; and 2) one or more polymers selected from the group consisting of: a polyvinylpyrrolidone (PVP), a poly-butyl-methacrylate (PBMA), and/or a complex copolymer such as poly-vinyl-butyral co-vinyl-alcohol-co-vinyl acetate (PVB-PVA), PBMA-2, PBMA-4, PBMA-6, PBMA-8, PVA-PVB-2, PVA-PVB-4, PVA-PVB-6, PVA-PVB-8, PVP-2, and/or PVP-4.

The compound 30 operable to change a perceived colour of the device may enable some devices of the present invention to measure a duration of time of the exposure of a tissue sample to a treatment medium. It is also possible that the compound 30 may enable some devices of the present invention to measure the penetration of the treatment medium into the tissue sample. The compound 30 may enable devices to measure the penetration of the treatment medium provided that the compound 30 changes upon exposure to the active component of the treatment medium. The duration of time of the exposure of a tissue sample to a treatment medium may also be enabled by a compound 30 that changes upon exposure to the active component of the treatment medium as well as by a compound 30 that changes upon exposure to chemicals other than the active component of the treatment medium. The compound 30, when selected to change upon exposure to the active component of the treatment medium, may enable some devices of the present invention to measure both time and penetration.

The compound 30 operable to change a perceived colour of the device is prevented from complete and immediate exposure to the treatment medium by being between the surface 20 and the transparent body 40 connected to the surface 20. The transparent body 40 is impenetrable by the treatment medium and in some embodiments, the body 40 is operable to control contact between the compound 30 and the treatment medium. In other embodiments, the surface 20 is operable to control contact between the compound 30 and the treatment medium. In those embodiments in which the surface 20 is operable to control contact between the compound 30 and the treatment medium, the surface 20 functionally replaces the role of the transparent body 40 and the transparent body 40 functionally replaces the role of the surface 20.

In some embodiments, the compound 30 operable to change a perceived colour of the device is prevented from complete and immediate exposure to the treatment medium by having a component mixed into a polymer, thereby creating a compound 30 which is a matrix in which the component is exposed to the treatment medium through small capillary-like holes and/or pores in the matrix. The small capillary-like holes and/or pores may be formed by mixing the component with the polymer and allowing the component-polymer mixture to dry into a compound operable to change a perceived colour of the device.

The transparent body 40 connected to the surface 20 may be any material that is transparent so as to enable detection of a perceived colour change. As used herein with respect to the transparent body 40 connected to the surface 20 the word ‘transparent’ means that at least a portion of the electromagnetic spectrum from about 390 nm to about 700 nm is able to pass through the transparent body 40. The portion of the electromagnetic spectrum that is able to pass through the transparent body 40 should enable the perceivable change in colour to be detected and not hide the perceivable change in colour. In some embodiments, the transparent body 40 is a polymeric film, glass or a mixture of polymeric films. In some embodiments, the transparent body 40 is a polymeric film such as, but not limited to, a polycarbonate film, a polyvinylpyrrolidone (PVP), a poly-butyl-methacrylate (PBMA), or complex copolymers such as poly-vinyl-butyral co-vinyl-alcohol-co-vinyl acetate (PVB-PVA).

The transparent body 40 is connected to the surface 20 in a manner that the treatment medium is able to penetrate the into the device such that the compound 30 may be exposed to the treatment medium. The compound 30 is exposed to the treatment medium when the treatment medium penetrates the device between the surface 20 and the body 40. The compound 30 is separated from the treatment medium such that immediate exposure of all of the compound 30 to the treatment medium is prevented. In some embodiments, suitable exposure is enabled by mixing a component and a polymer to form the compound 30. In such component-polymer compounds 30, the small capillary-like holes and/or pores may be sized so as to mimic the rate of penetration of the treatment medium into the tissue sample. Penetration time depends on a diameter of the small capillary-like pores, and/or a density of the capillary-like pores, and/or a branching of capillary-like pores. Penetration time is increased when the diameter is smaller and/or the density is smaller, and/or with increased branching. Such variables in the porous nature of the compound 30 depend, at least in part, on the compound 30 formation procedure, including, but not limited to variables such as concentration of component, foaming and application conditions. In some embodiments, the body 40 is attached to the surface 20 so that the body 40 completely covers the compound 30 and the compound 30 is only exposed to the treatment medium by penetration of the treatment medium at gaps occurring at the interface of the body 40 and the surface 20. Different types of adhesive, such as acrylic, silicone, polyurethane or combination can be used to attach body 40 to the surface 20. In some embodiments, a compartment may be provided in the device so that the body 40 can be mechanically attached to the surface 20, thereby reducing or eliminating the use of an adhesive.

In other embodiments a small hole 70 may be introduced into the transparent body 40 such that the only place where treatment medium may penetrate the device is the hole 70 in the transparent body 40. Such embodiments with a hole 70 in the transparent body 40 may be operable by observing a change of a portion of the compound 30 which portion may be the whole of the compound 30 or less than the whole of the compound 30. For example, penetration of the treatment medium to a portion of the compound 30 that is spatially most distant from the hole 70 in the transparent body 40, thereby effecting a change to that portion of the compound 30, may be required to indicate adequate exposure of the tissue sample to the treatment medium. Alternatively, a change to the portion of the compound 30 that is only half way to the spatially most distant portion from the hole 70 portion may be indicative of adequate exposure of the tissue sample to the treatment medium. This can, at least in part, be determined by selecting the distance of the spatially most distant portion of the compound 30 and/or by selecting the size of the hole 70. The larger the distance of the spatially most distant portion of the compound 30 from the hole 70 in the transparent body 40, the more time it will take for the treatment medium to penetrate the device to that portion. Similarly, if the distance is smaller, the treatment medium will penetrate to that portion in less time. Further, if the hole 70 in the transparent body 40 is bigger, then the treatment medium will penetrate the device more quickly and penetrate more slowly if the hole 70 is smaller.

In other embodiments, the transparent body 40 may be used in combination with a polymer-component compound 30. The transparent body 40 may comprise a hole 70 or may not comprise a hole 70.

Devices of the present invention comprise a surface 20 supporting the compound 30 operable to change a perceived colour with the transparent body 40 covering, at least in part, the compound 30 by being attached to the surface 20. The body 40 is attached to the surface 20 such that exposure of the compound 30 to a treatment medium is restricted from immediate and complete exposure. In some embodiments, the surface 20 is coated with the compound 30 and the body 40 is then attached to the surface 20, thereby covering the compound 30. In other embodiments, the body 40 is coated with the compound 30 and the body 40 coated with compound 30 is then attached to the surface 20. In some embodiments, the transparent body 40 and the compound 30 are the same. In embodiments where the transparent body 40 and the compound 30 are the same, the compound 30 is a mixture of a component with a polymer and the polymer is functionally equivalent to the transparent body 40.

In illustrative embodiments, devices of the present invention provide for indirect visual inspection by observing a change in a position of the device relative to a top surface of the treatment medium. For example, a device may float on the surface of a treatment medium prior to adequate exposure of the tissue sample to a treatment medium and sink, or partially sink, in a treatment medium once adequate exposure of the tissue sample to the treatment medium has been achieved. Alternatively, the device may only float once adequate exposure of the tissue sample to the treatment medium has been achieved and will sink, or partially sink, prior to adequate exposure time having been achieved.

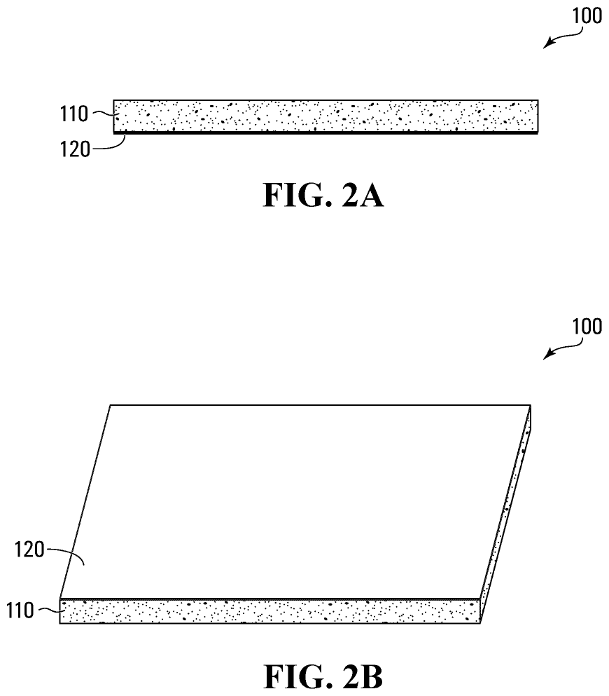

Referring to FIGS. 2A and 2B, an illustrative embodiment in which the indirect visual inspection is provided by a change in position of the device relative to a top surface of a treatment medium is shown generally at 100. Often such an embodiment will comprise:
a foam layer 110;
a film layer 120 coating at least a portion of the outside of the foam layer 110;
a density increasing agent;
a softening agent; and
at least one foam stabilizing agent.

Materials that are suitable for use as foam layers 110 in devices of the present invention may be selected from any foam that is able to increase in density by absorbing the treatment medium and/or by being exposed to the treatment medium over time and do not adversely affect or contaminate the tissue sample. Such a foam material will, at least in part, be determined by the treatment medium for which the device is to be exposed to. A foam material may be more susceptible to breaking apart in one kind of treatment medium and less susceptible to breaking apart in another treatment medium. Foam materials for use in the present invention may be selected so that they do not chemically interact, minimally chemically interact, or benignly chemically interact with both the treatment medium and the tissue sample. In some cases, the treatment medium may cause some crosslinking in foam materials and in these circumstances the crosslinking should not interfere with the ability of the foam to absorb sufficient treatment medium to provide for visual inspection of the device, such as the device sinking in the treatment medium. Further, foam materials that readily break apart are generally not suitable for use in devices of the present invention as the portions of the foam that break apart can cause contamination of the tissue sample. Examples of foam materials that may be suitable for use in devices of the present invention, include, but are not limited to: gelatin, including but not limited to fish gelatin and porcine gelatin. Treatment medium penetration rate may be regulated by adding to gelatin different types of polysaccharides such as alginate, cellulose, chitosan in different forms (sodium alginate, carboxy methyl cellulose, etc.). Some surfactants, such as sodium dodecyl sulfate, sodium lauryl ether sulfate, Triton™ X-100, etc., may also decrease medium penetration time.

Often foam materials comprise a significant volume of air and often have a low density as a result. In order to encourage exposure of the foam layer 110 to the treatment medium, a density increasing agent may be added to devices of the present invention. As used herein, a “density increasing agent” is any agent that increases the density of the device. The density increasing agent is able to encourage exposure of the foam layer 110 to the treatment medium such that the foam layer 110 is able to absorb treatment medium at a faster rate due to the increased exposure. This encouraging of exposure may be achieved by increasing the amount of the foam layer 110 for exposure to the treatment medium by the density increasing agent weighing down the device such that more of the foam layer 110 is below the top surface of the treatment medium. A density increasing agent may be added to the foam layer 110, the film layer 120 or both the foam layer 110 and the film layer 120. Density increasing agents suitable for use in devices of the present invention include, but are not limited to, aluminosilicate, titanium dioxide, etc.

A film layer 120 in devices of the present invention may act as a density increasing agent. In some embodiments, the film layer 120 may be made from the same material as the foam layer 110. In such embodiments, the film layer 120 is typically more dense and will thereby act as a density increasing agent. In other embodiments, the film layer 120 is made from a different material and in these embodiments it is often useful to select a material that is more dense than the foam material. Film layers 120 suitable for use in the present invention may be selected so that they do not chemically interact, minimally chemically interact, or benignly chemically interact with both the treatment medium and the tissue sample. Examples of materials suitable for use in devices of the present invention include, but are not limited to gelatin.

Some of the density increasing agents may, when added to some foam materials for use the present invention, cause a hardening and/or an increase in the brittleness of the foam material. Further, some treatment mediums may cause foam materials to harden and/or become more brittle. Such hardening and/or increase of brittleness may impart adverse properties to the foam material. For example, if the foam is too hard, it may not adequately absorb the treatment medium, or if the foam is too brittle, it may break apart and contaminate the tissue sample. Further, film layers of the present invention may similarly be or become hard and brittle. Such adverse properties that may be caused by the addition of the density increasing agent and/or exposure to the treatment medium may be mitigated, at least in part, by the addition of a softening agent. Examples of softening agents suitable for use in the present invention include, but are not limited to polyethylene glycol, polypropylene glycol, glycerin, and polysaccharides such as alginate, cellulose, chitosan, etc.

Softening agents for use in devices described herein may inhibit or reduce adequate foam formation. Adequate foam formation is necessary to allow the device to absorb the treatment medium over time. It is possible to mitigate, at least in part, the reduction in foam formation that may be caused by the use of softening agents by use of a stabilizing agent. Stabilizing agents may increase the amount of crosslinking during foam formation and/or stabilize the foam crosslinking, thereby increasing the absorption properties of the foam. Examples of stabilizing agents suitable for use in making devices of the present invention include, but are not limited to: Sodium Dodecyl Sulfonate, N-Hydroxysuccinimde, and 1-ethyl-3-(3-dimethylaminoproply)carbodiimide.

Illustrative embodiments of devices of the present invention may be made by following or generally adapting the general and specific procedures as set out in the Examples section of the present application.

Once a device of the present invention is prepared, it is possible to add the device to a treatment container for use to identify adequate exposure of the tissue sample to the treatment medium. The device is best be exposed to the treatment medium at about the same time as the tissue sample is exposed to the treatment medium. It is not required that the device is added to the treatment medium at exactly the same time, but the difference in time between the exposure of the device and the tissue sample to the treatment medium is best limited to less than an hour, but is dependent on the tissue sample and the treatment medium. The shorter the time difference between the exposure of the tissue sample and the device, the better the indication of adequate exposure will be. If there is to be a difference in time between the exposure of the device when compared to the exposure of the treatment medium, then it is often preferable that the device is exposed to the treatment medium after the tissue sample is exposed.

In illustrative embodiments of the present invention there is provided a treatment container for exposing a tissue sample to a treatment medium, which treatment container comprises a device as described herein. Typical treatment containers for treating tissue samples are well known to a person of skill in the art. For example, and without limitation, the treatment container may be a flask, a Petri dish, a test tube, bottle, jar, tub, bucket, cassette, or any specially designed container for tissue processing, handling or storage. In some embodiments, a device of the present invention is affixed to an inside surface of the treatment container. In other embodiments, the device is integral to the treatment container.

In illustrative embodiments of the present invention, the device is positioned in the treatment container so that it is not in contact with the treatment medium until the treatment container is opened to insert a tissue sample into the treatment container, at which time the device is then repositioned such that it is exposed to the treatment medium. For example, and without limitation, the device may be in a compartment of the treatment container and the compartment is isolated and free from the treatment medium. Upon removing a lid of the treatment container, the compartment may be automatically exposed to the treatment medium, thereby exposing the device to the treatment medium upon opening the lid of the treatment container for insertion of the tissue sample into the treatment container. For example, and without limitation, the device may be in a compartment of the treatment container and the compartment has a bottom. The bottom of the compartment is automatically removed upon removing a lid of the treatment container, thereby dropping the device into the treatment medium. In some embodiments, it may be beneficial to weight the device so that it sinks in the treatment medium. In other embodiments, the device may float on the surface of the treatment upon initial exposure to the treatment medium and hence no weighting is desired.

Illustrative embodiments of the present invention provide a method for visually determining that a tissue sample has been adequately exposed to a treatment medium. Such methods may comprise:
a) adding a tissue sample to a treatment container;
b) adding a device of the present invention to the treatment container;
c) adding the treatment medium to the treatment container; and
d) exposing the tissue sample and the device to the treatment medium at about the same time and until the device provides a visual indication that adequate exposure has been attained. Steps a), b), c) may be completed in any order and often a treatment medium is added to the treatment container well in advance of adding the tissue sample to the treatment container.

Adding a tissue sample to a treatment container comprises obtaining a treatment container, opening the treatment container, and placing the tissue sample in the treatment container. In some embodiments, the treatment container is provided with the treatment medium already within the treatment container prior to adding the tissue sample. In such embodiments, it may be beneficial to place the device in the treatment container when placing the tissue sample in the treatment container. Alternatively, the tissue sample may be placed in the treatment container prior to placing the device in the treatment container or after placing the device in the treatment container.

In some embodiments, the device is included as part of the treatment container. In such embodiments, upon adding the tissue sample to the treatment container, the device is exposed to the treatment medium at about the same time as the tissue sample is exposed to the treatment medium. In some embodiments, upon opening the treatment container the device may become exposed to the treatment medium. In some embodiments, the treatment container comprises the device attached to a surface of the treatment container, which surface is exposed to the treatment medium when in the tissue sample is added.

In some embodiments of the present invention, the inspection of the device is carried out by computerized methods. Such computerized methods may include, but are not limited to, further processing of an output of a digital image capture device by a computer to quantify a change in the device, thereby identifying that adequate exposure has or has not occurred.

### EXAMPLES

The following examples are illustrative of some of the embodiments of the invention described herein. These examples do not limit the spirit or scope of the invention in any way.

### Example 1

### General Procedure for Making and Testing Devices

Devices of the present invention were made in accordance with the following general procedure. In 20 ml of compound solvent, 1000 mg of polymer was added. The polymer was dissolved in the compound solvent using a magnetic stirrer at room temperature. Complete dissolution of the polymer may take as long as 2 hrs and the polymer-solvent mixture will be clear once complete dissolution has been achieved. Once complete dissolution is achieved, 1000 mg of the component is added very slowly to the polymer-solvent mixture. The component was added slowly enough to avoid clumping of the component in the polymer-solvent mixture. The mixture of the component and the polymer-solvent mixture was then stirred using a magnetic stirrer for about 30 minutes, thereby forming the compound. The compound was then applied onto the surface and left to dry for about 2 to 4 hours depending on the solution thickness. The compound dried to the surface was then covered with a transparent body by attaching the transparent body to the surface. In all of the examples below, the transparent body was a film of polypropylene (PP). Samples were then cut out and immersed in an ethanol solution. The particular surfaces, compounds (and components thereof), transparent bodies and the results thereof are set out in Table 1 and Table 2 below.

TABLE 1
Summary Table for Experimental Variables for Devices

| | Device | | | | | |
|---|---|---|---|---|---|---|
| | | | | | Application | No. of |
| | | Compound | | | method of | layers for |
| | | Compound | Compound | Compound | compound | compound |
| Ex No. | Surface | Polymer | solvent | Component | to surface | application |
| 1 | clear, thin | PBMA-4 | Ethanol | AlSil-4 | Brush | one |
| | polypropylene | | | | | |
| 2 | clear, thin | PBMA-4 | Ethanol | AlSil-4 | Brush | two |
| | polypropylene | | | | | |
| 3 | clear, thin | PVA-PVB-4 | Ethanol | AlSil-4 | Brush | one |
| | polypropylene | | | | | |
| 4 | clear, thin | PVA-PVB-4 | Ethanol | AlSil-4 | Brush | two |
| | polypropylene | | | | | |
| 5 | clear, thin | PBMA-4 | Ethanol | AlSil-4 | Brush | one |
| | polypropylene | | | | | |
| 6 | clear, thin | PBMA-4 | Ethanol | AlSil-4 | Brush | two |
| | polypropylene | | | | | |
| 7 | clear, thin | PVA-PVB-4 | Ethanol | AlSil-4 | Brush | one |
| | polypropylene | | | | | |
| 8 | clear, thin | PVA-PVB-4 | Ethanol | AlSil-4 | Brush | two |
| | polypropylene | | | | | |
| 9 | clear, thin | PBMA-4 | Ethanol | Sil A380-4 | Brush | One |
| | polypropylene | | | | | |
| 10 | clear, thin | PBMA-4 | Ethanol | Sil A380-4 | Brush | two |
| | polypropylene | | | | | |
| 11 | clear, thin | PVA-PVB-4 | Ethanol | Sil A380-4 | Brush | one |
| | polypropylene | | | | | |
| 12 | clear, thin | PVA-PVB-4 | Ethanol | Sil A380-4 | Brush | two |
| | polypropylene | | | | | |
| 13 | clear, thin | PBMA-4 | Ethanol | Sil A380-4 | Brush | one |
| | polypropylene | | | | | |
| 14 | clear, thin | PBMA-4 | Ethanol | Sil A380-4 | Brush | two |
| | polypropylene | | | | | |
| 15 | clear, thin | PVA-PVB-4 | Ethanol | Sil A380-4 | Brush | one |
| | polypropylene | | | | | |
| 16 | clear, thin | PVA-PVB-4 | Ethanol | Sil A380-4 | Brush | two |
| | polypropylene | | | | | |
| 17 | red, vinyl | PBMA-2 | ethanol | AlSil-2 | Brush | One |
| 18 | red, vinyl | PBMA-2 | ethanol | AlSil-2 | Brush | two |
| 19 | red, vinyl | PBMA-2 | ethanol | AlSil-4 | Brush | One |
| 20 | red, vinyl | PBMA-2 | ethanol | AlSil-4 | Brush | two |
| 21 | red, vinyl | PBMA-2 | ethanol | AlSil-6 | Brush | One |
| 22 | red, vinyl | PBMA-2 | ethanol | AlSil-6 | Brush | Two |
| 23 | red, vinyl | PBMA-2 | ethanol | AlSil-8 | Brush | One |
| 24 | red, vinyl | PBMA-2 | ethanol | AlSil-8 | Brush | Two |
| 25 | red, vinyl | PBMA-4 | ethanol | AlSil-2 | Brush | One |
| 26 | red, vinyl | PBMA-4 | ethanol | AlSil-2 | Brush | Two |
| 27 | red, vinyl | PBMA-4 | ethanol | AlSil-4 | Brush | One |
| 28 | red, vinyl | PBMA-4 | ethanol | AlSil-4 | Brush | two |
| 29 | red, vinyl | PBMA-4 | ethanol | AlSil-6 | Brush | one |
| 30 | red, vinyl | PBMA-4 | ethanol | AlSil-6 | Brush | two |
| 31 | red, vinyl | PBMA-6 | ethanol | AlSil-4 | Brush | One |
| 32 | red, vinyl | PBMA-6 | ethanol | AlSil-4 | Brush | Two |
| 33 | red, vinyl | PBMA-8 | ethanol | AlSil-4 | Brush | One |
| 34 | red, vinyl | PBMA-8 | ethanol | AlSil-4 | Brush | two |
| 35 | red, vinyl | PBMA-4 | ethanol | AlSil-4 | Brush | three |
| 36 | red, vinyl | PBMA-4 | ethanol | AlSil-4 | Knife | one |
| 37 | red, vinyl | PBMA-4 | ethanol | AlSil-4 | Knife | two |
| 38 | red, vinyl | PBMA-4 | Ethanol | AlSil-4 | Knife | three |
| 39 | red, vinyl | PBMA-4 | Ethanol | AlSil-4 | Sponge | One |
| 40 | red, vinyl | PBMA-4 | ethanol | AlSil-4 | Sponge | two |
| 41 | red, vinyl | PBMA-4 | ethanol | AlSil-4 | Sponge | three |
| 42 | red, vinyl | PBMA-4 | ethanol | AlSil-4 | Spray | One |
| 43 | red, vinyl | PBMA-4 | ethanol | AlSil-4 | Spray | two |
| 44 | red, vinyl | PBMA-4 | ethanol | AlSil-4 | Spray | three |
| 45 | red, vinyl | PBMA-4 | ethanol | Sil A380-2 | Brush | One |
| 45A | red, vinyl | PBMA-4 | ethanol | Sil A380-2 | Brush | two |
| 46 | red, vinyl | PBMA-4 | ethanol | Sil A380-4 | Brush | One |
| 47 | red, vinyl | PBMA-4 | ethanol | Sil A380-4 | Brush | two |
| 48 | red, vinyl | PBMA-4 | ethanol | Sil A380-6 | Brush | One |
| 49 | red, vinyl | PBMA-4 | ethanol | Sil A380-6 | Brush | two |
| 50 | red, vinyl | PBMA-4 | methanol | Sil A380-4 | Brush | One |
| 51 | red, vinyl | PBMA-4 | methanol | Sil A380-4 | Brush | two |
| 52 | red, vinyl | PBMA-4 | methanol | AlSil-4 | Brush | One |
| 53 | red, vinyl | PBMA-4 | methanol | AlSil-4 | Brush | two |
| 54 | red, vinyl | PBMA-4 | methanol | AlSil-4 | Brush | three |
| 55 | red, vinyl | PBMA-4 | acetone | AlSil-4 | Brush | One |
| 56 | red, vinyl | PBMA-4 | acetone | AlSil-4 | Brush | two |
| 57 | red, vinyl | PBMA-4 | acetone | AlSil-4 | Brush | three |
| 58 | red, vinyl | PBMA-4 | ethanol | Sil A380-4 | Spray | One |
| 59 | red, vinyl | PBMA-4 | ethanol | Sil A380-4 | Spray | Two |
| 60 | red, vinyl | PBMA-4 | ethanol | Sil A380-4 | Spray | Three |
| 61 | red, vinyl | PVA-PVB-2 | ethanol | Sil A380-4 | Brush | One |
| 62 | red, vinyl | PVA-PVB-2 | ethanol | Sil A380-4 | Brush | one |
| 63 | red, vinyl | PVA-PVB-2 | ethanol | Sil A380-4 | Brush | one |
| 64 | red, vinyl | PVA-PVB-4 | ethanol | Sil A380-4 | Brush | One |
| 65 | red, vinyl | PVA-PVB-4 | ethanol | Sil A380-4 | Brush | two |
| 66 | red, vinyl | PVA-PVB-4 | ethanol | Sil A380-4 | Brush | three |
| 67 | red, vinyl | PVA-PVB-6 | ethanol | Sil A380-4 | Brush | One |
| 68 | red, vinyl | PVA-PVB-6 | ethanol | Sil A380-4 | Brush | Two |
| 69 | red, vinyl | PVA-PVB-6 | ethanol | Sil A380-4 | Brush | three |
| 70 | red, vinyl | PVA-PVB-8 | ethanol | Sil A380-4 | Brush | One |
| 71 | red, vinyl | PVA-PVB-8 | ethanol | Sil A380-4 | Brush | two |
| 72 | red, vinyl | PVA-PVB-8 | ethanol | Sil A380-4 | Brush | three |
| 73 | red, vinyl | PVA-PVB-6 | ethanol | Sil A380-4 | Knife | One |
| 74 | red, vinyl | PVA-PVB-6 | ethanol | Sil A380-4 | Knife | two |
| 75 | red, vinyl | PVA-PVB-6 | ethanol | Sil A380-4 | Knife | three |
| 76 | red, vinyl | PVA-PVB-4 | ethanol | Sil A380-4 | Knife | One |
| 77 | red, vinyl | PVA-PVB-4 | ethanol | Sil A380-4 | Knife | two |
| 78 | red, vinyl | PVA-PVB-4 | ethanol | Sil A380-4 | Knife | three |
| 79 | red, vinyl | PVA-PVB-4 | ethanol | Sil A380-4 | Sponge | One |
| 80 | red, vinyl | PVA-PVB-4 | ethanol | Sil A380-4 | Sponge | two |
| 81 | red, vinyl | PVA-PVB-4 | ethanol | Sil A380-4 | Sponge | three |
| 82 | red, vinyl | PVA-PVB-4 | acetone | Sil A380-4 | Brush | One |
| 83 | red, vinyl | PVA-PVB-4 | acetone | Sil A380-4 | Brush | two |
| 84 | red, vinyl | PVA-PVB-4 | acetone | Sil A380-4 | Brush | three |
| 85 | red, vinyl | PVA-PVB-4 | ethanol | AlSil-4 | Brush | One |
| 86 | red, vinyl | PVA-PVB-4 | ethanol | AlSil-4 | Brush | Two |
| 87 | red, vinyl | PVA-PVB-4 | ethanol | AlSil-4 | Brush | Three |
| 88 | red, vinyl | PVA-PVB-4 | ethanol | AlSil-4 | Knife | One |
| 89 | red, vinyl | PVA-PVB-4 | ethanol | AlSil-4 | Knife | two |
| 90 | red, vinyl | PVA-PVB-4 | ethanol | AlSil-4 | knife | three |
| 91 | red, vinyl | PVA-PVB-4 | ethanol | AlSil-4 | sponge | One |
| 92 | red, vinyl | PVA-PVB-4 | ethanol | AlSil-4 | sponge | two |
| 93 | red, vinyl | PVA-PVB-4 | ethanol | AlSil-4 | sponge | three |
| 94 | red, vinyl | PVA-PVB-4 | methanol | AlSil-4 | brush | One |
| 95 | red, vinyl | PVA-PVB-4 | methanol | AlSil-4 | brush | two |
| 96 | red, vinyl | PVA-PVB-4 | methanol | AlSil-4 | brush | three |
| 97 | red, vinyl | PVA-PVB-4 | acetone | AlSil-4 | Brush | One |
| 98 | red, vinyl | PVA-PVB-4 | acetone | AlSil-4 | brush | two |
| 99 | red, vinyl | PVA-PVB-4 | acetone | AlSil-4 | brush | three |
| 100 | red, vinyl | PVA-PVB-4 | ethanol | AlSil-4 | Spray | One |
| 101 | red, vinyl | PVA-PVB-4 | ethanol | AlSil-4 | spray | two |
| 102 | red, vinyl | PVA-PVB-4 | ethanol | AlSil-4 | spray | three |
| 103 | red, vinyl | PVA-PVB-4 | ethanol | Sil A380-4 | spray | One |
| 104 | red, vinyl | PVA-PVB-4 | ethanol | Sil A380-4 | spray | two |
| 105 | red, vinyl | PVA-PVB-4 | ethanol | Sil A380-4 | spray | three |
| 106 | red, vinyl | PVP-2 | ethanol | AlSil-4 | brush | One |
| 107 | red, vinyl | PVP-2 | ethanol | AlSil-4 | brush | two |
| 108 | red, vinyl | PVP-4 | ethanol | AlSil-4 | brush | One |
| 109 | red, vinyl | PVP-4 | ethanol | AlSil-4 | brush | Two |
| 110 | red, vinyl | PVP-2 | ethanol | Sil A380-4 | brush | One |
| 111 | red, vinyl | PVP-2 | ethanol | Sil A380-4 | brush | two |
| 112 | red, vinyl | PVP-4 | ethanol | Sil A380-4 | brush | One |
| 113 | red, vinyl | PVP-4 | ethanol | Sil A380-4 | brush | two |
| 114 | red, vinyl | PVP-4 | acetone | AlSil-4 | brush | One |
| 115 | red, vinyl | PVP-4 | acetone | AlSil-4 | brush | Two |
| 116 | red, vinyl | PVP-4 | acetone | Sil A380-4 | brush | One |
| 117 | red, vinyl | PVP-4 | acetone | Sil A380-4 | brush | two |
| 118 | red, vinyl | PVP-4 | ethanol | AlSil-4 | spray | One |
| 119 | red, vinyl | PVP-4 | ethanol | AlSil-4 | spray | two |
| 120 | red, vinyl | PVP-4 | ethanol | Sil A380-4 | spray | One |
| 121 | red, vinyl | PVP-4 | ethanol | Sil A380-4 | spray | two |

TABLE 2
Summary Table for Results of Experimental Variables for Devices

| Ex No. | Outcome |
|---|---|
| 1 | Compound is weak, shrinks after drying |
| 2 | Compound is weak, shrinks after drying |
| 3 | Compound is weak, shrinks after drying |
| 4 | Compound is weak, shrinks after drying |
| 5 | Contrast between wet and dry compound is not ideal |
| 6 | Contrast between wet and dry compound is not ideal |
| 7 | Contrast between wet and dry compound is not ideal |
| 8 | Contrast between wet and dry compound is not ideal |
| 9 | Compound is weak, shrinks after drying |
| 10 | Compound is weak, shrinks after drying |
| 11 | Compound is weak, shrinks after drying |
| 12 | Compound is weak, shrinks after drying |
| 13 | Contrast between wet and dry compound is not ideal |
| 14 | Contrast between wet and dry compound is not ideal |
| 15 | Contrast between wet and dry compound is not ideal |
| 16 | Contrast between wet and dry compound is not ideal |
| 17 | Contrast between wet and dry compound is not ideal |
| 18 | Contrast between wet and dry compound is not ideal |
| 19 | Good contrast between wet and dry coating. |
| | Compound cracked after drying |
| 20 | Good contrast between wet and dry coating. |
| | Compound cracked after drying |
| 21 | Initial solution when making compound is viscous |
| 22 | Initial solution when making compound is viscous |
| 23 | Initial solution when making compound is viscous, paste-like |
| 24 | Initial solution when making compound viscous, paste-like |
| 25 | Compound is flexible. Contrast between wet and dry compound is not ideal |
| 26 | Compound is flexible. Contrast between wet and dry compound is not ideal |
| 27 | Good contrast between wet and dry coating. Compound cracked after drying |
| 28 | Good contrast between wet and dry coating. Compound cracked after drying |
| 29 | Initial solution when making compound is viscous - difficult to apply |
| 30 | Initial solution when making compound is viscous - difficult to apply |
| 31 | Good contrast between wet and dry compound. |
| | Compound is not flexible when dried |
| 32 | Good contrast between wet and dry compound. |
| | Compound is not flexible when dried |
| 33 | After drying, compound is stiff, even one layer |
| 34 | After drying, compound is stiff, even one layer |
| 35 | After drying, compound is stiff, even one layer |
| 36 | After drying, compound is stiff, even one layer |
| 37 | After drying, compound is stiff, even one layer |
| 38 | After drying, compound is stiff, even one layer |
| 39 | After drying, compound is stiff, even one layer |
| 40 | After drying, compound is stiff, even one layer |
| 41 | After drying, compound is stiff, even one layer |
| 42 | After drying, compound is stiff, even one layer |
| 43 | After drying, compound is stiff, even one layer |
| 44 | After drying, compound is stiff, even one layer |
| 45 | Contrast between wet and dry compound is not ideal |
| 45A | Contrast between wet and dry compound is not ideal |
| 46 | Contrast between wet and dry compound is not ideal. Thick compound |
| 47 | Contrast between wet and dry compound is not ideal. Thick compound |
| 48 | Contrast between wet and dry compound is not ideal. Thick transparent body. |
| 49 | Contrast between wet and dry compound is not ideal. Thick transparent body. |
| 50 | Contrast between wet and dry compound is not ideal. Thick compound |
| 51 | Contrast between wet and dry compound is not ideal. Thick compound |
| 52 | Contrast between wet and dry compound is good. |
| | Compound solution is not viscous |
| 53 | Contrast between wet and dry compound is good. |
| | Compound solution is not viscous |
| 54 | Contrast between wet and dry compound is good. |
| | Compound solution is not viscous |
| 55 | Difficult to dissolve compound polymer in compound solvent |
| 56 | Difficult to dissolve compound polymer in compound solvent |
| 57 | Difficult to dissolve compound polymer in compound solvent |
| 58 | Contrast between wet and dry compound is not ideal |
| 59 | Contrast between wet and dry compound is not ideal |
| 60 | Contrast between wet and dry compound is not ideal |
| 61 | Contrast between wet and dry compound is not ideal |
| 62 | Contrast between wet and dry compound is not ideal |
| 63 | Contrast between wet and dry compound is not ideal |
| 64 | Good compound and good contrast between wet and dry |
| 65 | Good compound and good contrast between wet and dry |
| 66 | Good compound and good contrast between wet and dry |
| 67 | Compound solution is too viscous |
| 68 | Compound solution is too viscous |
| 69 | Compound solution is too viscous |
| 70 | Compound solution is too viscous |
| 71 | Compound solution is too viscous |
| 72 | Compound solution is too viscous |
| 73 | Compound solution is too viscous |
| 74 | Compound solution is too viscous |
| 75 | Compound solution is too viscous |
| 76 | Difficult to apply compound in uniform layer |
| 77 | Difficult to apply compound in uniform layer |
| 78 | Difficult to apply compound in uniform layer |
| 79 | Difficult to apply compound in uniform layer |
| 80 | Difficult to apply compound in uniform layer |
| 81 | Difficult to apply compound in uniform layer |
| 82 | Good spreading of compound solution, but takes |
| | longer to dissolve compound polymer in compound solvent |
| 83 | Good spreading of compound solution, but takes |
| | longer to dissolve compound polymer in compound solvent |
| 84 | Good spreading of compound solution, but takes |
| | longer to dissolve compound polymer in compound solvent |
| 85 | Good uniform spreading of the compound solution |
| 86 | Good uniform spreading of the compound solution |
| 87 | Good uniform spreading of the compound solution |
| 88 | Difficult to apply compound solution in a uniform layer |
| 89 | Difficult to apply compound solution in a uniform layer |
| 90 | Difficult to apply compound solution in a uniform layer |
| 91 | Difficult to apply compound solution in a uniform layer |
| 92 | Difficult to apply compound solution in a uniform layer |
| 93 | Difficult to apply compound solution in a uniform layer |
| 94 | Solubility of compound polymer and compound |
| | component is not as good as in ethanol |
| 95 | Solubility of compound polymer and compound |
| | component is not as good as in ethanol |
| 96 | Solubility of compound polymer and compound |
| | component is not as good as in ethanol |
| 97 | Good spreading of compound solution, but takes |
| | longer to dissolve compound polymer and compound component |
| 98 | Good spreading of compound solution, but takes |
| | longer to dissolve compound polymer and compound component |
| 99 | Good spreading of compound solution, but takes |
| | longer to dissolve compound polymer and compound component |
| 100 | Uniform compound solution. Good contrast |
| | between wet and dry compound |
| 101 | Uniform compound solution. Good contrast |
| | between wet and dry compound |
| 102 | Uniform compound solution. Good contrast |
| | between wet and dry compound |
| 103 | Uniform compound solution. Contrast between wet |
| | and dry compound is not as good as with AlSil |
| 104 | Uniform compound solution. Contrast between wet |
| | and dry compound is not as good as with AlSil |
| 105 | Uniform compound solution. Contrast between wet |
| | and dry compound is not as good as with AlSil |
| 106 | Good compound solution, adhesion to surface is weak |
| 107 | Good compound solution, adhesion to surface is weak |
| 108 | Compound solution is stiff and cracks after drying |
| 109 | Compound solution is stiff and cracks after drying |
| 110 | Compound solution is uniform, contrast between wet |
| | and dry compound is not ideal, adhesion to surface is weak |
| 111 | Compound solution is uniform, contrast between wet |
| | and dry compound is not ideal, adhesion to surface is weak |
| 112 | Stiff compound, weak adhesion to surface |
| 113 | Stiff compound, weak adhesion to surface |
| 114 | Poor solubility of compound polymer and compound |
| | component in compound solvent |
| 115 | Poor solubility of compound polymer and compound |
| | component in compound solvent |
| 116 | Poor solubility of compound polymer and compound |
| | component in compound solvent |
| 117 | Poor solubility of compound polymer and compound |
| | component in compound solvent |
| 118 | Compound solution is too viscous to spray |
| 119 | Compound solution is too viscous to spray |
| 120 | Compound solution is too viscous to spray |
| 121 | Compound solution is too viscous to spray |

### Example 2

### General Procedure for Making and Testing Devices

In a first step PVAPVB polymer was dissolved in ethanol. Then Alumina-silica or titania or silica (A-300) and combination of different particles were added into the polymer solution. The final solution was white or opaque. The solution was spread on a red polymer film with a paint brash. The shape of covered area was 5 mm×40 mm rectangle (see picture 1). Ethanol was evaporated from the solution and the polymer with particles (white layer) was formed on the top of the red polymer film. Transparent adhesive polycarbonate film was applied on the top. A small hole was punched with different syringe needle (21½ or 27½ gauge) on the top of the rectangle to regulate formalin solution penetration speed.

The polymer layer with particles became transparent after the formalin solution penetrated into the device via the hole in the polycarbonate film layer.

The following variables were altered in different devices to refine the timing of penetration of the formalin solution into the devices:
Concentration of the alumina-silica particles;
Concentration of the titania particles;
Concentration of the silica (A 300) particles.
Ratio of the mixture of the alumina-silica, titania, and silica (A 300) particles;
Thickness of the layer; and
Size of the hole.

A device using the following was made:

| | |
|---|---|
| PVAPVB in Ethanol | 5.0% |
| Alumina-Silica | 10.0% |

27½ needle used to make a hole in the polycarbonate film.

Using these parameters, the formalin solution penetrated the device over a distance of 20 mm in approximately 1 h 40 min. The formalin solution penetrated the device over a distance of 40 mm in approximately 7 hrs.

Further devices were made and tested and the results are set out below in Tables 3 and 4.

TABLE 3
Summary Table for Experimental Variables for Devices
Devices

| | | | | Coated | | |
|---|---|---|---|---|---|---|
| | | Additional | Additional | area, | Coating | Top layer on |
| Ex. No | Polymer | component 1 | component 2 | cm × cm | profile | the coating |
| 102.1 | PVA- | AlSil, 5% | — | 3 × 1 | The coating | I layer of |
| | PVB, 5% | | | | goes to top | Transparent |
| | | | | | and bottom | adhesive |
| | | | | | edges | polycarbonate |
| | | | | | | film (TPCF) |
| 102.2 | PVA- | AlSil, 5% | — | 1 × 1 | The coating | I layer of |
| | PVB, 5% | | | | goes to top | Transparent |
| | | | | | and bottom | adhesive |
| | | | | | edges | polycarbonate |
| | | | | | | film (TPCF) |
| 102.3 | PVA- | AlSil, 5% | — | 1 × 1 | The coating | I layer of |
| | PVB, 5% | | | | goes to top | Transparent |
| | | | | | and bottom | adhesive |
| | | | | | edges | polycarbonate |
| | | | | | | film (TPCF) |
| 103.1 | PVA- | AlSil, 5% | — | 2 × 1 | The coating | I layer of |
| | PVB, 7.5% | | | | surrounded | Transparent |
| | | | | | by non- | adhesive |
| | | | | | coated area | polycarbonate |
| | | | | | | film (TPCF); |
| | | | | | | hole in the film |
| 103.2 | PVA- | AlSil, 5% | — | 2 × 1 | The coating | 1 layer of |
| | PVB, 7.5% | | | | surrounded | Transparent |
| | | | | | by non- | adhesive |
| | | | | | coated area | polycarbonate |
| | | | | | | film (TPCF); |
| | | | | | | hole in the film |
| 104.5 | PVA- | AlSil, 5% | TiO₂; 5% | 3 × 1 | Non-coated | 2 layers of |
| | PVB, 5% | | | | areas | TPCF, holes in |
| | | | | | around | both films on a |
| | | | | | coated. | top of coated |
| | | | | | *it wasn't a | area; 27 ½ |
| | | | | | good | gauge needle |
| | | | | | contrast | |
| | | | | | wet/dry | |
| 108.7-a | PVA- | AlSil 4.5% | Silica 300 | 0.5 × 1.5 | 1 layer of | 2 layers of |
| | PVB, 5% | | 0.5% | | coating | TPCF, holes in |
| | | | | | | both films on a |
| | | | | | | top of coated |
| | | | | | | area; 27 ½ |
| | | | | | | gauge needle |
| 108.7-b | PVA- | AlSil 4.5% | Silica 300 | 0.5 × 1.5 | 1 layer of | 2 layers of |
| | PVB, 5% | | 0.5% | | coating | TPCF, holes in |
| | | | | | | both films on a |
| | | | | | | top of coated |
| | | | | | | area; 27 ½ |
| | | | | | | gauge needle |
| 106.1 | PVA- | AlSil, 5% | TiO₂; 1.5% | 3 × 1 | Non-coated | 2 layers of |
| | PVB, 5% | | | | areas | TPCF, holes in |
| | | | | | around | both films on a |
| | | | | | coated. | top of coated |
| | | | | | | area; 27 ½ |
| | | | | | | gauge needle |
| 105.4 | PVA- | AlSil, 5% | TiO₂; 2.3% | 2.5 × 1 | Non-coated | 2 layers of |
| | PVB, 5% | | | | areas | TPCF, holes in |
| | | | | | around | both films on a |
| | | | | | coated. | top of coated |
| | | | | | *better | area; 27 ½ |
| | | | | | contrast | gauge needle |
| | | | | | wet/dry | |
| 105.5 | PVA- | AlSil, 5% | TiO₂; 2.3% | 2.5 × 1 | Non-coated | 2 layers of |
| | PVB, 5% | | | | areas | TPCF, holes in |
| | | | | | around | both films on a |
| | | | | | coated. | top of coated |
| | | | | | *better | area; 27 ½ |
| | | | | | contrast | gauge needle |
| | | | | | wet/dry | |
| 106.3 | PVA- | AlSil, 5% | TiO₂; 1.5% | 3 × 1 | Non-coated | 2 layers of |
| | PVB, 5% | | | | areas | TPCF, holes in |
| | | | | | around | both films on a |
| | | | | | coated. | top of coated |
| | | | | | | area; 27 ½ |
| | | | | | | gauge needle |
| 106.2 | PVA- | AlSil, 5% | TiO₂; 1.5% | 3 × 1 | Non-coated | 2 layers of |
| | PVB, 5% | | | | areas | TPCF, holes in |
| | | | | | around | both films on a |
| | | | | | coated. | top of coated |
| | | | | | | area; 27 ½ |
| | | | | | | gauge needle |
| 105.1 | PVA- | AlSil, 5% | TiO₂; 2.3% | 2.5 × 1 | Non-coated | 2 layers of |
| | PVB, 5% | | | | areas | TPCF, holes in |
| | | | | | around | both films on a |
| | | | | | coated. | top of coated |
| | | | | | *better | area; 27 ½ |
| | | | | | contrast | gauge needle |
| | | | | | wet/dry | |
| 107.4 | PVA- | | TiO₂; 2% | 1 × 2.5 | Non-coated | 2 layers of |
| | PVB, 5% | | | | areas | TPCF, holes in |
| | | | | | around | both films on a |
| | | | | | coated. | top of coated |
| | | | | | | area; 27 ½ |
| | | | | | | gauge needle |
| 105.2 | PVA- | AlSil, 5% | TiO₂; 2.3% | 2.5 × 1 | Non-coated | 2 layers of |
| | PVB, 5% | | | | areas | TPCF, holes in |
| | | | | | around | both films on a |
| | | | | | coated. | top of coated |
| | | | | | *better | area; 27 ½ |
| | | | | | contrast | gauge needle |
| | | | | | wet/dry | |
| 105.3 | PVA- | AlSil, 5% | TiO₂; 2.3% | 2.5 × 1 | Non-coated | 2 layers of |
| | PVB, 5% | | | | areas | TPCF, holes in |
| | | | | | around | both films on a |
| | | | | | coated. | top of coated |
| | | | | | *better | area; 27 ½ |
| | | | | | contrast | gauge needle |
| | | | | | wet/dry | |
| 104.3 | PVA- | AlSil, 5% | TiO₂; 5% | 3 × 1 | Non-coated | 2 layers of |
| | PVB, 5% | | | | areas | TPCF, holes in |
| | | | | | around | both films on a |
| | | | | | coated. | top of coated |
| | | | | | *it wasn't a | area; 27 ½ |
| | | | | | good | gauge needle |
| | | | | | contrast | |
| | | | | | wet/dry | |
| 108.5-a | PVA- | AlSil 4.5% | Silica 300 | 0.5 × 1.5 | 1 layer of | 2 layers of |
| | PVB, 5% | | 0.5% | | coating | TPCF, holes in |
| | | | | | | both films on a |
| | | | | | | top of coated |
| | | | | | | area; 27 ½ |
| | | | | | | gauge needle |
| 108.6-b | PVA- | AlSil 4.5% | Silica 300 | 0.5 × 1.5 | 1 layer of | 2 layers of |
| | PVB, 5% | | 0.5% | | coating | TPCF, holes in |
| | | | | | | both films on a |
| | | | | | | top of coated |
| | | | | | | area; 27 ½ |
| | | | | | | gauge needle |
| 108.5-d | PVA- | AlSil 4.5% | Silica 300 | 0.5 × 1.5 | 1 layer of | 2 layers of |
| | PVB, 5% | | 0.5% | | coating | TPCF, holes in |
| | | | | | | both films on a |
| | | | | | | top of coated |
| | | | | | | area; 27 ½ |
| | | | | | | gauge needle |
| 108.6-a | PVA- | AlSil 4.5% | Silica 300 | 0.5 × 1.5 | 1 layer of | 2 layers of |
| | PVB, 5% | | 0.5% | | coating | TPCF, holes in |
| | | | | | | both films on a |
| | | | | | | top of coated |
| | | | | | | area; 27 ½ |
| | | | | | | gauge needle |
| 109.2 | PVA- | AlSil 4% | Silica 300 | 0.5 × 1.5 | Non-coated | 1 layer of |
| | PVB, 5% | | 1% | | areas | TPCF, hole in |
| | | | | | around | film on a top of |
| | | | | | coated. | coated area; 27 ½ |
| | | | | | | gauge needle |
| 108.5-b | PVA- | AlSil 4.5% | Silica 300 | 0.5 × 1.5 | 1 layer of | 2 layers of |
| | PVB, 5% | | 0.5% | | coating | TPCF, holes in |
| | | | | | | both films on a |
| | | | | | | top of coated |
| | | | | | | area; 27 ½ |
| | | | | | | gauge needle |
| 102.4 | PVA- | AlSil, 5% | — | 3 × 1 | The coating | 1 layer of |
| | PVB, 5% | | | | surrounded | Transparent |
| | | | | | by non- | adhesive |
| | | | | | coated area | polycarbonate |
| | | | | | | film (TPCF); |
| | | | | | | hole in a film |
| 107.5 | PVA- | — | TiO₂; 2% | 1 × 2.5 | Non-coated | 2 layers of |
| | PVB, 5% | | | | areas | TPCF, holes in |
| | | | | | around | both films on a |
| | | | | | coated. | top of coated |
| | | | | | | area; 27 ½ |
| | | | | | | gauge needle |
| 108.5-c | PVA- | AlSil 4.5% | Silica 300 | 0.5 × 1.5 | 1 layer of | 2 layers of |
| | PVB, 5% | | 0.5% | | coating | TPCF, holes in |
| | | | | | | both films on a |
| | | | | | | top of coated |
| | | | | | | area; 27 ½ |
| | | | | | | gauge needle |
| 108.6-c | PVA- | AlSil 4.5% | Silica 300 | 0.5 × 1.5 | 2 layers of | 2 layers of |
| | PVB, 5% | | 0.5% | | coating | TPCF, holes in |
| | | | | | | both films on a |
| | | | | | | top of coated |
| | | | | | | area; 27 ½ |
| | | | | | | gauge needle |
| 108.4 | PVA- | AlSil 4.5% | Silica 300 | 0.5 × 3.5 | Non-coated | 2 layers of |
| | PVB, 5% | | 0.5% | | areas | TPCF, holes in |
| | | | | | around | both films on a |
| | | | | | coated. | top of coated |
| | | | | | | area; 27 ½ |
| | | | | | | gauge needle |
| 108.6-d | PVA- | AlSil 4.5% | Silica 300 | 0.5 × 1.5 | 2 layers of | 2 layers of |
| | PVB, 5% | | 0.5% | | coating | TPCF, holes in |
| | | | | | | both films on a |
| | | | | | | top of coated |
| | | | | | | area; 27 ½ |
| | | | | | | gauge needle |
| 108.8 | PVA- | AlSil 4.5% | Silica 300 | 0.5 × 1.5 | 2 layers of | 2 layers TPCF |
| | PVB, 5% | | 0.5% | | coating | |
| 108.1 | PVA- | AlSil 4.5% | Silica 300 | 0.5 × 1.5 | Non-coated | 2 layers of |
| | PVB, 5% | | 0.5% | | areas | TPCF, holes in |
| | | | | | around | both films on a |
| | | | | | coated. | top of coated |
| | | | | | | area; 27 ½ |
| | | | | | | gauge needle |
| 109.1 | PVA- | AlSil 4% | Silica 300 | 0.5 × 0.5 | Non-coated | 2 layers of |
| | PVB, 5% | | 1% | | areas | TPCF, holes in |
| | | | | | around | both films on a |
| | | | | | coated. | top of coated |
| | | | | | | area; 27 ½ |
| | | | | | | gauge needle |
| 108.9 | PVA- | AlSil 4.5% | Silica 300 | 3.5 × 0.5 | 1 layer of | 2 layers TPCF |
| | PVB, 5% | | 0.5% | | coating | |
| 107.6 | PVA- | — | TiO₂; 2% | 1 × 2.5 | Non-coated | 2 layers of |
| | PVB, 5% | | | | areas | TPCF, holes in |
| | | | | | around | both films on a |
| | | | | | coated. | top of coated |
| | | | | | | area; 27 ½ |
| | | | | | | gauge needle |
| 114-f | PVA- | AlSil 5% | — | 0.5 × 5 | Non-coated | 1 layer of |
| | PVB, 5% | | | | areas | TPCF, holes 21 ½ |
| | | | | | around | G needle |
| | | | | | coated. | |
| 114-b | PVA- | AlSil 5% | — | 0.5 × 5 | Non-coated | 1 layer of |
| | PVB, 5% | | | | areas | TPCF, holes 27 |
| | | | | | around | ½ G needle |
| | | | | | coated. | |
| 114-d | PVA- | AlSil 5% | — | 0.5 × 5 | Non-coated | 1 layer of |
| | PVB, 5% | | | | areas | TPCF, holes 27 ½ |
| | | | | | around | G needle |
| | | | | | coated. | |
| 114-g | PVA- | AlSil 5% | — | 0.5 × 5 | Non-coated | 1 layer of |
| | PVB, 5% | | | | areas | TPCF, holes 21 |
| | | | | | around | ½ G needle |
| | | | | | coated. | |
| 114-a | PVA- | AlSil 5% | — | 0.5 × 5 | Non-coated | 1 layer of |
| | PVB, 5% | | | | areas | TPCF, holes 27 |
| | | | | | around | ½ G needle |
| | | | | | coated. | |
| 114-c | PVA- | AlSil 5% | — | 0.5 × 5 | Non-coated | 1 layer of |
| | PVB, 5% | | | | areas | TPCF, holes 27 |
| | | | | | around | ½ G needle |
| | | | | | coated. | |
| 114-e | PVA- | AlSil 5% | — | 0.5 × 5 | Non-coated | 1 layer of |
| | PVB, 5% | | | | areas | TPCF, holes 27 |
| | | | | | around | ½ G needle |
| | | | | | coated. | |
| 110 | PVA- | AlSil 5% | — | 0.5 × 5 | Non-coated | 1 layer of |
| | PVB, 5% | | | | areas | TPCF, hole in |
| | | | | | around | film on a top of |
| | | | | | coated. | coated area; 27 |
| | | | | | | ½ gauge needle |
| 111 | PVA- | AlSil 7.5% | — | 0.5 × 5 | Non-coated | 1 layer of |
| | PVB, 5% | | | | areas | TPCF, hole in |
| | | | | | around | film on a top of |
| | | | | | coated. | coated area; 27 |
| | | | | | | ½ gauge needle |
| 112 | PVA- | AlSil 10% | — | 0.5 × 5 | Non-coated | 1 layer of |
| | PVB, 5% | | | | areas | TPCF, hole in |
| | | | | | around | film on a top of |
| | | | | | coated. | coated area; 27 |
| | | | | | | ½ gauge needle |
| 113.2 | PVA- | AlSil 15% | — | 0.5 × 5 | Non-coated | 1 layer of |
| | PVB, 5% | | | | areas | TPCF, hole in |
| | | | | | around | film on a top of |
| | | | | | coated. | coated area; 27 |
| | | | | | | ½ gauge needle |
| 114-h | PVA- | AlSil 5% | — | 0.5 × 5 | Non-coated | 1 layer of |
| | PVB, 5% | | | | areas | TPCF, holes 21 |
| | | | | | around | ½ G needle |
| | | | | | coated. | |
| 113.1 | PVA- | AlSil 15% | — | 0.5 × 5 | Non-coated | 1 layer of |
| | PVB, 5% | | | | areas | TPCF, hole in |
| | | | | | around | film on a top of |
| | | | | | coated. | coated area; 27 |
| | | | | | | ½ gauge needle |
| 104.1 | PVA- | AlSil, 5% | TiO₂; 5% | 1 × 1 | Non-coated | 2 layers of |
| | PVB, 5% | | | | areas | TPCF, holes in |
| | | | | | around | both films on a |
| | | | | | coated. | top of coated |
| | | | | | *it wasn't a | area; 27 ½ |
| | | | | | good | gauge needle |
| | | | | | contrast | |
| | | | | | wet/dry | |
| 104.2 | PVA- | AlSil, 5% | TiO₂; 5% | 1 × 1 | Non-coated | 2 layers of |
| | PVB, 5% | | | | areas | TPCF, holes in |
| | | | | | around | both films on a |
| | | | | | coated. | top of coated |
| | | | | | *it wasn't a | area; 27 ½ |
| | | | | | good | gauge needle |
| | | | | | contrast | |
| | | | | | wet/dry | |
| 107.1 | PVA- | — | TiO₂; 2% | 1.5 × 2 | Non-coated | 2 layers of |
| | PVB, 5% | | | | areas | TPCF, holes in |
| | | | | | around | both films on a |
| | | | | | coated. | top of coated |
| | | | | | | area; 27 ½ |
| | | | | | | gauge needle |
| 107.2 | PVA- | — | TiO₂; 2% | 1 × 3 | Non-coated | 2 layers of |
| | PVB, 5% | | | | areas | TPCF, holes in |
| | | | | | around | both films on a |
| | | | | | coated. | top of coated |
| | | | | | | area; 27 ½ |
| | | | | | | gauge needle |
| 107.3 | PVA- | — | TiO₂; 2% | 2 × 2 | Non-coated | 2 layers of |
| | PVB, 5% | | | | areas | TPCF, holes in |
| | | | | | around | both films on a |
| | | | | | coated. | top of coated |
| | | | | | | area; 27 ½ |
| | | | | | | gauge needle |
| 104.4 | PVA- | AlSil, 5% | TiO₂; 5% | 1 × 1 | Non-coated | 2 layers of |
| | PVB, 5% | | | | areas | TPCF, holes in |
| | | | | | around | both films on a |
| | | | | | coated. | top of coated |
| | | | | | *it wasn't a | area; 27 ½ |
| | | | | | good | gauge needle |
| | | | | | contrast | |
| | | | | | wet/dry | |
| 108.2 | PVA- | AlSil 4.5% | Silica 300 | 0.5 × 1.5 | Non-coated | 2 layers of |
| | PVB, 5% | | 0.5% | | areas | TPCF, holes in |
| | | | | | around | both films on a |
| | | | | | coated. | top of coated |
| | | | | | | area; 27 ½ |
| | | | | | | gauge needle |
| 108.3 | PVA- | AlSil 4.5% | Silica 300 | 0.5 × 3.5 | Non-coated | 2 layers of |
| | PVB, 5% | | 0.5% | | areas | TPCF, holes in |
| | | | | | around | both films on a |
| | | | | | coated. | top of coated |
| | | | | | | area; 27 ½ |
| | | | | | | gauge needle |
| 108.10 | PVA- | AlSil 4.5% | Silica 300 | 3.5 × 0.5 | 1 layer of | 2 layers TPCF |
| | PVB, 5% | | 0.5% | | coating | |
| 108.11 | PVA- | AlSil 4.5% | Silica 300 | 3.5 × 0.5 | 1 layer of | 2 layers TPCF |
| | PVB, 5% | | 0.5% | | coating | |
| 109.3 | PVA- | AlSil 4% | Silica 300 | 0.5 × 3.5 | Non-coated | 1 layer of |
| | PVB, 5% | | 1% | | areas | TPCF, hole in |
| | | | | | around | film on a top of |
| | | | | | coated. | coated area; 27 |
| | | | | | | ½ gauge needle |
| 109.4 | PVA- | AlSil 4% | Silica 300 | 0.5 × 3.5 | Non-coated | 1 layer of |
| | PVB, 5% | | 1% | | areas | TPCF, hole in |
| | | | | | around | film on a top of |
| | | | | | coated. | coated area; 27 |
| | | | | | | ½ gauge needle |
| 107.7 | PVA- | — | TiO₂; 2% | 1 × 2.5 | Non-coated | 2 layers of |
| | PVB, 5% | | | | areas | TPCF, holes in |
| | | | | | around | both films on a |
| | | | | | coated. | top of coated |
| | | | | | | area; 27 ½ |
| | | | | | | gauge needle |

TABLE 4
Summary Tables for Results of Experimental
Variables for Devices Outcome

| | Wettability time - time to perceivable change in | |
|---|---|---|
| | colour of whole device and/or time taken for a travel | |
| | distance of perceivable change in colour from the | |
| Ex No. | hole | |
| 102.1 | Immediately* | |
| 102.2 | Immediately* | |
| 102.3 | Immediately* | |
| 103.1 | Immediately* | |
| 103.2 | Immediately* | |
| 104.5 | Immediately* | |
| 108.7-a | Immediately* | |
| 108.7-b | Immediately* | |
| 106.1 | Wet from bottom and top in 10 m | |
| 105.4 | 10 | min |
| 105.5 | 10 | min |
| 106.3 | Wet from bottom only; 30 m | |
| 106.2 | 40 | min |
| 105.1 | 1 | h |
| 107.4 | 1 | h |
| 105.2 | 1 h 10 m | |
| 105.3 | 1 h 20 m | |
| 104.3 | 1 h 40 m | |
| 108.5-a | 1 h 45 h | |
| 108.6-b | 1 h 45 m | |
| 108.5-d | 2 | h |
| 108.6-a | 2 | h |
| 109.2 | 2 h 12 m | |
| 108.5-b | 2 h 15 m | |
| 102.4 | 2 h 20 m | |
| 107.5 | 2 h 40 m | |
| 108.5-c | 2 h 45 m | |
| 108.6-c | 3 | h |
| 108.4 | 3 h 12 m | |
| 108.6-d | 3 h 15 m | |
| 108.8 | 4 | h |
| 108.1 | 4 h 12 m | |
| 109.1 | 5 h 12 m | |
| 108.9 | 6 | h |
| 107.6 | 30 | hr |

| | |
|---|---|
| 114-f | 2 cm:3 h 30 m |
| 114-b | 2 cm:3 h 50 m |
| 114-d | 2 cm:3 h 50 m |
| 114-g | 2 cm:3 h 50 m |
| 114-a | 2 cm:4 hr |
| 114-c | 2 cm:4 h |
| 114-e | 2 cm:4 h 20 m |
| 110 | 1.2 cm:8 h 20 m |
| | 2.5 cm:13 h 50 m |
| | 5c m:19 h 50 m |
| 111 | 1.2 cm:8 h 20 m |
| | 2.5 cm:13 h 50 m |
| | 5 cm:19 h 50 m |
| 112 | 1.2 cm:8 h 20 m |
| | 2.5 cm:13 h 50 m |
| | 4 cm:25 h |
| 113 | 1.2 cm:8 h 20 m |
| | 2.5 cm:13 h 50 m |
| | 4 cm:25 h |
| 114-h | 1 cm:2 h |
| | (the coating was broken |
| | when TPCF film applied) |
| 113 | Started wetting then stopped@1 cm |
| 104.1 | Not wet |
| 104.2 | Not wet |
| 107.1 | didn't get wet >48 hr |
| 107.2 | didn't get wet >48 hr |
| 107.3 | didn't get wet >48 hr |
| 104.4 | Not wet |
| 108.2 | Not wet |
| 108.3 | Not wet |
| 108.10 | Not wet |
| 108.11 | Not wet |
| 109.3 | Not wet |
| 109.4 | Not wet |
| 107.7 | n/a |

*immediately means wettability time was less than a few seconds

### Example 3

A device that will sink when adequate exposure of the tissue sample to the treatment medium was developed taking into consideration the ability of the changing density of the device after immersion in a formalin solution.

Gelatin was used as a base ingredient to prepare a foam layer and a film layer. Alumina-silica, silica, or titania particles were used to adjust/increase density of the device.

Devices with crosslinked gelatin foams with alumina-silica particles show good results when immersed in a water solution. However, when the solution is changed to formalin, the same samples do not sink in the same manner. Formalin has higher density and significantly (more than 2.5 times) lower surface tension than water. Further, formalin may crosslink with gelatin and harden the foam in a manner that water does not. For this reason, some devices became less flexible and, as a result, the formalin solution did not penetrate in foam in some devices as easily as water penetrated into the same devices. In order to explore these sinking times the following variables were considered:

Concentration of the alumina-silica particles was increased to increase average density of the samples.

Gelatin film has a higher density than formalin and some gelatin films sink in some formalin solutions. Double layer samples were prepared to increase density of the samples. The bottom layer was prepared as a gelatin film with or without alumina-silica particle and a top layer was prepared as a gelatin foam.

Devices were prepared using different thicknesses of gelatin foam. A single large gelatin foam was prepared and cut into smaller pieces, which pieces then had a portion of the foam removed. The amount of foam removed from each piece varied from 0% to 75%.

Titania (TiO₂) particles, which have higher density than alumina-silica (AlSi) particles, were used in some devices to further increase the average density of the samples.

Polypropylene glycol (PPG) or Glycerin (Gly), which has an ability to make film softer, was added to the film in some devices.

Sodium Dodecyl Sulfonate (SDS) surfactant, which promote foam formation and stability, was used in some formulations of foam to regulate foam quality.

### General Procedure for Preparation of a Two-Layer Sinking Device:

Prepare solutions for film and foam:
Dissolve required concentration of Porcine/Fish gelatin in distilled water at 50° C. with constant stirring for 90 minutes
Cool down the solution to 30-36° C.
Add required amount of AlSi/TiO₂ particles to the solution.
Mix the solution for at least 20 minutes
Add required amount of PPG/Gly to the film solution (bottom layer).
Add required amount of PPG/Gly to the foam solution (top layer).
Mix the solution for 10 minutes
Add required concentration of SDS to the foam solution.
Mix the solution for 10 minutes
Add required concentration of N-Hydroxysuccinimide (NHS) crosslinker component to the solutions.
Mix the solutions for 10 minutes
Prepare the required concentration of 1-Ethyl-3-(3-dimethylaminopropyl)carbodiimide (EDC) crosslinker component in distilled water solution.

2. Make the bottom layer (film layer):
Slowly add EDC solution into the gelatin solution with vigorous mixing.
Mix for 30-60 sec.
Pour the solution into a tray. Solution will start to gel.

3. Prepare the foam solution for the top layer.
Beat the gelatin solution with mixer/foamer to make a uniform foam for about 2 minutes until the foam is formed.
Slowly add the EDC solution into the foam with continuous mixing/foaming. Foam for an additional 20-30 sec after all the EDC solution is added to the foam.
Spread the foam on the top of the bottom layer solution with a spatula.

4. Samples were dried at room temperature in a well-ventilated area, and in some cases with blowing air for 24-72 hrs.

Devices prepared as described above where then added to a 10% formalin solution and the amount of time required for the device to sink was measured. The devices prepared were immersed in vertical position and sinking time was measure from the time vertical immersion was initiated. The devices usually remained in this vertical position, however, a few samples turned into a horizontal position and floated in that positon. Where horizontal floating occurred, it is noted in the results.

Devices prepared and tested according to the above have a wide range of sinking times ranging from hours to days. Table 5 sets out the various devices prepared according to the above procedure and Table 6 sets out the results of those devices in the sinking experiments.

TABLE 5
SUMMARY TABLE OF DEVICES PREPARED FOR SINKING EXPERIMENTS

| | Vol | Vol | | | Visual | Visual |
|---|---|---|---|---|---|---|
| | Bottom | Top | Bottom | Top | outcome | outcome |
| Sample | Layer | Layer, | layer | layer | after | after |
| No. | (mL) | (mL) | composition | composition | preparation | drying |
| 231 | 30 | 20 | 4 Porcine | 4 Porcine | Bottom - | Samples bent, |
| | | | gelatin | gelatin | solidified in | no foam, just |
| | | | 1 drop PPG | 3.5 TiO₂ | 30 min | film 0.7 mm |
| | | | 1 drop | 1 drop PPG | Top- thin | |
| | | | Glycerin | 1 drop | foam | |
| | | | | Glycerin | w/bubbles | |
| | | | | NHS, EDC | | |
| 132 | 50 | 25 | 4 Porcine | 2.5 Porcine | Foam is not | Not flexible |
| | | | gelatin | gelatin | very thick | bottom film, no |
| | | | | 5AlSil | | good |
| | | | | SDS | | connection |
| | | | | | | between layers |
| 135 | 50 | 25 | 4 Porcine | 2.5 Porcine | Foam is not | Not flexible |
| | | | gelatin | gelatin | very thick | bottom film. Top |
| | | | | 2.5 AlSil | | foam is not |
| | | | | SDS | | dense, not a |
| | | | | | | strong |
| | | | | | | attachment |
| 177 | 20 | 30 | 4 Porcine | 4 Porcine | Film and foam | After 48 h: |
| | | | gelatin | gelatin | solutions are | Uniform film and |
| | | | 4TiO₂ | NHS, EDC | good | foam (2-3 mm). |
| | | | 1 drop PPG | | | Film less |
| | | | NHS, EDC | | | flexible, matt |
| | | | 1 drop | | | |
| | | | Glycerin | | | |
| 48 | 20 | 30 | 6 PG | 6 PG | Good foam | A little bit bent, |
| | | | 6 AlSi | 6 AlSi | and solution | 3 mm, film |
| | | | 1 drop | NHS, EDC | | attached to |
| | | | PPG/50 ml | | | foam |
| 31 | 50 | — | 4 PG | — | Not a foam, | Hard film on |
| | | | 4 AlSi | | very thin, like | bottom, porous |
| | | | 1 drop PPG | | a thick | foam on top |
| | | | EDC (No | | solution | |
| | | | NHS) | | | |
| 84 | 25 | 25 | PG 4, | PG 2.5, | Uniform white | Hard 0.1 mm |
| | | | NHS 0.04, | AlSi 5, | film. Uniform | film, 3 mm foam |
| | | | EDC 0.2, | SDS 0.015 | Foam | on the top. |
| | | | 30 min wait | | | Bottom film is |
| | | | before top is | | | not flexible |
| | | | spread | | | |
| 250 | 30 | 20 | 4 Porcine | 4 Porcine | Bottom: not | Top is not very |
| | | | gelatin | gelatin | uniform | uniform (comp |
| | | | 3.5 TiO₂ | | Foam was | 94) |
| | | | 3 drops PPG | | good | Bottom - not all |
| | | | 3 drops | | | TiO2 has |
| | | | Glycerin | | | dissolved, some |
| | | | NHS, EDC | | | precipitate on |
| | | | | | | the bottom |
| 83 | 25 | 25 | PG 4, | PG 2.5, | Uniform white | Hard 0.1 mm |
| | | | NHS 0.04, | AlSi 5, | film. Uniform | film, 3 mm foam |
| | | | EDC 0.2, | SDS 0.015 | Foam | on the top. |
| | | | 30 min wait | | | Bottom film is |
| | | | before top is | | | not flexible |
| | | | spread | | | |
| 128 | 30 | 20 | 4 Porcine | 4 Porcine | Foam is good | Top: quite thin |
| | | | gelatin | gelatin | | Bottom: thin, |
| | | | 4TiO₂ | 1 drop PPG | | flex |
| | | | 1 dr PPG | NHS, EDC | | |
| | | | NHS, EDC | | | |
| 133 | 50 | 25 | 4 Porcine | 2.5 Porcine | Foam is not | Not flexible |
| | | | gelatin | gelatin | very thick | bottom film, no |
| | | | | 5AlSil | | good |
| | | | | SDS | | connection |
| | | | | | | between layers |
| 187 | 30 | 30 | 4 Porcine | 4 Porcine | Film and foam | After 48 h: |
| | | | gelatin | gelatin | solutions are | Not bent, |
| | | | 3.5 TiO₂ | NHS, EDC | good | Foam 0.2 mm. |
| | | | 1 drop PPG | | | Bottom 3 mm, |
| | | | NHS, EDC | | | flexible, shiny |
| | | | 1 drop | | | |
| | | | Glycerin | | | |
| 205 | 30 | 30 | 4 Porcine | 4 Porcine | Film and foam | After 48 h: |
| | | | gelatin | gelatin | solutions are | Not bent, |
| | | | 3.5 TiO₂ | NHS, EDC | good | Foam 0.2 mm. |
| | | | 1 drop PPG | | | Bottom 3 mm, |
| | | | NHS, EDC | | | flexible, shiny |
| | | | 1 drop | | | |
| | | | Glycerin | | | |
| 308 | 30 | 20 | 4 Porcine | 4 Porcine | Top: Good | Top (foam) |
| | | | gelatin | gelatin | foam | uniform, some |
| | | | 3.5 TiO₂ | 1.75 TiO₂ | Bottom: | tiny holes from |
| | | | 1 small drop | 1 big dr | | bubbles |
| | | | Glycerin | Glycerin | | Bottom uniform, |
| | | | NHS, EDC | NHS, EDC | | semi-shiny. |
| | | | | | | A little cracks |
| | | | | | | when cut, quite |
| | | | | | | flexible |
| | | | | | | Bottom 0.1 mm |
| | | | | | | Top 2.5-3.0 mm |
| 85 | 25 | 25 | PG 4, | PG 2.5, | Uniform white | Hard 0.1 mm |
| | | | NHS 0.04, | AlSi 5, | film. Uniform | film, 3 mm foam |
| | | | EDC 0.2, | SDS 0.015 | Foam | on the top. |
| | | | 30 min wait | | | Bottom film is |
| | | | before top is | | | not flexible |
| | | | spread | | | |
| 94 | 25 | 16 | PG 4, | PG 4, | Uniform white | Not very hard |
| | | | TiO2 4, | TiO2 4, | film. Uniform | 0.1 mm film, 3 |
| | | | NHS 0.04, | SDS 0.015 | foam. | mm foam on the |
| | | | EDC 0.2, | | | top. |
| | | | 30 min wait | | | |
| | | | before top is | | | |
| | | | spread | | | |
| 100 | 25 | 25 | PG 4, | PG 4, | Uniform white | Flexible0.1 mm |
| | | | TiO2 4, | TiO2 4, | film. Uniform | film, 2 mm foam |
| | | | PPG 0.015, | SDS 0.015 | foam. | on the top. |
| | | | NHS 0.04, | | | |
| | | | EDC 0.2, 20 | | | |
| | | | min wait | | | |
| | | | before top is | | | |
| | | | spread | | | |
| 227 | 25 | 20 | 4 Porcine | 4 Porcine | Good foam | Top: Not |
| | | | gelatin | gelatin | | uniform 1-3 mm, |
| | | | 3.5 TiO₂ | NHS, EDC | | thick |
| | | | 1 drop PPG | | | |
| | | | 1 drop | | | |
| | | | Glycerin | | | |
| | | | NHS, EDC | | | |
| 252 | 30 | 20 | 4 Porcine | 4 Porcine | Bottom: not | Top is not very |
| | | | gelatin | gelatin | uniform | uniform (comp |
| | | | 3.5 TiO₂ | | Foam was | 94) |
| | | | 3 drops PPG | | good | Bottom - not all |
| | | | 3 drops | | | TiO2 has |
| | | | Glycerin | | | dissolved, some |
| | | | NHS, EDC | | | precipitate on |
| | | | | | | the bottom |
| 286 | 30 | 20 | 4 Porcine | 4 Porcine | Bottom: not | Top is uniform. |
| | | | gelatin | gelatin | uniform | Bottom - not all |
| | | | 3.5 TiO₂ | 4 drops | Foam was | TiO2 has |
| | | | 3 drops PPG | Glycerin | good | dissolved, some |
| | | | 3 drops | | | precipitate on |
| | | | Glycerin | | | the bottom |
| | | | NHS, EDC | | | |
| 6 | 50 | — | 2 FG | — | Thick solution | Thin, hard, |
| | | | 4 AlSi | | | brittle |
| | | | 0.2 PPG | | | |
| | | | NHS, EDC | | | |
| 19 | 50 | — | 4 PG | — | Thin foam | Good foam |
| | | | 4 AlSi | | | |
| | | | NHS, EDC | | | |
| 58 | 50 | — | 4 PG | — | Good sample | Hard, bent |
| | | | 4 AlSi | | solution, not | |
| | | | 1 drop PPG | | very foamy | |
| 158 | 30 | 20 | 4 Porcine | 4 Porcine | Foam not | Top: thin foam |
| | | | gelatin | gelatin | very thick | Bottom: not |
| | | | 4 AlSil | 1 dr PPG | | flexible, |
| | | | 1 dr PPG | NHS, EDC | | Good |
| | | | NHS, EDC | | | attachment |
| | | | | | | between layers |
| 317 | 30 | 20 | 4 Porcine | 4 Porcine | Top: Good | Top (foam) |
| | | | gelatin | gelatin | foam | uniform, some |
| | | | 3.5 TiO₂ | 1.75 TiO₂ | Bottom: | tiny holes from |
| | | | 1 small drop | 1 big dr | | bubbles |
| | | | Glycerin | Glycerin | | Bottom uniform, |
| | | | NHS, EDC | NHS, EDC | | semi-shiny. |
| | | | | | | A little cracks |
| | | | | | | when cut, quite |
| | | | | | | flexible |
| | | | | | | Bottom 0.1 mm |
| | | | | | | Top 2.5-3.0 mm |
| 7 | 50 | — | 2 FG | — | Thick solution | Thin, hard, |
| | | | 4 AlSi | | | brittle |
| | | | 0.2 PPG | | | |
| | | | NHS, EDC | | | |
| 21 | 50 | — | 4 PG | — | Medium | Good foam |
| | | | 4 AlSi | | thickness of | |
| | | | NHS, EDC | | foam | |
| 150 | 20 | 30 | 4 Porcine | 4 Porcine | Foam not | Top: foam 3 mm |
| | | | gelatin | gelatin | very thick | Bottom: thin, not |
| | | | 4TiO₂ | 1 dr PPG | | flexible, bubbles |
| | | | 1 dr PPG | NHS, EDC | | |
| | | | NHS, EDC | | | |
| 176 | 30 | 20 | 4 Porcine | 4 Porcine | Film and foam | After 48 h: |
| | | | gelatin | gelatin | solutions are | Uniform film and |
| | | | 4TiO₂ | NHS, EDC | good | foam (1 mm). |
| | | | 1 drop PPG | | | Film flexible, |
| | | | NHS, EDC | | | shiny |
| | | | 1 drop | | | |
| | | | Glycerin | | | |
| 285 | 30 | 20 | 4 Porcine | 4 Porcine | Bottom: not | Top is uniform. |
| | | | gelatin | gelatin | uniform | Bottom - not all |
| | | | 3.5 TiO₂ | 4 drops | Foam was | TiO2 has |
| | | | 3 drops PPG | Glycerin | good | dissolved, some |
| | | | 3 drops | | | precipitate on |
| | | | Glycerin | | | the bottom |
| | | | NHS, EDC | | | |
| 305 | 30 | 20 | 4 Porcine | 4 Porcine | Top: Good | Top (foam) |
| | | | gelatin | gelatin | foam | uniform, some |
| | | | 3.5 TiO₂ | 1.75 TiO₂ | Bottom: | tiny holes from |
| | | | 1 small drop | 1 big dr | | bubbles |
| | | | Glycerin | Glycerin | | Bottom uniform, |
| | | | NHS, EDC | NHS, EDC | | semi-shiny. |
| | | | | | | A little cracks |
| | | | | | | when cut, quite |
| | | | | | | flexible |
| | | | | | | Bottom 0.1 mm |
| | | | | | | Top 2.5-3.0 mm |
| 302 | 30 | 20 | 4 Porcine | 4 Porcine | Top: Good | Top (foam) |
| | | | gelatin | gelatin | foam | uniform, some |
| | | | 3.5 TiO₂ | 1.75 TiO₂ | Bottom: | tiny holes from |
| | | | 1 small drop | 1 big dr | | bubbles |
| | | | Glycerin | Glycerin | | Bottom uniform, |
| | | | NHS, EDC | NHS, EDC | | semi-shiny. |
| | | | | | | A little cracks |
| | | | | | | when cut, quite |
| | | | | | | flexible |
| | | | | | | Bottom 0.1 mm |
| | | | | | | Top 2.5-3.0 mm |
| 307 | 30 | 20 | 4 Porcine | 4 Porcine | Top: Good | Top (foam) |
| | | | gelatin | gelatin | foam | uniform, some |
| | | | 3.5 TiO₂ | 1.75 TiO₂ | Bottom: | tiny holes from |
| | | | 1 small drop | 1 big dr | | bubbles |
| | | | Glycerin | Glycerin | | Bottom uniform, |
| | | | NHS, EDC | NHS, EDC | | semi-shiny. |
| | | | | | | A little cracks |
| | | | | | | when cut, quite |
| | | | | | | flexible |
| | | | | | | Bottom 0.1 mm |
| | | | | | | Top 2.5-3.0 mm |
| 33 | 50 | — | 4 PG | — | Medium | Hard, bent |
| | | | 4 AlSi | | thickness | |
| | | | 1 drop PPG | | foam solution | |
| 261 | 30 | 20 | 4 Porcine | 4 Porcine | Bottom: not | Top is uniform. |
| | | | gelatin | gelatin | uniform | Bottom - not all |
| | | | 3.5 TiO₂ | 4 drops | Foam was | TiO2 has |
| | | | 3 drops PPG | Glycerin | good | dissolved, some |
| | | | 3 drops | | | precipitate on |
| | | | Glycerin | | | the bottom |
| | | | NHS, EDC | | | |
| 267 | 30 | 20 | 4 Porcine | 4 Porcine | Bottom: not | Top is uniform. |
| | | | gelatin | gelatin | uniform | Bottom - not all |
| | | | 3.5 TiO₂ | 4 drops | Foam was | TiO2 has |
| | | | 3 drops PPG | Glycerin | good | dissolved, some |
| | | | 3 drops | | | precipitate on |
| | | | Glycerin | | | the bottom |
| | | | NHS, EDC | | | |
| 215 | 20 | 20 | 4 Porcine | 4 Porcine | | Top: Not |
| | | | gelatin | gelatin | | uniform 1-3 mm, |
| | | | 3.5 TiO₂ | NHS, EDC | | thick |
| | | | 1 drop PPG | | | |
| | | | 1 drop | | | |
| | | | Glycerin | | | |
| | | | NHS, EDC | | | |
| 258 | 30 | 20 | 4 Porcine | 4 Porcine | Bottom: not | Top is not very |
| | | | gelatin | gelatin | uniform | uniform (comp |
| | | | 3.5 TiO₂ | | Foam was | 94) |
| | | | 3 drops PPG | | good | Bottom - not all |
| | | | 3 drops | | | TiO2 has |
| | | | Glycerin | | | dissolved, some |
| | | | NHS, EDC | | | precipitate on |
| | | | | | | the bottom |
| 284 | 30 | 20 | 4 Porcine | 4 Porcine | Bottom: not | Top is uniform. |
| | | | gelatin | gelatin | uniform | Bottom - not all |
| | | | 3.5 TiO₂ | 4 drops | Foam was | TiO2 has |
| | | | 3 drops PPG | Glycerin | good | dissolved, some |
| | | | 3 drops | | | precipitate on |
| | | | Glycerin | | | the bottom |
| | | | NHS, EDC | | | |
| 50 | 30 | 20 | 6 PG | 6 PG | Good foam | Two air pockets: |
| | | | 6 AlSi | 6 AlSi | and solution | film separated |
| | | | 1 drop | NHS, EDC | | from foam |
| | | | PPG/50 ml | | | |
| 54 | 15 | — | 6 PG | — | Good solution | Hard dry film, |
| | | | 6 AlSi | | | shrank a lot |
| | | | NHS, EDC | | | |
| 111 | 40 | 25 | 4 Porcine | 4 Porcine | Foam not | Top: foam is |
| | | | gelatin | gelatin | very thick | thin Bottom: film |
| | | | 4TiO₂ | 1 dr PPG | | has medium |
| | | | 2 drops PPG | NHS, EDC | | flexibility |
| | | | NHS, EDC | | | |
| 143 | 30 | 20 | 4 Porcine | 4 Porcine | Foam not | Top: foam |
| | | | gelatin | gelatin | very thick | 2.5 mm |
| | | | 4TiO₂ | 1 dr PPG | | Bottom: thin, not |
| | | | 1 dr PPG | NHS, EDC | | flexible |
| | | | NHS, EDC | | | |
| 256 | 30 | 20 | 4 Porcine | 4 Porcine | Bottom: not | Top is not very |
| | | | gelatin | gelatin | uniform | uniform (comp |
| | | | 3.5 TiO₂ | | Foam was | 94) |
| | | | 3 drops PPG | | good | Bottom - not all |
| | | | 3 drops | | | TiO2 has |
| | | | Glycerin | | | dissolved, some |
| | | | NHS, EDC | | | precipitate on |
| | | | | | | the bottom |
| 59 | 50 | — | 4 PG | — | Good sample | Hard, bent |
| | | | 4 AlSi | | solution, not | |
| | | | 1 drop PPG | | very foamy | |
| 228 | 25 | 20 | 4 Porcine | 4 Porcine | Good foam | Top: Not |
| | | | gelatin | gelatin | | uniform 1-3 mm, |
| | | | 3.5 TiO₂ | NHS, EDC | | thick |
| | | | 1 drop PPG | | | |
| | | | 1 drop | | | |
| | | | Glycerin | | | |
| | | | NHS, EDC | | | |
| 156 | 30 | 20 | 4 Porcine | 4 Porcine | Foam not | Top: thin foam |
| | | | gelatin | gelatin | very thick | Bottom: not |
| | | | 4 AlSil | 1 dr PPG | | flexible, |
| | | | 1 dr PPG | NHS, EDC | | Good |
| | | | NHS, EDC | | | attachment |
| | | | | | | between layers |
| 282 | 30 | 20 | 4 Porcine | 4 Porcine | Bottom: not | Top is uniform. |
| | | | gelatin | gelatin | uniform | Bottom - not all |
| | | | 3.5 TiO₂ | 4 drops | Foam was | TiO2 has |
| | | | 3 drops PPG | Glycerin | good | dissolved, some |
| | | | 3 drops | | | precipitate on |
| | | | Glycerin | | | the bottom |
| | | | NHS, EDC | | | |
| 32 | 50 | — | 4 PG | — | Not a foam, | Hard film on |
| | | | 4 AlSi | | very thin, like | bottom, porous |
| | | | 1 drop PPG | | a thick | foam on top |
| | | | EDC (No | | solution | |
| | | | NHS) | | | |
| 98 | 25 | 16 | PG 4, | PG 4, | Uniform white | Not very hard |
| | | | TiO2 4, | TiO2 4, | film. Uniform | 0.1 mm film, 3 |
| | | | NHS 0.04, | SDS 0.015 | foam. | mm foam on the |
| | | | EDC 0.2, | | | top. |
| | | | 30 min wait | | | |
| | | | before top is | | | |
| | | | spread | | | |
| 141 | 30 | 20 | 4 Porcine | 4 Porcine | Foam not | Top: foam |
| | | | gelatin | gelatin | very thick | 2.5 mm |
| | | | 4TiO₂ | 1 dr PPG | | Bottom: thin, not |
| | | | 1 dr PPG | NHS, EDC | | flexible |
| | | | NHS, EDC | | | |
| 216 | 20 | 20 | 4 Porcine | 4 Porcine | | Top: Not |
| | | | gelatin | gelatin | | uniform 1-3 mm, |
| | | | 3.5 TiO₂ | NHS, EDC | | thick |
| | | | 1 drop PPG | | | |
| | | | 1 drop | | | |
| | | | Glycerin | | | |
| | | | NHS, EDC | | | |
| 232 | 25 | 20 | 4 Porcine | 4 Porcine | Top- foam | Uniform |
| | | | gelatin | gelatin | was blended | |
| | | | 3.5 TiO₂ | NHS, EDC | less, thin | |
| | | | 1 drop PPG | | | |
| | | | 1 drop | | | |
| | | | Glycerin | | | |
| | | | NHS, EDC | | | |
| 312 | 30 | 20 | 4 Porcine | 4 Porcine | Top: Good | Top (foam) |
| | | | gelatin | gelatin | foam | uniform, some |
| | | | 3.5 TiO₂ | 1.75 TiO₂ | Bottom: | tiny holes from |
| | | | 1 small drop | 1 big dr | | bubbles |
| | | | Glycerin | Glycerin | | Bottom uniform, |
| | | | NHS, EDC | NHS, EDC | | semi-shiny. |
| | | | | | | A little cracks |
| | | | | | | when cut, quite |
| | | | | | | flexible |
| | | | | | | Bottom 0.1 mm |
| | | | | | | Top 2.5-3.0 mm |
| 30 | 50 | — | 4 PG | — | Foam very | Very hard film, |
| | | | 4 AlSi | | thin, like a | not possible to |
| | | | 0.05 PPG | | solution | cut |
| | | | EDC (No | | | |
| | | | NHS) | | | |
| 99 | 25 | 25 | PG 4, | PG 4, | Uniform white | Flexible0.1 mm |
| | | | TiO2 4, | TiO2 4, | film. Uniform | film, 2 mm foam |
| | | | PPG 0.015, | SDS 0.015 | foam. | on the top. |
| | | | NHS 0.04, | | | |
| | | | EDC 0.2, 20 | | | |
| | | | min wait | | | |
| | | | before top is | | | |
| | | | spread | | | |
| 164 | 20 | 30 | 4 Porcine | 4 Porcine | Foam not | Top: thin foam |
| | | | gelatin | gelatin | very thick | Bottom: not |
| | | | 4 AlSil | 1 drop PPG | | flexible, |
| | | | 1 drop PPG | NHS, EDC | | Good |
| | | | NHS, EDC | | | attachment |
| | | | | | | between layers. |
| | | | | | | Compare to #80, |
| | | | | | | this sample |
| | | | | | | has thinner film |
| | | | | | | and thicker |
| | | | | | | foam |
| 112 | 40 | 25 | 4 Porcine | 4 Porcine | Foam not | Top: foam is |
| | | | gelatin | gelatin | very thick | thin Bottom: film |
| | | | 4TiO₂ | 1 dr PPG | | has medium |
| | | | 2 drops PPG | NHS, EDC | | flexibility |
| | | | NHS, EDC | | | |
| 319 | 20 | 30 | 4 Porcine | 4 Porcine | Good foam | Top (foam) |
| | | | gelatin | gelatin | | uniform, some |
| | | | 3.5 TiO₂ | 1.75 TiO₂ | | tiny holes from |
| | | | 1 small drop | 1 big dr | | bubbles |
| | | | Glycerine | Glycerine | | Bottom uniform, |
| | | | NHS, EDC | NHS, EDC | | semi-shiny. |
| | | | | | | A little cracks |
| | | | | | | when cut, quite |
| | | | | | | flexible |
| | | | | | | Bottom 0.1 mm |
| | | | | | | Top 2.5-3.0 mm |
| 144 | 30 | 20 | 4 Porcine | 4 Porcine | Foam not | Top: foam |
| | | | gelatin | gelatin | very thick | 2.5 mm |
| | | | 4TiO₂ | 1 dr PPG | | Bottom: thin, not |
| | | | 1 dr PPG | NHS, EDC | | flexible |
| | | | NHS, EDC | | | |
| 235 | 25 | 20 | 4 Porcine | 4 Porcine | Top- foam | Uniform |
| | | | gelatin | gelatin | was blended | |
| | | | 3.5 TiO₂ | NHS, EDC | less, thin | |
| | | | 1 drop PPG | | | |
| | | | 1 drop | | | |
| | | | Glycerin | | | |
| | | | NHS, EDC | | | |
| 277 | 30 | 20 | 4 Porcine | 4 Porcine | Bottom: not | Top is uniform. |
| | | | gelatin | gelatin | uniform | Bottom - not all |
| | | | 3.5 TiO₂ | 4 drops | Foam was | TiO2 has |
| | | | 3 drops PPG | Glycerin | good | dissolved, some |
| | | | 3 drops | | | precipitate on |
| | | | Glycerin | | | the bottom |
| | | | NHS, EDC | | | |
| 278 | 30 | 20 | 4 Porcine | 4 Porcine | Bottom: not | Top is uniform. |
| | | | gelatin | gelatin | uniform | Bottom - not all |
| | | | 3.5 TiO₂ | 4 drops | Foam was | TiO2 has |
| | | | 3 drops PPG | Glycerin | good | dissolved, some |
| | | | 3 drops | | | precipitate on |
| | | | Glycerin | | | the bottom |
| | | | NHS, EDC | | | |
| 292 | 30 | 20 | 4 Porcine | 4 Porcine | Good foam | After 4 days: |
| | | | gelatin | gelatin | for top, | Bottom is matt |
| | | | 3.5 TiO₂ | 5% or2drops | normal | around 1 cm. |
| | | | 5% Glycerin | Glycerin | bottom | Mid part is |
| | | | (to gelatin) | | | glossy, flexible, |
| | | | NHS, EDC | | | uniform, no |
| | | | | | | cracks |
| | | | | | | Bottom &Top |
| | | | | | | 1 mm |
| 293 | 30 | 20 | 4 Porcine | 4 Porcine | Good foam | After 4 days: |
| | | | gelatin | gelatin | for top, | Bottom is matt |
| | | | 3.5 TiO₂ | 5% or2drops | normal | around 1 cm. |
| | | | 5% Glycerin | Glycerin | bottom | Mid part is |
| | | | (to gelatin) | | | glossy, flexible, |
| | | | NHS, EDC | | | uniform, no |
| | | | | | | cracks |
| | | | | | | Bottom &Top |
| | | | | | | 1 mm |
| 304 | 30 | 20 | 4 Porcine | 4 Porcine | Top: Good | Top (foam) |
| | | | gelatin | gelatin | foam | uniform, some |
| | | | 3.5 TiO₂ | 1.75 TiO₂ | Bottom: | tiny holes from |
| | | | 1 small drop | 1 big dr | | bubbles |
| | | | Glycerin | Glycerin | | Bottom uniform, |
| | | | NHS, EDC | NHS, EDC | | semi-shiny. |
| | | | | | | A little cracks |
| | | | | | | when cut, quite |
| | | | | | | flexible |
| | | | | | | Bottom 0.1 mm |
| | | | | | | Top 2.5-3.0 mm |
| 318 | 30 | 20 | 4 Porcine | 4 Porcine | Top: Good | Top (foam) |
| | | | gelatin | gelatin | foam | uniform, some |
| | | | 3.5 TiO₂ | 1.75 TiO₂ | Bottom: | tiny holes from |
| | | | 1 small drop | 1 big dr | | bubbles |
| | | | Glycerin | Glycerin | | Bottom uniform, |
| | | | NHS, EDC | NHS, EDC | | semi-shiny. |
| | | | | | | A little cracks |
| | | | | | | when cut, quite |
| | | | | | | flexible |
| | | | | | | Bottom 0.1 mm |
| | | | | | | Top 2.5-3.0 mm |
| 34 | 50 | — | 4 PG | — | Medium | Hard, bent |
| | | | 4 AlSi | | thickness | |
| | | | 1 drop PPG | | foam solution | |
| 103 | 25 | 8 | 4 Porcine | 4 Por | Good foam | Top: uniform, |
| | #56 | | gelatin | 4 TiO₂ | | flexible, white |
| | | | 4TiO₂ | SDS | | Bottom: clear, |
| | | | 1 dr PPG | | | not |
| | | | | | | flexible, 0.1 mm |
| 257 | 30 | 20 | 4 Porcine | 4 Porcine | Bottom: not | Top is not very |
| | | | gelatin | gelatin | uniform | uniform (comp |
| | | | 3.5 TiO₂ | | Foam was | 94) |
| | | | 3 drops PPG | | good | Bottom - not all |
| | | | 3 drops | | | TiO2 has |
| | | | Glycerin | | | dissolved, some |
| | | | NHS, EDC | | | precipitate on |
| | | | | | | the bottom |
| 229 | 25 | 20 | 4 Porcine | 4 Porcine | Good foam | Top: Not |
| | | | gelatin | gelatin | | uniform 1-3 mm, |
| | | | 3.5 TiO₂ | NHS, EDC | | thick |
| | | | 1 drop PPG | | | |
| | | | 1 drop | | | |
| | | | Glycerin | | | |
| | | | NHS, EDC | | | |
| 212 | 20 | 20 | 4 Porcine | 4 Porcine | | Top: Not |
| | | | gelatin | gelatin | | uniform 1-3 mm, |
| | | | 3.5 TiO₂ | NHS, EDC | | thick |
| | | | 1 drop PPG | | | |
| | | | 1 drop | | | |
| | | | Glycerin | | | |
| | | | NHS, EDC | | | |
| 161 | 20 | 30 | 4 Porcine | 4 Porcine | Foam not | Top: thin foam |
| | | | gelatin | gelatin | very thick | Bottom: not |
| | | | 4 AlSil | 1 drop PPG | | flexible, |
| | | | 1 drop PPG | NHS, EDC | | Good |
| | | | NHS, EDC | | | attachment |
| | | | | | | between layers. |
| | | | | | | Compare to |
| | | | | | | #80, this sample |
| | | | | | | has thinner film |
| | | | | | | and thicker |
| | | | | | | foam |
| 288 | 30 | 20 | 4 Porcine | 4 Porcine | Bottom: not | Top is uniform. |
| | | | gelatin | gelatin | uniform | Bottom - not all |
| | | | 3.5 TiO₂ | 4 drops | Foam was | TiO2 has |
| | | | 3 drops PPG | Glycerin | good | dissolved, some |
| | | | 3 drops | | | precipitate on |
| | | | Glycerin | | | the bottom |
| | | | NHS, EDC | | | |
| 197 | 30 | 30 | 4 Porcine | 4 Porcine | Film and foam | After 48 h: |
| | | | gelatin | gelatin | solutions are | Not bent, |
| | | | 3.5 TiO₂ | NHS, EDC | good | Foam 0.2 mm. |
| | | | 1 drop PPG | | | Bottom 3 mm, |
| | | | NHS, EDC | | | flexible, shiny |
| | | | 1 drop | | | |
| | | | Glycerin | | | |
| 316 | 30 | 20 | 4 Porcine | 4 Porcine | Top: Good | Top (foam) |
| | | | gelatin | gelatin | foam | uniform, some |
| | | | 3.5 TiO₂ | 1.75 TiO₂ | Bottom: | tiny holes from |
| | | | 1 small drop | 1 big dr | | bubbles |
| | | | Glycerin | Glycerin | | Bottom uniform, |
| | | | NHS, EDC | NHS, EDC | | semi-shiny. |
| | | | | | | A little cracks |
| | | | | | | when cut, quite |
| | | | | | | flexible |
| | | | | | | Bottom 0.1 mm |
| | | | | | | Top 2.5-3.0 mm |
| 110 | 50 | 25 | 4 Porcine | 4 Porcine | Foam not | Top: foam is |
| | | | gelatin | gelatin | very thick | quite thin |
| | | | 4TiO₂ | 1 dr PPG | | Bottom: film is |
| | | | 1 drop PPG | | | thick and not |
| | | | NHS, EDC | | | very flexible |
| 262 | 30 | 20 | 4 Porcine | 4 Porcine | Bottom: not | Top is uniform. |
| | | | gelatin | gelatin | uniform | Bottom - not all |
| | | | 3.5 TiO₂ | 4 drops | Foam was | TiO2 has |
| | | | 3 drops PPG | Glycerin | good | dissolved, some |
| | | | 3 drops | | | precipitate on |
| | | | Glycerin | | | the bottom |
| | | | NHS, EDC | | | |
| 300 | 30 | 20 | 4 Porcine | 4 Porcine | Top: Good | Top (foam) |
| | | | gelatin | gelatin | foam | uniform, some |
| | | | 3.5 TiO₂ | 1.75 TiO₂ | Bottom: | tiny holes from |
| | | | 1 small drop | 1 big dr | | bubbles |
| | | | Glycerin | Glycerin | | Bottom uniform, |
| | | | NHS, EDC | NHS, EDC | | semi-shiny. |
| | | | | | | A little cracks |
| | | | | | | when cut, quite |
| | | | | | | flexible |
| | | | | | | Bottom 0.1 mm |
| | | | | | | Top 2.5-3.0 mm |
| 102 | 25 | 8 | 4 Porcine | 4 Por | Good foam | Top: uniform, |
| | #56 | | gelatin | 4 TiO₂ | | flexible, white |
| | | | 4TiO₂ | SDS | | Bottom: clear, |
| | | | 1 dr PPG | | | not |
| | | | | | | flexible, 0.1 mm |
| 294 | 30 | 20 | 4 Porcine | 4 Porcine | Good foam | After 4 days: |
| | | | gelatin | gelatin | for top, | Bottom is matt |
| | | | 3.5 TiO₂ | 5% or2drops | normal | around 1 cm. |
| | | | 5% Glycerin | Glycerin | bottom | Mid part is |
| | | | (to gelatin) | | | glossy, flexible, |
| | | | NHS, EDC | | | uniform, no |
| | | | | | | cracks |
| | | | | | | Bottom &Top |
| | | | | | | 1 mm |
| 69 | 25 | 25 | PG 2.5, | PG 2.5, | Uniform white | Hard 0.1 mm |
| | | | AlSi 5, | AlSi 5, | film. | film, 2 mm foam |
| | | | SDS 0.03, | SDS 0.03 | Precipitate | on the top. |
| | | | NHS 0.04 | NHS 0.04 | AlSi. Uniform | Difficult to cut |
| | | | EDC 0.2, | EDC 0.2 | Foam | bottom film. |
| | | | 20 min wait | | | |
| | | | before top is | | | |
| | | | spread | | | |
| 247 | 30 | 20 | 4 Porcine | 4 Porcine | Bottom: not | Top is not very |
| | | | gelatin | gelatin | uniform | uniform (comp |
| | | | 3.5 TiO₂ | | Foam was | 94) |
| | | | 3 drops PPG | | good | Bottom - not all |
| | | | 3 drops | | | TiO2 has |
| | | | Glycerin | | | dissolved, some |
| | | | NHS, EDC | | | precipitate on |
| | | | | | | the bottom |
| 180 | 20 | 30 | 4 Porcine | 4 Porcine | Film and foam | After 48 h: |
| | | | gelatin | gelatin | solutions are | Uniform film and |
| | | | 4TiO₂ | NHS, EDC | good | foam (2-3 mm). |
| | | | 1 drop PPG | | | Film less |
| | | | NHS, EDC | | | flexible, matt |
| | | | 1 drop | | | |
| | | | Glycerin | | | |
| 201 | 30 | 30 | 4 Porcine | 4 Porcine | Film and foam | After 48 h: |
| | | | gelatin | gelatin | solutions are | Not bent, |
| | | | 3.5 TiO₂ | NHS, EDC | good | Foam 0.2 mm. |
| | | | 1 drop PPG | | | Bottom 3 mm, |
| | | | NHS, EDC | | | flexible, shiny |
| | | | 1 drop | | | |
| | | | Glycerin | | | |
| 207 | 30 | 30 | 4 Porcine | 4 Porcine | Film and foam | After 48 h: |
| | | | gelatin | gelatin | solutions are | Not bent, |
| | | | 3.5 TiO₂ | NHS, EDC | good | Foam 0.2 mm. |
| | | | 1 drop PPG | | | Bottom 3 mm, |
| | | | NHS, EDC | | | flexible, shiny |
| | | | 1 drop | | | |
| | | | Glycerin | | | |
| 217 | 20 | 20 | 4 Porcine | 4 Porcine | | Top: Not |
| | | | gelatin | gelatin | | uniform 1-3 mm, |
| | | | 3.5 TiO₂ | NHS, EDC | | thick |
| | | | 1 drop PPG | | | |
| | | | 1 drop | | | |
| | | | Glycerin | | | |
| | | | NHS, EDC | | | |
| 70 | 25 | 25 | PG 2.5, | PG 2.5, | Uniform white | Hard 0.1 mm |
| | | | AlSi 5, | AlSi 5, | film. | film, 2 mm foam |
| | | | SDS 0.03, | SDS 0.03 | Precipitate | on the top. |
| | | | NHS 0.04 | NHS 0.04 | AlSi. Uniform | Difficult to cut |
| | | | EDC 0.2, | EDC 0.2 | Foam | bottom film. |
| | | | 20 min wait | | | |
| | | | before top is | | | |
| | | | spread | | | |
| 157 | 30 | 20 | 4 Porcine | 4 Porcine | Foam not | Top: thin foam |
| | | | gelatin | gelatin | very thick | Bottom: not |
| | | | 4 AlSil | 1 dr PPG | | flexible, |
| | | | 1 dr PPG | NHS, EDC | | Good |
| | | | NHS, EDC | | | attachment |
| | | | | | | between layers |
| 200 | 30 | 30 | 4 Porcine | 4 Porcine | Film and foam | After 48 h: |
| | | | gelatin | gelatin | solutions are | Not bent, |
| | | | 3.5 TiO₂ | NHS, EDC | good | Foam 0.2 mm. |
| | | | 1 drop PPG | | | Bottom 3 mm, |
| | | | NHS, EDC | | | flexible, shiny |
| | | | 1 drop | | | |
| | | | Glycerin | | | |
| 246 | 30 | 20 | 4 Porcine | 4 Porcine | Bottom: not | Top is not very |
| | | | gelatin | gelatin | uniform | uniform (comp |
| | | | 3.5 TiO₂ | | Foam was | 94) |
| | | | 3 drops PPG | | good | Bottom - not all |
| | | | 3 drops | | | TiO2 has |
| | | | Glycerin | | | dissolved, some |
| | | | NHS, EDC | | | precipitate on |
| | | | | | | the bottom |
| 181 | 20 | 30 | 4 Porcine | 4 Porcine | Film and foam | After 48 h: |
| | | | gelatin | gelatin | solutions are | Uniform film and |
| | | | 4TiO₂ | NHS, EDC | good | foam (2-3 mm). |
| | | | 1 drop PPG | | | Film less |
| | | | NHS, EDC | | | flexible, matt |
| | | | 1 drop | | | |
| | | | Glycerin | | | |
| 274 | 30 | 20 | 4 Porcine | 4 Porcine | Bottom: not | Top is uniform. |
| | | | gelatin | gelatin | uniform | Bottom - not all |
| | | | 3.5 TiO₂ | 4 drops | Foam was | TiO2 has |
| | | | 3 drops PPG | Glycerin | good | dissolved, some |
| | | | 3 drops | | | precipitate on |
| | | | Glycerin | | | the bottom |
| | | | NHS, EDC | | | |
| 241 | 20 | 20 | 4 Porcine | 4 Porcine | Top- foam | Uniform |
| | | | gelatin | gelatin | was blended>, | |
| | | | 3.5 TiO₂ | NHS, EDC | thick | |
| | | | 1 drop PPG | | | |
| | | | 1 drop | | | |
| | | | Glycerin | | | |
| | | | NHS, EDC | | | |
| 179 | 20 | 30 | 4 Porcine | 4 Porcine | Film and foam | After 48 h: |
| | | | gelatin | gelatin | solutions are | Uniform film and |
| | | | 4TiO₂ | NHS, EDC | good | foam (2-3 mm). |
| | | | 1 drop PPG | | | Film less |
| | | | NHS, EDC | | | flexible, matt |
| | | | 1 drop | | | |
| | | | Glycerin | | | |
| 236 | 25 | 20 | 4 Porcine | 4 Porcine | Top- foam | Uniform |
| | | | gelatin | gelatin | was blended | |
| | | | 3.5 TiO₂ | NHS, EDC | less, thin | |
| | | | 1 drop PPG | | | |
| | | | 1 drop | | | |
| | | | Glycerin | | | |
| | | | NHS, EDC | | | |
| 260 | 30 | 20 | 4 Porcine | 4 Porcine | Bottom: not | Top is uniform. |
| | | | gelatin | gelatin | uniform | Bottom - not all |
| | | | 3.5 TiO₂ | 4 drops | Foam was | TiO2 has |
| | | | 3 drops PPG | Glycerin | good | dissolved, some |
| | | | 3 drops | | | precipitate on |
| | | | Glycerin | | | the bottom |
| | | | NHS, EDC | | | |
| 245 | 30 | 20 | 4 Porcine | 4 Porcine | Bottom: not | Top is not very |
| | | | gelatin | gelatin | uniform | uniform (comp |
| | | | 3.5 TiO₂ | | Foam was | 94) |
| | | | 3 drops PPG | | good | Bottom - not all |
| | | | 3 drops | | | TiO2 has |
| | | | Glycerin | | | dissolved, some |
| | | | NHS, EDC | | | precipitate on |
| | | | | | | the bottom |
| 263 | 30 | 20 | 4 Porcine | 4 Porcine | Bottom: not | Top is uniform. |
| | | | gelatin | gelatin | uniform | Bottom - not all |
| | | | 3.5 TiO₂ | 4 drops | Foam was | TiO2 has |
| | | | 3 drops PPG | Glycerin | good | dissolved, some |
| | | | 3 drops | | | precipitate on |
| | | | Glycerin | | | the bottom |
| | | | NHS, EDC | | | |
| 264 | 30 | 20 | 4 Porcine | 4 Porcine | Bottom: not | Top is uniform. |
| | | | gelatin | gelatin | uniform | Bottom - not all |
| | | | 3.5 TiO₂ | 4 drops | Foam was | TiO2 has |
| | | | 3 drops PPG | Glycerin | good | dissolved, some |
| | | | 3 drops | | | precipitate on |
| | | | Glycerin | | | the bottom |
| | | | NHS, EDC | | | |
| 275 | 30 | 20 | 4 Porcine | 4 Porcine | Bottom: not | Top is uniform. |
| | | | gelatin | gelatin | uniform | Bottom - not all |
| | | | 3.5 TiO₂ | 4 drops | Foam was | TiO2 has |
| | | | 3 drops PPG | Glycerin | good | dissolved, some |
| | | | 3 drops | | | precipitate on |
| | | | Glycerin | | | the bottom |
| | | | NHS, EDC | | | |
| 276 | 30 | 20 | 4 Porcine | 4 Porcine | Bottom: not | Top is uniform. |
| | | | gelatin | gelatin | uniform | Bottom - not all |
| | | | 3.5 TiO₂ | 4 drops | Foam was | TiO2 has |
| | | | 3 drops PPG | Glycerin | good | dissolved, some |
| | | | 3 drops | | | precipitate on |
| | | | Glycerin | | | the bottom |
| | | | NHS, EDC | | | |
| 23 | 50 | — | 4 PG | — | Very thin | Very hard film, |
| | | | 4 AlSi | | foam | thin and brittle, |
| | | | 0.05 PPG | | | not a foam |
| | | | EDC (No | | | |
| | | | NHS) | | | |
| 24 | 50 | — | 4 PG | — | Very thin | Very hard film, |
| | | | 4 AlSi | | foam | thin and brittle, |
| | | | 0.05 PPG | | | not a foam |
| | | | EDC (No | | | |
| | | | NHS) | | | |
| 29 | 50 | — | 4 PG | — | Foam very | Very hard film, |
| | | | 4 AlSi | | thin, like a | not possible to |
| | | | 0.05 PPG | | solution | cut |
| | | | EDC (No | | | |
| | | | NHS) | | | |
| 44 | 20 | 30 | 6 PG | 6 PG | Good foam | Very hard thin |
| | | | 6 AlSi | 6 AlSi | and solution | film of top and |
| | | | | NHS, EDC | | no foam |
| 45 | 20 | 30 | 6 PG | 6 PG | Good foam | Very hard thin |
| | | | 6 AlSi | 6 AlSi | and solution | film of top and |
| | | | | NHS, EDC | | no foam |
| 80 | 25 | 25 | PG 4, | PG 2.5, | Uniform white | Hard 0.1 mm |
| | | | NHS 0.04, | AlSi 5, | film. Uniform | film, 3 mm foam |
| | | | EDC 0.2, | SDS 0.015 | Foam | on the top. |
| | | | 30 min wait | | | Bottom film is |
| | | | before top is | | | not flexible |
| | | | spread | | | |
| 81 | 25 | 25 | PG 4, | PG 2.5, | Uniform white | Hard 0.1 mm |
| | | | NHS 0.04, | AlSi 5, | film. Uniform | film, 3 mm foam |
| | | | EDC 0.2, | SDS 0.015 | Foam | on the top. |
| | | | 30 min wait | | | Bottom film is |
| | | | before top is | | | not flexible |
| | | | spread | | | |
| 82 | 25 | 25 | PG 4, | PG 2.5, | Uniform white | Hard 0.1 mm |
| | | | NHS 0.04, | AlSi 5, | film. Uniform | film, 3 mm foam |
| | | | EDC 0.2, | SDS 0.015 | Foam | on the top. |
| | | | 30 min wait | | | Bottom film is |
| | | | before top is | | | not flexible |
| | | | spread | | | |
| 86 | 25 | 25 | PG 4, | PG 2.5, | Uniform white | Hard 0.1 mm |
| | | | NHS 0.04, | AlSi 5, | film. Uniform | film, 3 mm foam |
| | | | EDC 0.2, | SDS 0.015 | Foam | on the top. |
| | | | 30 min wait | | | Bottom film is |
| | | | before top is | | | not flexible |
| | | | spread | | | |
| 87 | 25 | 25 | PG 4, | PG 2.5, | Uniform white | Hard 0.1 mm |
| | | | NHS 0.04, | AlSi 5, | film. Uniform | film, 3 mm foam |
| | | | EDC 0.2, | SDS 0.015 | Foam | on the top. |
| | | | 30 min wait | | | Bottom film is |
| | | | before top is | | | not flexible |
| | | | spread | | | |
| 88 | 25 | 25 | PG 4, | PG 2.5, | Uniform white | Hard 0.1 mm |
| | | | NHS 0.04, | AlSi 5, | film. Uniform | film, 3 mm foam |
| | | | EDC 0.2, | SDS 0.015 | Foam | on the top. |
| | | | 30 min wait | | | Bottom film is |
| | | | before top is | | | not flexible |
| | | | spread | | | |
| 89 | 25 | 25 | PG 4, | PG 2.5, | Uniform white | Hard 0.1 mm |
| | | | NHS 0.04, | AlSi 5, | film. Uniform | film, 3 mm foam |
| | | | EDC 0.2, | SDS 0.015 | Foam | on the top. |
| | | | 30 min wait | | | Bottom film is |
| | | | before top is | | | not flexible |
| | | | spread | | | |
| 95 | 25 | 16 | PG 4, | PG 4, | Uniform white | Not very hard |
| | | | TiO2 4, | TiO2 4, | film. Uniform | 0.1 mm film, 3 |
| | | | NHS 0.04, | SDS 0.015 | foam. | mm foam on the |
| | | | EDC 0.2, | | | top. |
| | | | 30 min wait | | | |
| | | | before top is | | | |
| | | | spread | | | |
| 96 | 25 | 16 | PG 4, | PG 4, | Uniform white | Not very hard |
| | | | TiO2 4, | TiO2 4, | film. Uniform | 0.1 mm film, 3 |
| | | | NHS 0.04, | SDS 0.015 | foam. | mm foam on the |
| | | | EDC 0.2, | | | top. |
| | | | 30 min wait | | | |
| | | | before top is | | | |
| | | | spread | | | |
| 97 | 25 | 16 | PG 4, | PG 4, | Uniform white | Not very hard |
| | | | TiO2 4, | TiO2 4, | film. Uniform | 0.1 mm film, 3 |
| | | | NHS 0.04, | SDS 0.015 | foam. | mm foam on the |
| | | | EDC 0.2, | | | top. |
| | | | 30 min wait | | | |
| | | | before top is | | | |
| | | | spread | | | |
| 120 | 30 | 30 | 4 Porcine | 4 Porcine | Foam is not | Top: foam is ok |
| | | | gelatin | gelatin | very good, | Bottom: film is |
| | | | 4TiO₂ | 0.05 PPG | heavy | flexible, a little |
| | | | 1 dr PPG | NHS, EDC | | bit thick |
| | | | NHS, EDC | | | |
| 121 | 30 | 30 | 4 Porcine | 4 Porcine | Foam is not | Top: foam is ok |
| | | | gelatin | gelatin | very good, | Bottom: film is |
| | | | 4TiO₂ | 0.05 PPG | heavy | flexible, a little |
| | | | 1 dr PPG | NHS, EDC | | bit thick |
| | | | NHS, EDC | | | |
| 122 | 30 | 30 | 4 Porcine | 4 Porcine | Foam is | Top: foam is |
| | | | gelatin | gelatin | better | thin |
| | | | 4TiO₂ | 0.015 PPG | | Bottom: good |
| | | | 1 dr PPG | NHS, EDC | | flexible film |
| | | | NHS, EDC | | | |
| 123 | 30 | 30 | 4 Porcine | 4 Porcine | Foam is | Top: foam is |
| | | | gelatin | gelatin | better | thin |
| | | | 4TiO₂ | 0.015 PPG | | Bottom: good |
| | | | 1 dr PPG | NHS, EDC | | flexible film |
| | | | NHS, EDC | | | |
| 124 | 30 | 30 | 4 Porcine | 4 Porcine | Foam is | Top: foam is |
| | | | gelatin | gelatin | better | thin |
| | | | 4TiO₂ | 0.015 PPG | | Bottom: good |
| | | | 1 dr PPG | NHS, EDC | | flexible film |
| | | | NHS, EDC | | | |
| 125 | 30 | 20 | 4 Porcine | 4 Porcine | Foam is good | Top: quite thin |
| | | | gelatin | gelatin | | Bottom: thin, |
| | | | 4TiO₂ | 1 drop PPG | | flexible |
| | | | 1 dr PPG | NHS, EDC | | |
| | | | NHS, EDC | | | |
| 126 | 30 | 20 | 4 Porcine | 4 Porcine | Foam is good | Top: quite thin |
| | | | gelatin | gelatin | | Bottom: thin, |
| | | | 4TiO₂ | 1 drop PPG | | flexible |
| | | | 1 dr PPG | NHS, EDC | | |
| | | | NHS, EDC | | | |
| 127 | 30 | 20 | 4 Porcine | 4 Porcine | Foam is good | Top: quite thin |
| | | | gelatin | gelatin | | Bottom: thin, |
| | | | 4TiO₂ | 1 drop PPG | | flexible |
| | | | 1 dr PPG | NHS, EDC | | |
| | | | NHS, EDC | | | |
| 130 | 50 | 25 | 4 Porcine | 2.5 Porcine | Foam is not | Not flexible |
| | | | gelatin | gelatin | very thick | bottom film, no |
| | | | | 5AlSil | | good |
| | | | | SDS | | connection |
| | | | | | | between layers |
| 131 | 50 | 25 | 4 Porcine | 2.5 Porcine | Foam is not | Not flexible |
| | | | gelatin | gelatin | very thick | bottom film, no |
| | | | | 5AlSil | | good |
| | | | | SDS | | connection |
| | | | | | | between layers |
| 134 | 50 | 25 | 4 Porcine | 2.5 Porcine | Foam is not | Not flexible |
| | | | gelatin | gelatin | very thick | bottom film. Top |
| | | | | 2.5 AlSil | | foam is not |
| | | | | SDS | | dense, not a |
| | | | | | | strong |
| | | | | | | attachment |
| 140 | 30 | 20 | 4 Porcine | 4 Porcine | Foam not | Top: foam |
| | | | gelatin | gelatin | very thick | 2.5 mm |
| | | | 4TiO₂ | 1 dr PPG | | Bottom: thin, not |
| | | | 1 dr PPG | NHS, EDC | | flexible |
| | | | NHS, EDC | | | |
| 142 | 30 | 20 | 4 Porcine | 4 Porcine | Foam not | Top: foam |
| | | | gelatin | gelatin | very thick | 2.5 mm |
| | | | 4TiO₂ | 1 dr PPG | | Bottom: thin, not |
| | | | 1 dr PPG | NHS, EDC | | flexible |
| | | | NHS, EDC | | | |
| 165 | 50 | 50 | 4 Porcine | 4 Porcine | Good foam | Top: dried, unif |
| | | | gelatin | gelatin | | Bottom: sticky, |
| | | | 1 drop PPG | 4TiO₂ | | flexible |
| | | | NHS, EDC | 1 drop PPG | | |
| | | | | NHS, EDC | | |
| 166 | 50 | 50 | 4 Porcine | 4 Porcine | Good foam | Top: dried, unif |
| | | | gelatin | gelatin | | Bottom: sticky, |
| | | | 1 drop PPG | 4TiO₂ | | flexible |
| | | | NHS, EDC | 1 drop PPG | | |
| | | | | NHS, EDC | | |
| 167 | 50 | 50 | 4 Porcine | 4 Porcine | Good foam | Top: dried, unif |
| | | | gelatin | gelatin | | Bottom: sticky, |
| | | | 1 drop PPG | 4TiO₂ | | flexible |
| | | | NHS, EDC | 1 drop PPG | | |
| | | | | NHS, EDC | | |
| 168 | 30 | 20 | 4 Porcine | 4 Porcine | Film and foam | After 48 h: |
| | | | gelatin | gelatin | solutions are | Uniform film and |
| | | | 4TiO₂ | NHS, EDC | good | foam (1 mm). |
| | | | 1 drop PPG | | | Film flexible, |
| | | | NHS, EDC | | | shiny |
| | | | 1 drop | | | |
| | | | Glycerin | | | |
| 169 | 30 | 20 | 4 Porcine | 4 Porcine | Film and foam | After 48 h: |
| | | | gelatin | gelatin | solutions are | Uniform film and |
| | | | 4TiO₂ | NHS, EDC | good | foam (1 mm). |
| | | | 1 drop PPG | | | Film flexible, |
| | | | NHS, EDC | | | shiny |
| | | | 1 drop | | | |
| | | | Glycerin | | | |
| 170 | 30 | 20 | 4 Porcine | 4 Porcine | Film and foam | After 48 h: |
| | | | gelatin | gelatin | solutions are | Uniform film and |
| | | | 4TiO₂ | NHS, EDC | good | foam (1 mm). |
| | | | 1 drop PPG | | | Film flexible, |
| | | | NHS, EDC | | | shiny |
| | | | 1 drop | | | |
| | | | Glycerin | | | |
| 171 | 30 | 20 | 4 Porcine | 4 Porcine | Film and foam | After 48 h: |
| | | | gelatin | gelatin | solutions are | Uniform film and |
| | | | 4TiO₂ | NHS, EDC | good | foam (1 mm). |
| | | | 1 drop PPG | | | Film flexible, |
| | | | NHS, EDC | | | shiny |
| | | | 1 drop | | | |
| | | | Glycerin | | | |
| 172 | 30 | 20 | 4 Porcine | 4 Porcine | Film and foam | After 48 h: |
| | | | gelatin | gelatin | solutions are | Uniform film and |
| | | | 4TiO₂ | NHS, EDC | good | foam (1 mm). |
| | | | 1 drop PPG | | | Film flexible, |
| | | | NHS, EDC | | | shiny |
| | | | 1 drop | | | |
| | | | Glycerin | | | |
| 173 | 30 | 20 | 4 Porcine | 4 Porcine | Film and foam | After 48 h: |
| | | | gelatin | gelatin | solutions are | Uniform film and |
| | | | 4TiO₂ | NHS, EDC | good | foam (1 mm). |
| | | | 1 drop PPG | | | Film |
| | | | NHS, EDC | | | flexible, shiny |
| | | | 1 drop | | | |
| | | | Glycerin | | | |
| 175 | 30 | 20 | 4 Porcine | 4 Porcine | Film and foam | After 48 h: |
| | | | gelatin | gelatin | solutions are | Uniform film and |
| | | | 4TiO₂ | NHS, EDC | good | foam (1 mm). |
| | | | 1 drop PPG | | | Film |
| | | | NHS, EDC | | | flexible, shiny |
| | | | 1 drop | | | |
| | | | Glycerin | | | |
| 178 | 20 | 30 | 4 Porcine | 4 Porcine | Film and foam | After 48 h: |
| | | | gelatin | gelatin | solutions are | Uniform film and |
| | | | 4TiO₂ | NHS, EDC | good | foam (2-3 mm). |
| | | | 1 drop PPG | | | Film less |
| | | | NHS, EDC | | | flexible, matt |
| | | | 1 drop | | | |
| | | | Glycerin | | | |
| 184 | 20 | 30 | 4 Porcine | 4 Porcine | Film and foam | After 48 h: |
| | | | gelatin | gelatin | solutions are | Uniform film and |
| | | | 4TiO₂ | NHS, EDC | good | foam (2-3 mm). |
| | | | 1 drop PPG | | | Film less |
| | | | NHS, EDC | | | flexible, matt |
| | | | 1 drop | | | |
| | | | Glycerin | | | |
| 185 | 20 | 30 | 4 Porcine | 4 Porcine | Film and foam | After 48 h: |
| | | | gelatin | gelatin | solutions are | Uniform film and |
| | | | 4TiO₂ | NHS, EDC | good | foam (2-3 mm). |
| | | | 1 drop PPG | | | Film less |
| | | | NHS, EDC | | | flexible, matt |
| | | | 1 drop | | | |
| | | | Glycerin | | | |
| 186 | 20 | 30 | 4 Porcine | 4 Porcine | Film and foam | After 48 h: |
| | | | gelatin | gelatin | solutions are | Uniform film and |
| | | | 4TiO₂ | NHS, EDC | good | foam (2-3 mm). |
| | | | 1 drop PPG | | | Film less |
| | | | NHS, EDC | | | flexible, matt |
| | | | 1 drop | | | |
| | | | Glycerin | | | |
| 188 | 30 | 30 | 4 Porcine | 4 Porcine | Film and foam | After 48 h: |
| | | | gelatin | gelatin | solutions are | Not bent, |
| | | | 3.5 TiO₂ | NHS, EDC | good | Foam 0.2 mm. |
| | | | 1 drop PPG | | | Bottom 3 mm, |
| | | | NHS, EDC | | | flexible, shiny |
| | | | 1 drop | | | |
| | | | Glycerin | | | |
| 195 | 30 | 30 | 4 Porcine | 4 Porcine | Film and foam | After 48 h: |
| | | | gelatin | gelatin | solutions are | Not bent, |
| | | | 3.5 TiO₂ | NHS, EDC | good | Foam 0.2 mm. |
| | | | 1 drop PPG | | | Bottom 3 mm, |
| | | | NHS, EDC | | | flexible, shiny |
| | | | 1 drop | | | |
| | | | Glycerin | | | |
| 196 | 30 | 30 | 4 Porcine | 4 Porcine | Film and foam | After 48 h: |
| | | | gelatin | gelatin | solutions are | Not bent, |
| | | | 3.5 TiO₂ | NHS, EDC | good | Foam 0.2 mm. |
| | | | 1 drop PPG | | | Bottom 3 mm, |
| | | | NHS, EDC | | | flexible, shiny |
| | | | 1 drop | | | |
| | | | Glycerin | | | |
| 208 | 30 | 30 | 4 Porcine | 4 Porcine | Film and foam | After 48 h: |
| | | | gelatin | gelatin | solutions are | Not bent, |
| | | | 3.5 TiO₂ | NHS, EDC | good | Foam 0.2 mm. |
| | | | 1 drop PPG | | | Bottom 3 mm, |
| | | | NHS, EDC | | | flexible, shiny |
| | | | 1 drop | | | |
| | | | Glycerin | | | |
| 209 | 30 | 30 | 4 Porcine | 4 Porcine | Film and foam | After 48 h: |
| | | | gelatin | gelatin | solutions are | Not bent, |
| | | | 3.5 TiO₂ | NHS, EDC | good | Foam 0.2 mm. |
| | | | 1 drop PPG | | | Bottom 3 mm, |
| | | | NHS, EDC | | | flexible, shiny |
| | | | 1 drop | | | |
| | | | Glycerin | | | |
| 210 | 30 | 30 | 4 Porcine | 4 Porcine | Film and foam | After 48 h: |
| | | | gelatin | gelatin | solutions are | Not bent, |
| | | | 3.5 TiO₂ | NHS, EDC | good | Foam 0.2 mm. |
| | | | 1 drop PPG | | | Bottom 3 mm, |
| | | | NHS, EDC | | | flexible, shiny |
| | | | 1 drop | | | |
| | | | Glycerin | | | |
| 230 | 20 | 30 | 4 Porcine | 4 Porcine | Bottom - | Samples bent, |
| | | | gelatin | gelatin | solidified in | no foam, just |
| | | | 1 drop PPG | 3.5 TiO₂ | 30 min | film 0.7 mm |
| | | | 1 drop | 1 drop PPG | Top- thin | |
| | | | Glycerin | 1 drop | foam | |
| | | | | Glycerin | w/bubbles | |
| | | | | NHS, EDC | | |
| 248 | 30 | 20 | 4 Porcine | 4 Porcine | Bottom: not | Top is not very |
| | | | gelatin | gelatin | uniform | uniform (comp |
| | | | 3.5 TiO₂ | | Foam was | 94) |
| | | | 3 drops PPG | | good | Bottom - not all |
| | | | 3 drops | | | TiO2 has |
| | | | Glycerin | | | dissolved, some |
| | | | NHS, EDC | | | precipitate on |
| | | | | | | the bottom |
| 249 | 30 | 20 | 4 Porcine | 4 Porcine | Bottom: not | Top is not very |
| | | | gelatin | gelatin | uniform | uniform (comp |
| | | | 3.5 TiO₂ | | Foam was | 94) |
| | | | 3 drops PPG | | good | Bottom - not all |
| | | | 3 drops | | | TiO2 has |
| | | | Glycerin | | | dissolved, some |
| | | | NHS, EDC | | | precipitate on |
| | | | | | | the bottom |
| 251 | 30 | 20 | 4 Porcine | 4 Porcine | Bottom: not | Top is not very |
| | | | gelatin | gelatin | uniform | uniform (comp |
| | | | 3.5 TiO₂ | | Foam was | 94) |
| | | | 3 drops PPG | | good | Bottom - not all |
| | | | 3 drops | | | TiO2 has |
| | | | Glycerin | | | dissolved, some |
| | | | NHS, EDC | | | precipitate on |
| | | | | | | the bottom |
| 253 | 30 | 20 | 4 Porcine | 4 Porcine | Bottom: not | Top is not very |
| | | | gelatin | gelatin | uniform | uniform (comp |
| | | | 3.5 TiO₂ | | Foam was | 94) |
| | | | 3 drops PPG | | good | Bottom - not all |
| | | | 3 drops | | | TiO2 has |
| | | | Glycerin | | | dissolved, some |
| | | | NHS, EDC | | | precipitate on |
| | | | | | | the bottom |
| 254 | 30 | 20 | 4 Porcine | 4 Porcine | Bottom: not | Top is not very |
| | | | gelatin | gelatin | uniform | uniform (comp |
| | | | 3.5 TiO₂ | | Foam was | 94) |
| | | | 3 drops PPG | | good | Bottom - not all |
| | | | 3 drops | | | TiO2 has |
| | | | Glycerin | | | dissolved, some |
| | | | NHS, EDC | | | precipitate on |
| | | | | | | the bottom |
| 255 | 30 | 20 | 4 Porcine | 4 Porcine | Bottom: not | Top is not very |
| | | | gelatin | gelatin | uniform | uniform (comp |
| | | | 3.5 TiO₂ | | Foam was | 94) |
| | | | 3 drops PPG | | good | Bottom - not all |
| | | | 3 drops | | | TiO2 has |
| | | | Glycerin | | | dissolved, some |
| | | | NHS, EDC | | | precipitate on |
| | | | | | | the bottom |
| 265 | 30 | 20 | 4 Porcine | 4 Porcine | Bottom: not | Top is uniform. |
| | | | gelatin | gelatin | uniform | Bottom - not all |
| | | | 3.5 TiO₂ | 4 drops | Foam was | TiO2 has |
| | | | 3 drops PPG | Glycerin | good | dissolved, some |
| | | | 3 drops | | | precipitate on |
| | | | Glycerin | | | the bottom |
| | | | NHS, EDC | | | |
| 266 | 30 | 20 | 4 Porcine | 4 Porcine | Bottom: not | Top is uniform. |
| | | | gelatin | gelatin | uniform | Bottom - not all |
| | | | 3.5 TiO₂ | 4 drops | Foam was | TiO2 has |
| | | | 3 drops PPG | Glycerin | good | dissolved, some |
| | | | 3 drops | | | precipitate on |
| | | | Glycerin | | | the bottom |
| | | | NHS, EDC | | | |
| 268 | 30 | 20 | 4 Porcine | 4 Porcine | Bottom: not | Top is uniform. |
| | | | gelatin | gelatin | uniform | Bottom - not all |
| | | | 3.5 TiO₂ | 4 drops | Foam was | TiO2 has |
| | | | 3 drops PPG | Glycerin | good | dissolved, some |
| | | | 3 drops | | | precipitate on |
| | | | Glycerin | | | the bottom |
| | | | NHS, EDC | | | |
| 269 | 30 | 20 | 4 Porcine | 4 Porcine | Bottom: not | Top is uniform. |
| | | | gelatin | gelatin | uniform | Bottom - not all |
| | | | 3.5 TiO₂ | 4 drops | Foam was | TiO2 has |
| | | | 3 drops PPG | Glycerin | good | dissolved, some |
| | | | 3 drops | | | precipitate on |
| | | | Glycerin | | | the bottom |
| | | | NHS, EDC | | | |
| 270 | 30 | 20 | 4 Porcine | 4 Porcine | Bottom: not | Top is uniform. |
| | | | gelatin | gelatin | uniform | Bottom - not all |
| | | | 3.5 TiO₂ | 4 drops | Foam was | TiO2 has |
| | | | 3 drops PPG | Glycerin | good | dissolved, some |
| | | | 3 drops | | | precipitate on |
| | | | Glycerin | | | the bottom |
| | | | NHS, EDC | | | |
| 271 | 30 | 20 | 4 Porcine | 4 Porcine | Bottom: not | Top is uniform. |
| | | | gelatin | gelatin | uniform | Bottom - not all |
| | | | 3.5 TiO₂ | 4 drops | Foam was | TiO2 has |
| | | | 3 drops PPG | Glycerin | good | dissolved, some |
| | | | 3 drops | | | precipitate on |
| | | | Glycerin | | | the bottom |
| | | | NHS, EDC | | | |
| 272 | 30 | 20 | 4 Porcine | 4 Porcine | Bottom: not | Top is uniform. |
| | | | gelatin | gelatin | uniform | Bottom - not all |
| | | | 3.5 TiO₂ | 4 drops | Foam was | TiO2 has |
| | | | 3 drops PPG | Glycerin | good | dissolved, some |
| | | | 3 drops | | | precipitate on |
| | | | Glycerin | | | the bottom |
| | | | NHS, EDC | | | |
| 273 | 30 | 20 | 4 Porcine | 4 Porcine | Bottom: not | Top is uniform. |
| | | | gelatin | gelatin | uniform | Bottom - not all |
| | | | 3.5 TiO₂ | 4 drops | Foam was | TiO2 has |
| | | | 3 drops PPG | Glycerin | good | dissolved, some |
| | | | 3 drops | | | precipitate on |
| | | | Glycerin | | | the bottom |
| | | | NHS, EDC | | | |
| 295 | 30 | 20 | 4 Porcine | 4 Porcine | Good foam | After 4 days: |
| | | | gelatin | gelatin | for top, | Bottom is matt |
| | | | 3.5 TiO₂ | 5% or2drops | normal | arround 1 cm |
| | | | 5% Glycerin | Glycerin | bottom | around. Mid part |
| | | | (to gelatin) | | | is glossy, |
| | | | NHS, EDC | | | flexible, uniform, |
| | | | | | | no cracks |
| | | | | | | Bottom&Top |
| | | | | | | 1 mm |
| 301 | 30 | 20 | 4 Porcine | 4 Porcine | Top: Good | Top (foam) |
| | | | gelatin | gelatin | foam | uniform, some |
| | | | 3.5 TiO₂ | 1.75 TiO₂ | Bottom: | tiny holes from |
| | | | 1 small drop | 1 big dr | | bubbles |
| | | | Glycerin | Glycerin | | Bottom uniform, |
| | | | NHS, EDC | NHS, EDC | | semi-shiny. |
| | | | | | | A little cracks |
| | | | | | | when cut, quite |
| | | | | | | flexible |
| | | | | | | Bottom 0.1 mm |
| | | | | | | Top 2.5-3.0 mm |
| 303 | 30 | 20 | 4 Porcine | 4 Porcine | Top: Good | Top (foam) |
| | | | gelatin | gelatin | foam | uniform, some |
| | | | 3.5 TiO₂ | 1.75 TiO₂ | Bottom: | tiny holes from |
| | | | 1 small drop | 1 big dr | | bubbles |
| | | | Glycerin | Glycerin | | Bottom uniform, |
| | | | NHS, EDC | NHS, EDC | | semi-shiny. |
| | | | | | | A little cracks |
| | | | | | | when cut, quite |
| | | | | | | flexible |
| | | | | | | Bottom 0.1 mm |
| | | | | | | Top 2.5-3.0 mm |
| 313 | 30 | 20 | 4 Porcine | 4 Porcine | Top: Good | Top (foam) |
| | | | gelatin | gelatin | foam | uniform, some |
| | | | 3.5 TiO₂ | 1.75 TiO₂ | Bottom: | tiny holes from |
| | | | 1 small drop | 1 big dr | | bubbles |
| | | | Glycerin | Glycerin | | Bottom uniform, |
| | | | NHS, EDC | NHS, EDC | | semi-shiny. |
| | | | | | | A little cracks |
| | | | | | | when cut, quite |
| | | | | | | flexible |
| | | | | | | Bottom 0.1 mm |
| | | | | | | Top 2.5-3.0 mm |
| 314 | 30 | 20 | 4 Porcine | 4 Porcine | Top: Good | Top (foam) |
| | | | gelatin | gelatin | foam | uniform, some |
| | | | 3.5 TiO₂ | 1.75 TiO₂ | Bottom: | tiny holes from |
| | | | 1 small drop | 1 big dr | | bubbles |
| | | | Glycerin | Glycerin | | Bottom uniform, |
| | | | NHS, EDC | NHS, EDC | | semi-shiny. |
| | | | | | | A little cracks |
| | | | | | | when cut, quite |
| | | | | | | flexible |
| | | | | | | Bottom 0.1 mm |
| | | | | | | Top 2.5-3.0 mm |
| 315 | 30 | 20 | 4 Porcine | 4 Porcine | Top: Good | Top (foam) |
| | | | gelatin | gelatin | foam | uniform, some |
| | | | 3.5 TiO₂ | 1.75 TiO₂ | Bottom: | tiny holes from |
| | | | 1 small drop | 1 big dr | | bubbles |
| | | | Glycerin | Glycerin | | Bottom uniform, |
| | | | NHS, EDC | NHS, EDC | | semi-shiny. |
| | | | | | | A little cracks |
| | | | | | | when cut, quite |
| | | | | | | flexible |
| | | | | | | Bottom 0.1 mm |
| | | | | | | Top 2.5-3.0 mm |
| 114 | 30 | 20 | 4 Porcine | 4 Porcine | Foam not | Top: quite thin |
| | | | gelatin | gelatin | very thick | Bottom: thin, |
| | | | 4TiO₂ | 1 dr PPG | | flex |
| | | | 1 dr PPG | NHS, EDC | | |
| | | | NHS, EDC | | | |
| 145 | 30 | 20 | 4 Porcine | 4 Porcine | Foam not | Top: foam |
| | | | gelatin | gelatin | very thick | 2.5 mm |
| | | | 4TiO₂ | 1 dr PPG | | Bottom: thin, not |
| | | | 1 dr PPG | NHS, EDC | | flex |
| | | | NHS, EDC | | | |
| 149 | 20 | 30 | 4 Porcine | 4 Porcine | Foam not | Top: foam 3 mm |
| | | | gelatin | gelatin | very thick | Bottom: thin, not |
| | | | 4TiO₂ | 1 dr PPG | | flexible, bubbles |
| | | | 1 dr PPG | NHS, EDC | | |
| | | | NHS, EDC | | | |
| 198 | 30 | 30 | 4 Porcine | 4 Porcine | Film and foam | After 48 h: |
| | | | gelatin | gelatin | solutions are | Not bent, |
| | | | 3.5 TiO₂ | NHS, EDC | good | Foam 0.2 mm. |
| | | | 1 drop PPG | | | Bottom 3 mm, |
| | | | NHS, EDC | | | flexible, shiny |
| | | | 1 drop | | | |
| | | | Glycerin | | | |
| 199 | 30 | 30 | 4 Porcine | 4 Porcine | Film and foam | After 48 h: |
| | | | gelatin | gelatin | solutions are | Not bent, |
| | | | 3.5 TiO₂ | NHS, EDC | good | Foam 0.2 mm. |
| | | | 1 drop PPG | | | Bottom 3 mm, |
| | | | NHS, EDC | | | flexible, shiny |
| | | | 1 drop | | | |
| | | | Glycerin | | | |
| 202 | 30 | 30 | 4 Porcine | 4 Porcine | Film and foam | After 48 h: |
| | | | gelatin | gelatin | solutions are | Not bent, |
| | | | 3.5 TiO₂ | NHS, EDC | good | Foam 0.2 mm. |
| | | | 1 drop PPG | | | Bottom 3 mm, |
| | | | NHS, EDC | | | flexible, shiny |
| | | | 1 drop | | | |
| | | | Glycerin | | | |
| 71 | 25 | 25 | PG 2.5, | PG 2.5, AlSi | Uniform white | Hard 0.1 mm |
| | | | AlSi 5, SDS | 5, SDS | film. | film, 2 mm foam |
| | | | 0.03, NHS | 0.03, NHS | Precipitate | on the top. |
| | | | 0.04 | 0.04 | AlSi. Uniform | Difficult to cut |
| | | | EDC 0.2, | EDC 0.2 | Foam | bottom film, |
| | | | 10 min wait | | | |
| | | | before top is | | | |
| | | | spread | | | |
| 1 | 50 | — | 4 Fish | — | Thick solution | Thin, hard, |
| | | | gelatin(FG) | | | brittle |
| | | | 4 AlSi | | | |
| | | | 0.5 PPG | | | |
| | | | NHS, EDC | | | |
| 2 | 50 | — | 4 Fish | — | Thick solution | Thin, hard, |
| | | | gelatin(FG) | | | brittle |
| | | | 4 AlSi | | | |
| | | | 0.5 PPG | | | |
| | | | NHS, EDC | | | |
| 3 | 50 | — | 2 FG | — | Thick solution | Thin, hard, |
| | | | 4 AlSi | | | brittle |
| | | | 0.2 PPG | | | |
| | | | NHS, EDC | | | |
| 4 | 50 | — | 2 FG | — | Thick solution | Thin, hard, |
| | | | 4 AlSi | | | brittle |
| | | | 0.2 PPG | | | |
| | | | NHS, EDC | | | |
| 5 | 50 | — | 2 FG | — | Thick solution | Thin, hard, |
| | | | 4 AlSi | | | brittle |
| | | | 0.2 PPG | | | |
| | | | NHS, EDC | | | |
| 8 | 50 | — | 4 FG | — | Thick solution | Thin, hard, |
| | | | 4 AlSi | | | brittle |
| | | | 0.2 PPG | | | |
| 9 | 50 | — | 4 FG | — | Thick solution | Thin, hard, |
| | | | 4 AlSi | | | brittle |
| | | | 0.2 PPG | | | |
| 10 | 50 | — | 4 FG | — | Thick solution | Thin, hard, |
| | | | 4 AlSi | | | brittle |
| | | | 0.2 PPG | | | |
| | | | NHS, EDC | | | |
| 11 | 50 | — | 4 FG | — | Thick solution | Thin, hard, |
| | | | 4 AlSi | | | brittle |
| | | | 0.2 PPG | | | |
| | | | NHS, EDC | | | |
| 12 | 50 | — | 2 FG | — | Thick solution | Thin, hard, |
| | | | 8 AlSi | | | brittle |
| | | | 0.5 PPG | | | |
| | | | NHS, EDC | | | |
| 13 | 50 | — | 2 FG | — | Thick solution | Thin, hard, |
| | | | 8 AlSi | | | brittle |
| | | | 0.5 PPG | | | |
| | | | NHS, EDC | | | |
| 14 | 50 | — | 2 FG | — | Thick solution | Thin, hard, |
| | | | 8 AlSi | | | brittle |
| | | | 0.5 PPG | | | |
| | | | NHS, EDC | | | |
| 15 | 50 | — | 2 FG | — | Thick solution | Thin, hard, |
| | | | 8 AlSi | | | brittle |
| | | | 0.5 PPG | | | |
| | | | NHS, EDC | | | |
| 16 | 50 | — | 4 Porcine | — | Medium | Foam, but not |
| | | | gelatin(PG) | | thickness | flexible |
| | | | 4 AlSi | | foam | |
| 17 | 50 | — | 4 Porcine | — | Medium | Foam, but not |
| | | | gelatin(PG) | | thickness | flexible |
| | | | 4 AlSi | | foam | |
| 18 | 50 | — | 4 Porcine | — | Medium | Foam, but not |
| | | | gelatin(PG) | | thickness | flexible |
| | | | 4 AlSi | | foam | |
| 20 | 50 | — | 4 PG | — | Thin foam | Good foam |
| | | | 4 AlSi | | | |
| | | | NHS, EDC | | | |
| 22 | 50 | — | 4 PG | — | Medium | Good foam |
| | | | 4 AlSi | | thickness of | |
| | | | NHS, EDC | | foam | |
| 25 | 50 | — | 4 PG | — | Very thin | Whole sample |
| | | | 4 AlSi | | foam, bubbles | bent |
| | | | 0.05 PPG | | | |
| | | | NHS, EDC | | | |
| 26 | 50 | — | 4 PG | — | Very thin | Whole sample |
| | | | 4 AlSi | | foam, bubbles | bent |
| | | | 0.05 PPG | | | |
| | | | NHS, EDC | | | |
| 27 | 50 | — | 4 PG | — | Foam good, | Whole sample |
| | | | 4 AlSi | | less bubble | bent |
| | | | 1 drop PPG | | than #11 | |
| | | | NHS, EDC | | | |
| 28 | 50 | — | 4 PG | — | Foam good, | Whole sample |
| | | | 4 AlSi | | less bubble | bent |
| | | | 1 drop PPG | | than #11 | |
| | | | NHS, EDC | | | |
| 35 | 50 | — | 6 PG | — | Very good | Very good |
| | | | 6 AlSi | | foam solution | uniform 6 mm |
| | | | NHS, EDC | | | foam. Not very |
| | | | | | | hard |
| 36 | 50 | — | 6 PG | — | Very good | Very good |
| | | | 6 AlSi | | foam solution | uniform 6 mm |
| | | | NHS, EDC | | | foam. Not very |
| | | | | | | hard |
| 37 | 50 | — | 6 PG | — | Good foam | Very puffy foam |
| | | | 6 AlSi | | | |
| 38 | 50 | — | 6 PG | — | Good foam | Very puffy foam |
| | | | 6 AlSi | | | |
| 39 | 10 | 40 | 6 PG | 6 PG | Thick foam, | Very puffy foam |
| | | | 6 AlSi | 6 AlSi | uniform | |
| | | | | NHS, EDC | | |
| 40 | 10 | 40 | 6 PG | 6 PG | Thick foam, | Very puffy foam |
| | | | 6 AlSi | 6 AlSi | uniform | |
| | | | | NHS, EDC | | |
| 41 | 100 | — | 6 PG | — | Good foam, | Top: Hard film |
| | | | 6 AlSi | | medium | 1.5 mm |
| | | | 1 drop PPG | | thickness | Bottom: good |
| | | | | | | foam |
| 42 | 100 | — | 6 PG | — | Good foam, | Top: Hard film |
| | | | 6 AlSi | | medium | 1.5 mm |
| | | | 1 drop PPG | | thickness | Bottom: good |
| | | | | | | foam |
| 46 | 30 | 20 | 6 PG | 6 PG | Good foam | Hard film on top |
| | | | 6 AlSi | 6 AlSi | and solution | and foam on |
| | | | | NHS, EDC | | bottom. Film |
| | | | | | | 0.1 mm; foam |
| | | | | | | 2 mm |
| 47 | 30 | 20 | 6 PG | 6 PG | Good foam | Hard film on top |
| | | | 6 AlSi | 6 AlSi | and solution | and foam on |
| | | | | NHS, EDC | | bottom. Film |
| | | | | | | 0.1 mm; foam |
| | | | | | | 2 mm |
| 49 | 20 | 30 | 6 PG | 6 PG | Good foam | A little bit bent, |
| | | | 6 AlSi | 6 AlSi | and solution | 3 mm, film |
| | | | 1 drop | NHS, EDC | | attached to |
| | | | PPG/50 ml | | | foam |
| 51 | 30 | 20 | 6 PG | 6 PG | Good foam | Two air pockets: |
| | | | 6 AlSi | 6 AlSi | and solution | film separated |
| | | | 1 drop | NHS, EDC | | from foam |
| | | | PPG/50 ml | | | |
| 52 | 50 | 10 | 6 PG | 6 PG | Very good | This is as #16, |
| | | | 6 AlSi | 6 AlSi | foam | plus solution |
| | | | | 1 drop | | without |
| | | | | PPG/50 ml | | crosslinker, +PPG |
| 53 | 50 | 10 | 6 PG | 6 PG | Very good | This is as #16, |
| | | | 6 AlSi | 6 AlSi | foam | plus solution |
| | | | | 1 drop | | without |
| | | | | PPG/50 ml | | crosslinker, +PPG |
| 55 | 15 | — | 6 PG | — | Good solution | Hard dry film, |
| | | | 6 AlSi | | | shrinked a lot |
| | | | NHS, EDC | | | |
| 56 | 35 | — | 6 PG | — | Good solution | Hard dry film, |
| | | | 6 AlSi | | | shrinked |
| | | | NHS, EDC | | | |
| 57 | 35 | — | 6 PG | — | Good solution | Hard dry film, |
| | | | 6 AlSi | | | shrinked |
| | | | NHS, EDC | | | |
| 75 | 25 | 25 | PG 4, | PG 2.5, | Uniform white | Hard 0.1 mm |
| | | | NHS 0.04, | AlSi 5, | film. | film, 2 mm foam |
| | | | EDC 0.2, 15 | SDS 0.015, | Precipitate | on the top. |
| | | | min wait | NHS 0.04 | AlSi. Uniform | Difficult to cut |
| | | | before top is | EDC 0.2 | Foam | bottom film, |
| | | | spread | | | |
| 76 | 25 | 25 | PG 4, | PG 2.5, | Uniform white | Hard 0.1 mm |
| | | | NHS 0.04, | AlSi 5, | film. | film, 2 mm foam |
| | | | EDC 0.2, 30 | SDS 0.015, | Precipitate | on the top. |
| | | | min wait | NHS 0.04 | AlSi. Uniform | Difficult to cut |
| | | | before top is | EDC 0.2 | Foam | bottom film, |
| | | | spread | | | |
| 78 | 25 | 25 | PG 4, | PG 2.5, | Uniform white | Flexible 0.1 mm |
| | | | NHS 0.04, | AlSi 5, | film. Uniform | film, 3 mm foam |
| | | | EDC 0.2, | SDS 0.015, | Foam | on the top. |
| | | | 30 min wait | NHS 0.04 | | |
| | | | before top is | EDC 0.2 | | |
| | | | spread | | | |
| 79 | 25 | 25 | PG 4, | PG 2.5, | Uniform white | More flexible |
| | | | PPG 0.03, | AlSi 5, | film. | 0.1 mm film, 2 |
| | | | NHS 0.04, | SDS 0.015, | Precipitate | mm foam on the |
| | | | EDC 0.2, | NHS 0.04 | AlSi. Uniform | top. |
| | | | 30 min wait | EDC 0.2 | Foam | |
| | | | before top is | | | |
| | | | spread | | | |
| 113 | 30 | 20 | 4 Porcine | 4 Porcine | Foam not | Top: quite thin |
| | | | gelatin | gelatin | very thick | Bottom: thin, |
| | | | 4TiO₂ | 1 dr PPG | | flex |
| | | | 1 dr PPG | NHS, EDC | | |
| | | | NHS, EDC | | | |
| 139 | 30 | 20 | 4 Porcine | 4 Porcine | Foam not | Top: foam |
| | | | gelatin | gelatin | very thick | 2.5 mm |
| | | | 4TiO₂ | 1 dr PPG | | Bottom: thin, not |
| | | | 1 dr PPG | NHS, EDC | | flex |
| | | | NHS, EDC | | | |
| 291 | 30 | 20 | 4 Porcine | 4 Porcine | Good foam | After 4 days: |
| | | | gelatin | gelatin | for top, | Bottom is matt |
| | | | 3.5 TiO₂ | 5% or2drops | normal | arround 1 cm |
| | | | 5% Glycerin | Glycerin | bottom | around. Mid part |
| | | | (to gelatin) | | | is glossy, |
| | | | NHS, EDC | | | flexible, uniform, |
| | | | | | | no cracks |
| | | | | | | Bottom&Top |
| | | | | | | 1 mm |
| 296 | 30 | 20 | 4 Porcine | 4 Porcine | Top: Good | After 4 days: |
| | | | gelatin | gelatin | foam | very uniform |
| | | | 3.5 TiO₂ | 10% or | Bottom: good | sample. Bottom |
| | | | 5% | 4drops | film | stuck to the |
| | | | Glycerin(to | Glycerin (to | | tray, but |
| | | | gelatin) | gelatin) | | detached easy, |
| | | | NHS, EDC | | | uniform, shine. |
| | | | | | | Bottom 0.1- |
| | | | | | | 0.3 mm |
| | | | | | | Top 0.2-2.0 mm |
| 297 | 30 | 20 | 4 Porcine | 4 Porcine | Top: Good | After 4 days: |
| | | | gelatin | gelatin | foam | very uniform |
| | | | 3.5 TiO₂ | 10% or | Bottom: good | sample. Bottom |
| | | | 5% | 4drops | film | stuck to the |
| | | | Glycerin(to | Glycerin (to | | tray, but |
| | | | gelatin) | gelatin) | | detached easy, |
| | | | NHS, EDC | | | uniform, shine. |
| | | | | | | Bottom 0.1- |
| | | | | | | 0.3 mm |
| | | | | | | Top 0.2-2.0 mm |
| 298 | 30 | 20 | 4 Porcine | 4 Porcine | Top: Good | After 4 days: |
| | | | gelatin | gelatin | foam | very uniform |
| | | | 3.5 TiO₂ | 10% or | Bottom: good | sample. Bottom |
| | | | 5% | 4drops | film | stuck to the |
| | | | Glycerin(to | Glycerin (to | | tray, but |
| | | | gelatin) | gelatin) | | detached easy, |
| | | | NHS, EDC | | | uniform, shine. |
| | | | | | | Bottom 0.1- |
| | | | | | | 0.3 mm |
| | | | | | | Top 0.2-2.0 mm |
| 299 | 30 | 20 | 4 Porcine | 4 Porcine | Top: Good | After 4 days: |
| | | | gelatin | gelatin | foam | very uniform |
| | | | 3.5 TiO₂ | 10% or | Bottom: good | sample. Bottom |
| | | | 5% | 4drops | film | stuck to the |
| | | | Glycerin(to | Glycerin (to | | tray, but |
| | | | gelatin) | gelatin) | | detached easy, |
| | | | NHS, EDC | | | uniform, shine. |
| | | | | | | Bottom 0.1- |
| | | | | | | 0.3 mm |
| | | | | | | Top 0.2-2.0 mm |
| 151 | 30 | 20 | 4 Porcine | 4 Porcine | Foam not | Top: thin foam |
| | | | gelatin | gelatin | very thick | Bottom: not |
| | | | 4 AlSil | 1 dr PPG | | flexible, |
| | | | 1 dr PPG | NHS, EDC | | Good |
| | | | NHS, EDC | | | attachment |
| | | | | | | between layers |
| 152 | 30 | 20 | 4 Porcine | 4 Porcine | Foam not | Top: thin foam |
| | | | gelatin | gelatin | very thick | Bottom: not |
| | | | 4 AlSil | 1 dr PPG | | flexible, |
| | | | 1 dr PPG | NHS, EDC | | Good |
| | | | NHS, EDC | | | attachment |
| | | | | | | between layers |
| 153 | 30 | 20 | 4 Porcine | 4 Porcine | Foam not | Top: thin foam |
| | | | gelatin | gelatin | very thick | Bottom: not |
| | | | 4 AlSil | 1 dr PPG | | flexible, |
| | | | 1 dr PPG | NHS, EDC | | Good |
| | | | NHS, EDC | | | attachment |
| | | | | | | between layers |
| 154 | 30 | 20 | 4 Porcine | 4 Porcine | Foam not | Top: thin foam |
| | | | gelatin | gelatin | very thick | Bottom: not |
| | | | 4 AlSil | 1 dr PPG | | flexible, |
| | | | 1 dr PPG | NHS, EDC | | Good |
| | | | NHS, EDC | | | attachment |
| | | | | | | between layers |
| 155 | 30 | 20 | 4 Porcine | 4 Porcine | Foam not | Top: thin foam |
| | | | gelatin | gelatin | very thick | Bottom: not |
| | | | 4 AlSil | 1 dr PPG | | flexible, |
| | | | 1 dr PPG | NHS, EDC | | Good |
| | | | NHS, EDC | | | attachment |
| | | | | | | between layers |
| 159 | 20 | 30 | 4 Porcine | 4 Porcine | Foam not | Top: thin foam |
| | | | gelatin | gelatin | very thick | Bottom: not |
| | | | 4 AlSil | 1 drop PPG | | flexible, |
| | | | 1 drop PPG | NHS, EDC | | Good |
| | | | NHS, EDC | | | attachment |
| | | | | | | between layers. |
| | | | | | | Compare to |
| | | | | | | #80, this sample |
| | | | | | | has thinner film |
| | | | | | | and thicker |
| | | | | | | foam |
| 160 | 20 | 30 | 4 Porcine | 4 Porcine | Foam not | Top: thin foam |
| | | | gelatin | gelatin | very thick | Bottom: not |
| | | | 4 AlSil | 1 drop PPG | | flexible, |
| | | | 1 drop PPG | NHS, EDC | | Good |
| | | | NHS, EDC | | | attachment |
| | | | | | | between layers. |
| | | | | | | Compare to |
| | | | | | | #80, this sample |
| | | | | | | has thinner film |
| | | | | | | and thicker |
| | | | | | | foam |
| 213 | 20 | 20 | 4 Porcine | 4 Porcine | | Top: Not |
| | | | gelatin | gelatin | | uniform 1-3 mm, |
| | | | 3.5 TiO₂ | NHS, EDC | | thick |
| | | | 1 drop PPG | | | |
| | | | 1 drop | | | |
| | | | Glycerin | | | |
| | | | NHS, EDC | | | |
| 214 | 20 | 20 | 4 Porcine | 4 Porcine | | Top: Not |
| | | | gelatin | gelatin | | uniform 1-3 mm, |
| | | | 3.5 TiO₂ | NHS, EDC | | thick |
| | | | 1 drop PPG | | | |
| | | | 1 drop | | | |
| | | | Glycerin | | | |
| | | | NHS, EDC | | | |
| 218 | 20 | 20 | 4 Porcine | 4 Porcine | | Top: Not |
| | | | gelatin | gelatin | | uniform 1-3 mm, |
| | | | 3.5 TiO₂ | NHS, EDC | | thick |
| | | | 1 drop PPG | | | |
| | | | 1 drop | | | |
| | | | Glycerin | | | |
| | | | NHS, EDC | | | |
| 219 | 20 | 20 | 4 Porcine | 4 Porcine | | Top: Not |
| | | | gelatin | gelatin | | uniform 1-3 mm, |
| | | | 3.5 TiO₂ | NHS, EDC | | thick |
| | | | 1 drop PPG | | | |
| | | | 1 drop | | | |
| | | | Glycerin | | | |
| | | | NHS, EDC | | | |
| 220 | 20 | 20 | 4 Porcine | 4 Porcine | | Top: Not |
| | | | gelatin | gelatin | | uniform 1-3 mm, |
| | | | 3.5 TiO₂ | NHS, EDC | | thick |
| | | | 1 drop PPG | | | |
| | | | 1 drop | | | |
| | | | Glycerin | | | |
| | | | NHS, EDC | | | |
| 221 | 25 | 20 | 4 Porcine | 4 Porcine | Good foam | Top: Not |
| | | | gelatin | gelatin | | uniform 1-3 mm, |
| | | | 3.5 TiO₂ | NHS, EDC | | thick |
| | | | 1 drop PPG | | | |
| | | | 1 drop | | | |
| | | | Glycerin | | | |
| | | | NHS, EDC | | | |
| 222 | 25 | 20 | 4 Porcine | 4 Porcine | Good foam | Top: Not |
| | | | gelatin | gelatin | | uniform 1-3 mm, |
| | | | 3.5 TiO₂ | NHS, EDC | | thick |
| | | | 1 drop PPG | | | |
| | | | 1 drop | | | |
| | | | Glycerin | | | |
| | | | NHS, EDC | | | |
| 223 | 25 | 20 | 4 Porcine | 4 Porcine | Good foam | Top: Not |
| | | | gelatin | gelatin | | uniform 1-3 mm, |
| | | | 3.5 TiO₂ | NHS, EDC | | thick |
| | | | 1 drop PPG | | | |
| | | | 1 drop | | | |
| | | | Glycerin | | | |
| | | | NHS, EDC | | | |
| 224 | 25 | 20 | 4 Porcine | 4 Porcine | Good foam | Top: Not |
| | | | gelatin | gelatin | | uniform 1-3 mm, |
| | | | 3.5 TiO₂ | NHS, EDC | | thick |
| | | | 1 drop PPG | | | |
| | | | 1 drop | | | |
| | | | Glycerin | | | |
| | | | NHS, EDC | | | |
| 225 | 25 | 20 | 4 Porcine | 4 Porcine | Good foam | Top: Not |
| | | | gelatin | gelatin | | uniform 1-3 mm, |
| | | | 3.5 TiO₂ | NHS, EDC | | thick |
| | | | 1 drop PPG | | | |
| | | | 1 drop | | | |
| | | | Glycerin | | | |
| | | | NHS, EDC | | | |
| 226 | 25 | 20 | 4 Porcine | 4 Porcine | Good foam | Top: Not |
| | | | gelatin | gelatin | | uniform 1-3 mm, |
| | | | 3.5 TiO₂ | NHS, EDC | | thick |
| | | | 1 drop PPG | | | |
| | | | 1 drop | | | |
| | | | Glycerin | | | |
| | | | NHS, EDC | | | |
| 63 | n/a | 25 | n/a | 3 PG | Uniform Foam | Soft uniform |
| | | | | 3 AlSi | | foam |
| | | | | NHS 0.04, | | |
| | | | | EDC 0.2 | | |
| 64 | n/a | 25 | n/a | PG 3, | Uniform Foam | Soft uniform |
| | | | | AlSi 3, | | foam |
| | | | | SDS 0.03, | | |
| | | | | NHS 0.04 | | |
| | | | | EDC 0.2 | | |
| 65 | n/a | 25 | n/a | PG 3, | Uniform Foam | Soft uniform |
| | | | | AlSi 4 | | foam |
| | | | | NHS 0.04 | | |
| | | | | EDC 0.2 | | |
| 66 | n/a | 25 | n/a | PG 3, | Uniform Foam | Soft uniform |
| | | | | AlSi 4, | | foam |
| | | | | SDS 0.03, | | |
| | | | | NHS 0.04; | | |
| | | | | EDC 0.2 | | |
| 67 | n/a | 25 | n/a | PG 2.5, AlSi | Uniform Foam | Soft uniform |
| | | | | 5, NHS 0.04; | | foam |
| | | | | EDC 0.2 | | |
| 68 | No | 25 | | PG 2.5, AlSi | Uniform Foam | Soft uniform |
| | | | | 5, SDS | | foam. |
| | | | | 0.03, NHS | | More uniform |
| | | | | 0.04 | | than #36. |
| | | | | EDC 0.2 | | |
| 101 | 16 | 25 | PG 4, | PG 4, | Uniform clear | Hard 0.1 mm |
| | | | PPG 0.015, | TiO2 4 | film. Uniform | clear film, thick |
| | | | 10 min wait | SDS 0.015 | foam. | 5 mm foam on |
| | | | before top is | | | the top. |
| | | | spread | | | |
| 105 | 16 | 16 | PG 4, | PG 4, | Uniform clear | Top: 3 mm foam |
| | | | PPG 0.015, | TiO2 4 | film. Uniform | Bottom: Hard |
| | | | 10 min wait | SDS 0.015 | foam. | 0.1 mm clear |
| | | | before top is | | | film |
| | | | spread | | | |
| 106 | 35 | 25 | PG 4, | PG 4, | Uniform white | A little bit hard |
| | | | TiO2 4, | TiO2 4, | film, Uniform | 0.1 mm film, 2 |
| | | | PPG 0.015, | SDS 0.015 | foam. | mm foam on the |
| | | | NHS 0.04, | | | top. |
| | | | EDC 0.2, 20 | | | |
| | | | min wait | | | |
| | | | before top is | | | |
| | | | spread | | | |
| 107 | 50 | 50 | 4 Porcine | 4 Porcine | Foam is not | Top: foam is |
| | | | gelatin | gelatin | very thick | very thick |
| | | | 4TiO₂ | 1 dr PPG | | Bottom: film is |
| | | | 1 drop PPG | NHS, EDC | | thick and not |
| | | | NHS, EDC | | | very flex |
| 108 | 50 | 50 | 4 Porcine | 4 Porcine | Foam is not | Top: foam is |
| | | | gelatin | gelatin | very thick | very thick |
| | | | 4TiO₂ | 1 dr PPG | | Bottom: film is |
| | | | 1 drop PPG | NHS, EDC | | thick and not |
| | | | NHS, EDC | | | very flex |
| 109 | 50 | 25 | 4 Porcine | 4 Porcine | Foam not | Top: foam is |
| | | | gelatin | gelatin | very thick | quite thin |
| | | | 4TiO₂ | 1 dr PPG | | Bottom: film is |
| | | | 1 drop PPG | | | thick and not |
| | | | NHS, EDC | | | very flex |
| 146 | 20 | 30 | 4 Porcine | 4 Porcine | Foam not | Top: foam 3 mm |
| | | | gelatin | gelatin | very thick | Bottom: thin, not |
| | | | 4TiO₂ | 1 dr PPG | | flexible, bubbles |
| | | | 1 dr PPG | NHS, EDC | | |
| | | | NHS, EDC | | | |
| 147 | 20 | 30 | 4 Porcine | 4 Porcine | Foam not | Top: foam 3 mm |
| | | | gelatin | gelatin | very thick | Bottom: thin, not |
| | | | 4TiO₂ | 1 dr PPG | | flexible, bubbles |
| | | | 1 dr PPG | NHS, EDC | | |
| | | | NHS, EDC | | | |
| 148 | 20 | 30 | 4 Porcine | 4 Porcine | Foam not | Top: foam 3 mm |
| | | | gelatin | gelatin | very thick | Bottom: thin, not |
| | | | 4TiO₂ | 1 dr PPG | | flexible, bubbles |
| | | | 1 dr PPG | NHS, EDC | | |
| | | | NHS, EDC | | | |
| 174 | 30 | 20 | 4 Porcine | 4 Porcine | Film and foam | After 48 h: |
| | | | gelatin | gelatin | solutions are | Uniform film and |
| | | | 4TiO₂ | NHS, EDC | good | foam (1 mm). |
| | | | 1 drop PPG | | | Film |
| | | | NHS, EDC | | | flexible, shiny |
| | | | 1 drop | | | |
| | | | Glycerin | | | |
| 182 | 20 | 30 | 4 Porcine | 4 Porcine | Film and foam | After 48 h: |
| | | | gelatin | gelatin | solutions are | Uniform film and |
| | | | 4TiO₂ | NHS, EDC | good | foam (2-3 mm). |
| | | | 1 drop PPG | | | Film less |
| | | | NHS, EDC | | | flexible, matt |
| | | | 1 drop | | | |
| | | | Glycerin | | | |
| 183 | 20 | 30 | 4 Porcine | 4 Porcine | Film and foam | After 48 h: |
| | | | gelatin | gelatin | solutions are | Uniform film and |
| | | | 4TiO₂ | NHS, EDC | good | foam (2-3 mm). |
| | | | 1 drop PPG | | | Film less |
| | | | NHS, EDC | | | flexible, matt |
| | | | 1 drop | | | |
| | | | Glycerin | | | |
| 189 | 30 | 30 | 4 Porcine | 4 Porcine | Film and foam | After 48 h: |
| | | | gelatin | gelatin | solutions are | Not bent, |
| | | | 3.5 TiO₂ | NHS, EDC | good | Foam 0.2 mm. |
| | | | 1 drop PPG | | | Bottom 3 mm, |
| | | | NHS, EDC | | | flexible, shiny |
| | | | 1 drop | | | |
| | | | Glycerin | | | |
| 190 | 30 | 30 | 4 Porcine | 4 Porcine | Film and foam | After 48 h: |
| | | | gelatin | gelatin | solutions are | Not bent, |
| | | | 3.5 TiO₂ | NHS, EDC | good | Foam 0.2 mm. |
| | | | 1 drop PPG | | | Bottom 3 mm, |
| | | | NHS, EDC | | | flexible, shiny |
| | | | 1 drop | | | |
| | | | Glycerin | | | |
| 191 | 30 | 30 | 4 Porcine | 4 Porcine | Film and foam | After 48 h: |
| | | | gelatin | gelatin | solutions are | Not bent, |
| | | | 3.5 TiO₂ | NHS, EDC | good | Foam 0.2 mm. |
| | | | 1 drop PPG | | | Bottom 3 mm, |
| | | | NHS, EDC | | | flexible, shiny |
| | | | 1 drop | | | |
| | | | Glycerin | | | |
| 192 | 30 | 30 | 4 Porcine | 4 Porcine | Film and foam | After 48 h: |
| | | | gelatin | gelatin | solutions are | Not bent, |
| | | | 3.5 TiO₂ | NHS, EDC | good | Foam 0.2 mm. |
| | | | 1 drop PPG | | | Bottom 3 mm, |
| | | | NHS, EDC | | | flexible, shiny |
| | | | 1 drop | | | |
| | | | Glycerin | | | |
| 193 | 30 | 30 | 4 Porcine | 4 Porcine | Film and foam | After 48 h: |
| | | | gelatin | gelatin | solutions are | Not bent, |
| | | | 3.5 TiO₂ | NHS, EDC | good | Foam 0.2 mm. |
| | | | 1 drop PPG | | | Bottom 3 mm, |
| | | | NHS, EDC | | | flexible, shiny |
| | | | 1 drop | | | |
| | | | Glycerin | | | |
| 194 | 30 | 30 | 4 Porcine | 4 Porcine | Film and foam | After 48 h: |
| | | | gelatin | gelatin | solutions are | Not bent, |
| | | | 3.5 TiO₂ | NHS, EDC | good | Foam 0.2 mm. |
| | | | 1 drop PPG | | | Bottom 3 mm, |
| | | | NHS, EDC | | | flexible, shiny |
| | | | 1 drop | | | |
| | | | Glycerin | | | |
| 203 | 30 | 30 | 4 Porcine | 4 Porcine | Film and foam | After 48 h: |
| | | | gelatin | gelatin | solutions are | Not bent, |
| | | | 3.5 TiO₂ | NHS, EDC | good | Foam 0.2 mm. |
| | | | 1 drop PPG | | | Bottom 3 mm, |
| | | | NHS, EDC | | | flexible, shiny |
| | | | 1 drop | | | |
| | | | Glycerin | | | |
| 204 | 30 | 30 | 4 Porcine | 4 Porcine | Film and foam | After 48 h: |
| | | | gelatin | gelatin | solutions are | Not bent, |
| | | | 3.5 TiO₂ | NHS, EDC | good | Foam 0.2 mm. |
| | | | 1 drop PPG | | | Bottom 3 mm, |
| | | | NHS, EDC | | | flexible, shiny |
| | | | 1 drop | | | |
| | | | Glycerin | | | |
| 206 | 30 | 30 | 4 Porcine | 4 Porcine | Film and foam | After 48 h: |
| | | | gelatin | gelatin | solutions are | Not bent, |
| | | | 3.5 TiO₂ | NHS, EDC | good | Foam 0.2 mm. |
| | | | 1 drop PPG | | | Bottom 3 mm, |
| | | | NHS, EDC | | | flexible, shiny |
| | | | 1 drop | | | |
| | | | Glycerin | | | |
| 163 | 20 | 30 | 4 Porcine | 4 Porcine | Foam not | Top: thin foam |
| | | | gelatin | gelatin | very thick | Bottom: not |
| | | | 4 AlSil | 1 drop PPG | | flexible, |
| | | | 1 drop PPG | NHS, EDC | | Good |
| | | | NHS, EDC | | | attachment |
| | | | | | | between layers. |
| | | | | | | Compare to |
| | | | | | | #80, this sample |
| | | | | | | has thinner film |
| | | | | | | and thicker |
| | | | | | | foam |
| 320 | 20 | 30 | 4 Porcine | 4 Porcine | Good foam | Top (foam) |
| | | | gelatin | gelatin | | uniform, some |
| | | | 3.5 TiO₂ | 1.75 TiO₂ | | tiny holes from |
| | | | 1 small drop | 1 big dr | | bubbles |
| | | | Glycerine | Glycerine | | Bottom uniform, |
| | | | NHS, EDC | NHS, EDC | | semi-shiny. |
| | | | | | | A little cracks |
| | | | | | | when cut, quite |
| | | | | | | flexible |
| | | | | | | Bottom 0.1 mm |
| | | | | | | Top 2.5-3.0 mm |
| 321 | 20 | 30 | 4 Porcine | 4 Porcine | Good foam | Top (foam) |
| | | | gelatin | gelatin | | uniform, some |
| | | | 3.5 TiO₂ | 1.75 TiO₂ | | tiny holes from |
| | | | 1 small drop | 1 big dr | | bubbles |
| | | | Glycerine | Glycerine | | Bottom uniform, |
| | | | NHS, EDC | NHS, EDC | | semi-shiny. |
| | | | | | | A little cracks |
| | | | | | | when cut, quite |
| | | | | | | flexible |
| | | | | | | Bottom 0.1 mm |
| | | | | | | Top 2.5-3.0 mm |
| 322 | 20 | 30 | 4 Porcine | 4 Porcine | Good foam | Top (foam) |
| | | | gelatin | gelatin | | uniform, some |
| | | | 3.5 TiO₂ | 1.75 TiO₂ | | tiny holes from |
| | | | 1 small drop | 1 big dr | | bubbles |
| | | | Glycerine | Glycerine | | Bottom uniform, |
| | | | NHS, EDC | NHS, EDC | | semi-shiny. |
| | | | | | | A little cracks |
| | | | | | | when cut, quite |
| | | | | | | flexible |
| | | | | | | Bottom 0.1 mm |
| | | | | | | Top 2.5-3.0 mm |
| 72 | 25 | 25 | PG 6, | PG 2.5, NHS | Solution | Sample is bent |
| | | | AlSi 6, | 0.04 | penetrate in | after drying |
| | | | NHS 0.04, | EDC 0.2 | foam | |
| | | | EDC 0.2, | film | | |
| | | | foam from | | | |
| | | | #16 | | | |
| 73 | 25 | 25 | FG 4, | FG 4, | Uniform white | Very good puffy |
| | | | NHS 0.04, | A330 1, | film. Uniform | foam |
| | | | EDC 0.2. | NHS 0.04, | foam. | |
| | | | | EDC 0.2. | | |
| 74 | 25 | 25 | FG 4, | FG 4, | Uniform white | Very good puffy |
| | | | NHS 0.04, | A330 1, | film. Uniform | foam |
| | | | EDC 0.2. | SDS 0.015, | foam. | |
| | | | | NHS 0.04, | | |
| | | | | EDC 0.2. | | |
| 77 | 25 | 25 | PG 4, | PG 4, | Uniform white | Bottom film |
| | | | NHS 0.04, | A330 1, | film. Uniform | layer separated |
| | | | EDC 0.2. | SDS 0.015, | foam. | from top foam. |
| | | | | NHS 0.04 | | |
| | | | | EDC 0.2 | | |
| 115 | 20 | 30 | 4 Porcine | 4 Porcine | Foam not | Top: quite thin |
| | | | gelatin | gelatin | very thick | Bottom: thin, |
| | | | 4TiO₂ | 1 dr PPG | | flex |
| | | | 1 dr PPG | NHS, EDC | | |
| | | | NHS, EDC | | | |
| 129 | 40 | 40 | 4 Porcine | 2.5 Porcine | Foam is not | Top foam is |
| | | | gelatin | gelatin | very thick | very fluffy, not |
| | | | | 5AISil | | dense, Bottom |
| | | | | SDS | | film too rigid |
| 233 | 25 | 20 | 4 Porcine | 4 Porcine | Top- foam | Uniform |
| | | | gelatin | gelatin | was blended | |
| | | | 3.5 TiO₂ | NHS, EDC | less, thin | |
| | | | 1 drop PPG | | | |
| | | | 1 drop | | | |
| | | | Glycerin | | | |
| | | | NHS, EDC | | | |
| 234 | 25 | 20 | 4 Porcine | 4 Porcine | Top- foam | Uniform |
| | | | gelatin | gelatin | was blended | |
| | | | 3.5 TiO₂ | NHS, EDC | less, thin | |
| | | | 1 drop PPG | | | |
| | | | 1 drop | | | |
| | | | Glycerin | | | |
| | | | NHS, EDC | | | |
| 237 | 25 | 20 | 4 Porcine | 4 Porcine | Top- foam | Uniform |
| | | | gelatin | gelatin | was blended | |
| | | | 3.5 TiO₂ | NHS, EDC | less, thin | |
| | | | 1 drop PPG | | | |
| | | | 1 drop | | | |
| | | | Glycerin | | | |
| | | | NHS, EDC | | | |
| 238 | 20 | 20 | 4 Porcine | 4 Porcine | Top- foam | Uniform |
| | | | gelatin | gelatin | was blended>, | |
| | | | 3.5 TiO₂ | NHS, EDC | thick | |
| | | | 1 drop PPG | | | |
| | | | 1 drop | | | |
| | | | Glycerin | | | |
| | | | NHS, EDC | | | |
| 239 | 20 | 20 | 4 Porcine | 4 Porcine | Top- foam | Uniform |
| | | | gelatin | gelatin | was blended>, | |
| | | | 3.5 TiO₂ | NHS, EDC | thick | |
| | | | 1 drop PPG | | | |
| | | | 1 drop | | | |
| | | | Glycerin | | | |
| | | | NHS, EDC | | | |
| 240 | 20 | 20 | 4 Porcine | 4 Porcine | Top- foam | Uniform |
| | | | gelatin | gelatin | was blended>, | |
| | | | 3.5 TiO₂ | NHS, EDC | thick | |
| | | | 1 drop PPG | | | |
| | | | 1 drop | | | |
| | | | Glycerin | | | |
| | | | NHS, EDC | | | |
| 242 | 20 | 20 | 4 Porcine | 4 Porcine | Top- foam | Uniform |
| | | | gelatin | gelatin | was blended>, | |
| | | | 3.5 TiO₂ | NHS, EDC | thick | |
| | | | 1 drop PPG | | | |
| | | | 1 drop | | | |
| | | | Glycerin | | | |
| | | | NHS, EDC | | | |
| 243 | 20 | 20 | 4 Porcine | 4 Porcine | Top- foam | Uniform |
| | | | gelatin | gelatin | was blended>, | |
| | | | 3.5 TiO₂ | NHS, EDC | thick | |
| | | | 1 drop PPG | | | |
| | | | 1 drop | | | |
| | | | Glycerin | | | |
| | | | NHS, EDC | | | |
| 279 | 30 | 20 | 4 Porcine | 4 Porcine | Bottom: not | Top is uniform. |
| | | | gelatin | gelatin | uniform | Bottom - not all |
| | | | 3.5 TiO₂ | 4 drops | Foam was | TiO2 has |
| | | | 3 drops PPG | Glycerin | good | dissolved, some |
| | | | 3 drops | | | precipitate on |
| | | | Glycerin | | | the bottom |
| | | | NHS, EDC | | | |
| 280 | 30 | 20 | 4 Porcine | 4 Porcine | Bottom: not | Top is uniform. |
| | | | gelatin | gelatin | uniform | Bottom - not all |
| | | | 3.5 TiO₂ | 4 drops | Foam was | TiO2 has |
| | | | 3 drops PPG | Glycerin | good | dissolved, some |
| | | | 3 drops | | | precipitate on |
| | | | Glycerin | | | the bottom |
| | | | NHS, EDC | | | |
| 281 | 30 | 20 | 4 Porcine | 4 Porcine | Bottom: not | Top is uniform. |
| | | | gelatin | gelatin | uniform | Bottom - not all |
| | | | 3.5 TiO₂ | 4 drops | Foam was | TiO2 has |
| | | | 3 drops PPG | Glycerin | good | dissolved, some |
| | | | 3 drops | | | precipitate on |
| | | | Glycerin | | | the bottom |
| | | | NHS, EDC | | | |
| 283 | 30 | 20 | 4 Porcine | 4 Porcine | Bottom: not | Top is uniform. |
| | | | gelatin | gelatin | uniform | Bottom - not all |
| | | | 3.5 TiO₂ | 4 drops | Foam was | TiO2 has |
| | | | 3 drops PPG | Glycerin | good | dissolved, some |
| | | | 3 drops | | | precipitate on |
| | | | Glycerin | | | the bottom |
| | | | NHS, EDC | | | |
| 287 | 30 | 20 | 4 Porcine | 4 Porcine | Bottom: not | Top is uniform. |
| | | | gelatin | gelatin | uniform | Bottom - not all |
| | | | 3.5 TiO₂ | 4 drops | Foam was | TiO2 has |
| | | | 3 drops PPG | Glycerin | good | dissolved, some |
| | | | 3 drops | | | precipitate on |
| | | | Glycerin | | | the bottom |
| | | | NHS, EDC | | | |
| 309 | 30 | 20 | 4 Porcine | 4 Porcine | Top: Good | Top (foam) |
| | | | gelatin | gelatin | foam | uniform, some |
| | | | 3.5 TiO₂ | 1.75 TiO₂ | Bottom: | tiny holes from |
| | | | 1 small drop | 1 big dr | | bubbles |
| | | | Glycerin | Glycerin | | Bottom uniform, |
| | | | NHS, EDC | NHS, EDC | | semi-shiny. |
| | | | | | | A little cracks |
| | | | | | | when cut, quite |
| | | | | | | flexible |
| | | | | | | Bottom 0.1 mm |
| | | | | | | Top 2.5-3.0 mm |
| 310 | 30 | 20 | 4 Porcine | 4 Porcine | Top: Good | Top (foam) |
| | | | gelatin | gelatin | foam | uniform, some |
| | | | 3.5 TiO₂ | 1.75 TiO₂ | Bottom: | tiny holes from |
| | | | 1 small drop | 1 big dr | | bubbles |
| | | | Glycerin | Glycerin | | Bottom uniform, |
| | | | NHS, EDC | NHS, EDC | | semi-shiny. |
| | | | | | | A little cracks |
| | | | | | | when cut, quite |
| | | | | | | flexible |
| | | | | | | Bottom 0.1 mm |
| | | | | | | Top 2.5-3.0 mm |
| 311 | 30 | 20 | 4 Porcine | 4 Porcine | Top: Good | Top (foam) |
| | | | gelatin | gelatin | foam | uniform, some |
| | | | 3.5 TiO₂ | 1.75 TiO₂ | Bottom: | tiny holes from |
| | | | 1 small drop | 1 big dr | | bubbles |
| | | | Glycerin | Glycerin | | Bottom uniform, |
| | | | NHS, EDC | NHS, EDC | | semi-shiny. |
| | | | | | | A little cracks |
| | | | | | | when cut, quite |
| | | | | | | flexible |
| | | | | | | Bottom 0.1 mm |
| | | | | | | Top 2.5-3.0 mm |
| 259 | 30 | 20 | 4 Porcine | 4 Porcine | Bottom: not | Top is uniform. |
| | | | gelatin | gelatin | uniform | Bottom - not all |
| | | | 3.5 TiO₂ | 4 drops | Foam was | TiO2 has |
| | | | 3 drops PPG | Glycerin | good | dissolved, some |
| | | | 3 drops | | | precipitate on |
| | | | Glycerin | | | the bottom |
| | | | NHS, EDC | | | |
| 162 | 20 | 30 | 4 Porcine | 4 Porcine | Foam not | Top: thin foam |
| | | | gelatin | gelatin | very thick | Bottom: not |
| | | | 4 AlSil | 1 drop PPG | | flexible, |
| | | | 1 drop PPG | NHS, EDC | | Good |
| | | | NHS, EDC | | | attachment |
| | | | | | | between layers. |
| | | | | | | Compare to |
| | | | | | | #80, this sample |
| | | | | | | has thinner film |
| | | | | | | and thicker |
| | | | | | | foam |
| 138 | 20 | 30 | 4 Porcine | 4 Porcine | Foam not | Top: quite thin |
| | | | gelatin | gelatin | very thick | Bottom: thin, |
| | | | 4TiO₂ | 1 dr PPG | | flex |
| | | | 1 dr PPG | NHS, EDC | | |
| | | | NHS, EDC | | | |
| 244 | 30 | 20 | 4 Porcine | 4 Porcine | Bottom: not | Top is not very |
| | | | gelatin | gelatin | uniform | uniform (comp |
| | | | 3.5 TiO₂ | | Foam was | 94) |
| | | | 3 drops PPG | | good | Bottom - not all |
| | | | 3 drops | | | TiO2 has |
| | | | Glycerin | | | dissolved, some |
| | | | NHS, EDC | | | precipitate on |
| | | | | | | the bottom |
| 306 | 30 | 20 | 4 Porcine | 4 Porcine | Top: Good | Top (foam) |
| | | | gelatin | gelatin | foam | uniform, some |
| | | | 3.5 TiO₂ | 1.75 TiO₂ | Bottom: | tiny holes from |
| | | | 1 small drop | 1 big dr | | bubbles |
| | | | Glycerin | Glycerin | | Bottom uniform, |
| | | | NHS, EDC | NHS, EDC | | semi-shiny. |
| | | | | | | A little cracks |
| | | | | | | when cut, quite |
| | | | | | | flexible |
| | | | | | | Bottom 0.1 mm |
| | | | | | | Top 2.5-3.0 mm |
| 43 | 50 | — | 6 PG | — | EDC was | Fluffy, hard |
| | | | 6 AlSi | | added in the | mass |
| | | | 1 drop PPG | | beginning of | |
| | | | NHS, EDC | | bending, not | |
| | | | | | after 2 min | |
| 60 | n/a | 25 | n/a | PG 3, | Good foam | Sample bent |
| | | | | AlSi 3, | | |
| | | | | SDS 0.03, | | |
| | | | | NHS 0.2 | | |
| | | | | EDC 1.0 | | |
| 61 | n/a | 25 | n/a | PG 3, | Good foam | Sample bent |
| | | | | AlSi 5, | | |
| | | | | SDS 0.03, | | |
| | | | | NHS 0.2 | | |
| | | | | EDC 1.0 | | |
| 62 | n/a | 25 | n/a | PG 4, | Good foam | Sample bent |
| | | | | AlSi 3, | | |
| | | | | SDS 0.03, | | |
| | | | | NHS 0.2 | | |
| | | | | EDC 1.0 | | |
| 90 | 50 | 25 | PG 4, | PG 2.5, | Uniform white | Hard 0.1 mm |
| | | | PPG, 0.015, | AlSi 2, | film. Uniform | film, 3 mm foam |
| | | | NHS 0.04, | SDS 0.015 | Foam. | on the top. |
| | | | EDC 0.2, | | | Bottom film is |
| | | | 10 min wait | | | not flexible |
| | | | before top is | | | Not a good |
| | | | spread | | | connection |
| | | | | | | between top |
| | | | | | | and bottom |
| 91 | 25 | 25 | PG 6, | PG 4, | Very thick | Sample bent, |
| | | | TiO2 5, | TiO2 4, | foam, difficult | very hard |
| | | | NHS 0.04, | SDS 0.015 | to spread | |
| | | | EDC 0.2, | | | |
| | | | 30 min wait | | | |
| | | | before top is | | | |
| | | | spread | | | |
| 92 | 25 | 25 | PG 6, | PG 4, | Very thick | Sample bent, |
| | | | TiO2 3, | TiO2 3, | foam, difficult | very hard |
| | | | NHS 0.04, | SDS 0.015 | to spread | |
| | | | EDC 0.2, | | | |
| | | | 30 min wait | | | |
| | | | before top is | | | |
| | | | spread | | | |
| 93 | 25 | 25 | PG 6, | PG 4, | Very thick | Sample bent, |
| | | | TiO2 4, | TiO2 1, | foam, difficult | very hard |
| | | | NHS 0.04, | SDS 0.015 | to spread | |
| | | | EDC 0.2, | | | |
| | | | 20 min wait | | | |
| | | | before top is | | | |
| | | | spread | | | |
| 104 | 100 | — | 4 Porcine | — | Very good | 72 hr: uniform, |
| | | | gelatin | | foam | white film on |
| | | | 4 AlSil | | | bottom |
| | | | 2 TiO₂ | | | |
| 116 | 50 | 50 | 4 Porcine | 4 Porcine | Foam is not | Top: foam is not |
| | | | gelatin | gelatin | very good, | foamy, didn't |
| | | | 4TiO₂ | 0.3 PPG | heavy | dry after 3 days |
| | | | 1 dr PPG | | | Bottom: film is |
| | | | NHS, EDC | | | flexible, a little |
| | | | | | | bit thick |
| 117 | 40 | 40 | 4 Porcine | 4 Porcine | Foam is not | Top: foam is not |
| | | | gelatin | gelatin | very good, | foamy |
| | | | 4TiO₂ | 0.2 PPG | heavy, didn't | Bottom: film is |
| | | | 1 dr PPG | | blended well | flexible, a little |
| | | | NHS, EDC | | | bit thinner than |
| | | | | | | #66 |
| 118 | 30 | 30 | 4 Porcine | 4 Porcine | Foam is not | Top: foam is not |
| | | | gelatin | gelatin | very good, | foamy, heavy |
| | | | 4TiO₂ | 0.1 PPG | heavy | Bottom: film is |
| | | | 1 dr PPG | | | flexible, a little |
| | | | NHS, EDC | | | bit thinner than |
| | | | | | | #66 |
| 119 | 30 | 30 | 4 Porcine | 4 Porcine | Foam is not | Top: foam is not |
| | | | gelatin | gelatin | very good, | foamy |
| | | | 4TiO₂ | 0.1 PPG | heavy | Bottom: good |
| | | | 1 dr PPG | NHS, EDC | | flexible film |
| | | | NHS, EDC | | | |
| 136 | 50 | 25 | 4 Porcine | 4 Porcine | Foam is not | Top foam is |
| | | | gelatin | gelatin | very thick | weak, bottom |
| | | | | 2.5 AlSil | | film rigid |
| | | | | SDS | | |
| 137 | 50 | 50 | 4 Porcine | 4 Porcine | Good solution | Foam dried, |
| | | | gelatin | gelatin | and good | bottom layer |
| | | | 4 AlSil | NHS, EDC | foam | didn't dry in |
| | | | 1 dr PPG | | | 72 hr |
| | | | NHS, EDC | | | |
| 211 | 100 | 0 | 4 Porcine | 0 | Very good | Not bent, |
| | | | gelatin | | uniform foam | uniform |
| | | | 3.5 TiO₂ | | | |
| | | | NHS, EDC | | | |
| 289 | 30 | 20 | 4 Porcine | 4 Porcine | Bottom | Sample is not |
| | | | gelatin | gelatin | solution didn't | good |
| | | | 3.5 TiO₂ | | solidified | |
| | | | 10% Glycerin | | longer. | |
| | | | (to gelatin) | | Top (gelatin) | |
| | | | NHS, EDC | | didn't foam | |
| | | | | | well | |
| 290 | 30 | 20 | 4 Porcine | 4 Porcine | Bottom | Sample is not |
| | | | gelatin | gelatin | solution didn't | good |
| | | | 3.5 TiO₂ | | solidified | |
| | | | 10% | | longer. | |
| | | | Glycerin(to | | Top (gelatin) | |
| | | | gelatin) | | didn't foam | |
| | | | 10% PPG | | well | |
| | | | NHS, EDC | | | |

TABLE 6
SUMMARY TABLE FOR RESULTS DEVICES IN SINKING EXPERIMENTS

| Sample | Sinking Experiment Results - |
|---|---|
| No. | (Sample size and Sinking time) |
| 231 | 6 mm × 12 mm - no foam in sample - sunk in 2 min |
| 177 | 16 mm × 16 mm - 75% removed - sunk in 7 min |
| 48 | Sunk in 10 min |
| 31 | sunk in 15 min |
| 84 | 6 mm × 18 mm sample - 0% removed -sunk in 20 m |
| 250 | 8 mm × 15 mm, 3 mm foam 25% removed - sunk in 25 min |
| 83 | 6 mm × 18 mm sample - 0% removed - sunk in 30 m |
| 128 | 25% removed - sunk in 30 min |
| 133 | 25% removed -sunk in 30 min |
| 187 | 16 mm × 16 mm - 75% removed - sunk in 30 m |
| 205 | 18 mm × 6 mm - 25% removed (left top) - sunk in 35 m |
| 308 | 8 mm × 7 mm - sunk in 40 min |
| 85 | 6 mm × 18 mm sample - 0% removed -sunk in 60 m |
| 94 | 6 mm × 15 mm, all foam left - sunk in 60 m |
| 100 | sunk in 60 min |
| 227 | 8 mm × 12 mm - 75% removed 3 mm foam - sunk in 1 h |
| 252 | 8 mm × 15 mm, 3 mm foam 25% removed - sunk in 90 min |
| 286 | 8 mm × 25 mm - 0% removed - sunk in 2 h |
| 6 | sunk in 2 hr |
| 19 | sunk in 3 hr |
| 58 | sunk in 3 hr |
| 158 | 75% removed - sunk in 3 h |
| 317 | 8 mm × 7 mm -25% removed - sunk in 3 h |
| 132 | 25% removed - sunk in 4 hrs. 40 min |
| 135 | 30% removed - sunk in 4 hrs. 40 min |
| 7 | sunk in 5 hr |
| 21 | sunk in 6 hr |
| 150 | 75% removed -sunk in 6 h |
| 176 | 25% removed - sunk in 6 h |
| 285 | 8 mm × 25 mm - 0% removed - sunk in 6 h |
| 305 | 8 mm × 7 mm - sunk in 6 h 40 m |
| 302 | 8 mm × 15 mm - sunk in 7 hr |
| 307 | 8 mm × 7 mm - sunk in 7 hr 20 m |
| 33 | sunk in 8 hr |
| 261 | 8 mm × 15 mm - 0% removed - sunk in 8 h |
| 267 | 8 mm × 15 mm - 25% removed - sunk in 8 hr |
| 215 | 12 mm × 22 mm - 75% removed 1 mm foam - sunk - in 9 h |
| 258 | 8 mm × 25 mm, 3 mm foam 25% removed - sunk in 9 hr |
| 284 | 8 mm × 25 mm - 0% removed - sunk in 10 h |
| 50 | Sunk in 11 hr |
| 54 | Sunk in 11 hr |
| 111 | sunk in 11 hr |
| 143 | 75% removed - sunk in 11 hr |
| 256 | 8 mm × 25 mm, 3 mm foam 25% removed -sunk in 11 hr |
| 59 | sunk in 12 hr |
| 228 | 8 mm × 12 mm - 75% removed 3mm foam - sunk in 13 h |
| 156 | 75% removed - sunk in 14 h |
| 282 | 8 mm × 25 mm - 0% removed - sunk in 14 h |
| 32 | sunk in 15 hr |
| 98 | 8 mm × 16 mm, all foam left- sunk in 15 h |
| 141 | 75% removed - sunk in 15 h |
| 216 | 12 mm × 22 mm - 75% removed 1 mm foam - sunk - in 15 h |
| 232 | 7 mm × 12.5 mm - 50% removed - sunk in 15 h |
| 312 | 7 mm × 15 mm -50% removed - sunk in 15 h 20 m |
| 30 | Sunk in 16 hr |
| 99 | sunk in 16 hr |
| 164 | 75% removed - sunk in 16 h |
| 112 | sunk in 17 hr |
| 319 | 8 mm × 15 mm - sunk in 17 hr |
| 144 | 75% removed -sunk in 19 hr |
| 235 | 7 mm × 12.5 mm - 50% removed - sunk in 19 h |
| 277 | 8 mm × 25 mm - 0% removed - sunk in 20 h |
| 278 | 8 mm × 25 mm - 0% removed - sunk in 20 h |
| 292 | 8 mm × 15 mm - 50% removed - sunk in 20 hr |
| 293 | 8 mm × 15 mm - 50% removed - sunk in 20 hr |
| 304 | 8 mm × 15 mm - sunk in 20 hr |
| 318 | 8 mm × 7 mm -25% removed - sunk in 20 h |
| 34 | sunk in 21 hr |
| 103 | sunk in 21 hr |
| 257 | 8 mm × 25 mm, 3 mm foam 25% removed - sunk in 21 hr |
| 229 | 8 mm × 12 mm - 75% removed 3 mm foam - sunk in 22 h |
| 212 | 12 mm × 22 mm - 25% removed 1 mm foam - sunk in in 23 h |
| 161 | 75% removed - sunk <24 h |
| 288 | 8 mm × 25 mm - 0% removed - sunk in 24 h |
| 197 | 16 mm × 16 mm - 66% removed (left middle) - sunk in 27 h |
| 316 | 8 mm × 7 mm -25% removed - sunk in 27 h |
| 110 | sunk in 29 hr |
| 262 | 8 mm × 15 mm - 0% removed - sunk in 1 d 11 h |
| 300 | 8 mm × 15 mm - sunk in 35 hr |
| 102 | sunk in 36 hr |
| 294 | 8 mm × 15 mm - 50% removed - sunk in 38 hr |
| 69 | sunk in 42 hrs |
| 247 | 8 mm × 15 mm, 3 mm foam 0% removed - sunk in 1 d 19 h |
| 180 | 16 mm × 16 mm - 50% removed - sunk in 44 h |
| 201 | 18 mm × 6 mm - 66% removed (left top) -sunk in 44 h |
| 207 | 18 mm × 6 mm - 25% removed (left top) - sunk in 44 h |
| 217 | 12 mm × 22 mm - 75% removed 1 mm foam - sunk - in 44 h |
| 70 | Sunk in 48 hrs |
| 157 | 75% removed - sunk in 48 h |
| 200 | 18 mm × 6 mm - 66% removed (left top) -sunk in 48 h |
| 246 | 8 mm × 15 mm, 3 mm foam 0% removed - sunk in 2 d 4 h |
| 181 | 18 mm × 6 mm - 50% removed - sunk in 53 h |
| 274 | 8 mm × 25 mm - 0% removed - sunk in 2 d 7 hr |
| 241 | 12 mm × 22 mm - sunk in 60 h |
| 179 | 16 mm × 16 mm - 50% removed - sunk in 68 h |
| 236 | 7 mm × 12.5 mm - 50% removed - sunk in 72 hr |
| 260 | 8 mm × 15 mm - 0% removed - sunk in 3 d 16 h |
| 245 | 8 mm × 15 mm, 3 mm foam 0% removed - sunk in 3 d 20 h |
| 263 | 8 mm × 15 mm - 0% removed - sunk in 3 d 20 h |
| 264 | 8 mm × 15 mm - 0% removed - sunk in 3 d 20 h |
| 275 | 8 mm × 25 mm - 0% removed - sunk in 4 d |
| 276 | 8 mm × 25 mm - 0% removed - sunk in 4 d |
| 23 | sunk immediately* |
| 24 | sunk immediately |
| 29 | sunk immediately |
| 44 | sunk immediately |
| 45 | sunk immediately |
| 80 | 6 mm × 18 mm sample - 50% removed - sunk immediately |
| 81 | 6 mm × 18 mm sample - 75% removed - sunk immediately |
| 82 | 6 mm × 18 mm sample - 75% removed - sunk immediately |
| 86 | 6 mm × 12 mm sample - 25% removed - sunk immediately |
| 87 | 6 mm × 12 mm sample - 25% removed - sunk immediately |
| 88 | 6 mm × 12 mm sample - 25% removed - sunk immediately |
| 89 | 6 mm × 12 mm sample - 25% removed - sunk immediately |
| 95 | 6 mm × 15 mm; 50% - sunk immediately |
| 96 | 6 mm × 6 mm; 50% removed - sunk immediately |
| 97 | 6 mm × 1 5 mm; 25% removed - sunk immediately |
| 120 | sunk immediately |
| 121 | sunk immediately |
| 122 | sunk immediately |
| 123 | sunk immediately |
| 124 | sunk immediately |
| 125 | 50% removed -sunk immediately |
| 126 | 50% removed -sunk immediately |
| 127 | 25% removed -sunk immediately |
| 130 | 50% removed -sunk immediately |
| 131 | 50% removed -sunk immediately |
| 134 | 30% removed -sunk immediately |
| 140 | 75% removed - sunk immediately |
| 142 | 75% removed - sunk immediately |
| 165 | sunk immediately |
| 166 | sunk immediately |
| 167 | sunk immediately |
| 168 | 75% removed - sunk immediately |
| 169 | 75% removed - sunk immediately |
| 170 | 50% removed - sunk immediately |
| 171 | 50% removed - sunk immediately |
| 172 | 50% removed - sunk immediately |
| 173 | 25% removed - sunk immediately |
| 175 | 25% removed - sunk immediately |
| 178 | 16 mm × 16 mm - 75% removed- sunk immediately |
| 184 | 18 mm × 6 mm - 66% removed - sunk immediately |
| 185 | 18 mm × 6 mm - 66% removed - sunk immediately |
| 186 | 18 mm × 6 mm - 66% removed - sunk immediately |
| 188 | 16 mm × 16 mm - 75% removed - sunk immediately |
| 195 | 16 mm × 16 mm - 25% removed - sunk immediately |
| 196 | 16 mm × 16 mm - 66% removed (left middle) - sunk immediately |
| 208 | 18 mm × 6 mm - 75% removed (left top) - sunk immediately |
| 209 | 18 mm × 6 mm - 75% removed (left top) - sunk immediately |
| 210 | 18 mm × 6 mm - 75% removed (left top) - sunk immediately |
| 230 | 6 mm × 12 mm - no foam in sample - sunk immediately |
| 248 | 8 mm × 15 mm, 3 mm foam 0% removed - sunk immediately |
| 249 | 8 mm × 15 mm, 3 mm foam 0% removed - sunk immediately |
| 251 | 8 mm × 15 mm, 3 mm foam 25% removed - sunk immediately |
| 253 | 8 mm × 15 mm, 3 mm foam 25% removed - sunk immediately |
| 254 | 8 mm × 15 mm, 3 mm foam 25% removed - sunk immediately |
| 255 | 8 mm × 15 mm, 3 mm foam 25% removed - sunk immediately |
| 265 | 8 mm × 15 mm - 25% removed - sunk immediately |
| 266 | 8 mm × 15 mm - 25% removed - sunk immediately |
| 268 | 8 mm × 15 mm - 25% removed - sunk immediately |
| 269 | 8 mm × 15 mm - 25% removed - sunk immediately |
| 270 | 8 mm × 15 mm - 25% removed - sunk immediately |
| 271 | 8 mm × 25 mm - 25% removed - sunk immediately |
| 272 | 8 mm × 25 mm - 25% removed - sunk immediately |
| 273 | 8 mm × 25 mm - 25% removed - sunk immediately |
| 295 | 8 mm × 15 mm - 50% removed - sunk immediately |
| 301 | 8 mm × 15 mm - sunk immediately |
| 303 | 8 mm × 15 mm - sunk immediately |
| 313 | 7 mm × 15 mm -50% removed -sunk immediately |
| 314 | 7 mm × 15 mm -50% removed -sunk immediately |
| 315 | 7 mm × 15 mm -50% removed -sunk immediately |
| 114 | sunk after shaking |
| 145 | 75% removed -floats >48 h, but sunk when touched |
| 149 | 75% removed -floats >48 h, but sunk when touched |
| 198 | 16 mm × 16 mm - 66% removed (left middle) - floats >48 h, but sunk when touched |
| 199 | 18 mm × 6 mm - 66% removed (left top) - floats, but sunk when touched |
| 202 | 18 mm × 6 mm - 50% removed (left top) - floats, but sunk when touched |
| 71 | Floated for 5 days, but sunk when touched |
| 1 | Floats >24 hr |
| 2 | Floats >24 hr |
| 3 | Floats >24 hr |
| 4 | Floats >24 hr |
| 5 | Floats >24 hr |
| 8 | Floats >24 hr |
| 9 | Floats >24 hr |
| 10 | Floats >24 hr |
| 11 | Floats >24 hr |
| 12 | Floats >24 hr |
| 13 | Floats >24 hr |
| 14 | Floats >24 hr |
| 15 | Floats >24 hr |
| 16 | Floats >24 hr |
| 17 | Floats >24 hr |
| 18 | Floats >24 hr |
| 20 | Floats >24 hr |
| 22 | Floats >24 hr |
| 25 | Floats >24 hr |
| 26 | Floats >24 hr |
| 27 | Floats >24 hr |
| 28 | Floats >24 hr |
| 35 | Floats >24 hr |
| 36 | Floats >24 hr |
| 37 | Floats >24 hr |
| 38 | Floats >24 hr |
| 39 | Floats >24 hr |
| 40 | Floats >24 hr |
| 41 | Floats >24 hr |
| 42 | Floats >24 hr |
| 46 | Floats >24 hr |
| 47 | Floats >24 hr |
| 49 | Floats >24 hr |
| 51 | Floats >24 hr |
| 52 | Floats >24 hr |
| 53 | Floats >24 hr |
| 55 | Floats >24 hr |
| 56 | Floats >24 hr |
| 57 | Floats >24 hr |
| 75 | Floats >24 hr |
| 76 | Floats >24 hr |
| 78 | Floats >24 hr |
| 79 | Floats >24 hr |
| 113 | Floats >24 hr |
| 139 | 50% removed -floats >24 h |
| 291 | 8 mm × 15 mm - 50% removed - floats >36 hr |
| 296 | 8 mm × 15 mm - 50% removed - floats >36 hr |
| 297 | 8 mm × 15 mm - 50% removed - floats >36 hr |
| 298 | 8 mm × 15 mm - 50% removed - floats >36 hr |
| 299 | 8 mm × 15 mm - 50% removed - floats >36 hr |
| 151 | 50% removed -floats >40 h |
| 152 | 50% removed -floats >40 h |
| 153 | 25% removed -floats >40 h |
| 154 | 25% removed -floats >40 h |
| 155 | 25% removed -floats >40 h |
| 159 | 75% removed - floats >40 h |
| 160 | 75% removed - floats >40 h |
| 213 | 12 mm × 22 mm - 25% removed 1 mm foam - floats >44 h |
| 214 | 12 mm × 22 mm - 25% removed 1 mm foam - floats >44 h |
| 218 | 8 mm × 12 mm - 50% removed 1.5 mm foam - floats >44 h |
| 219 | 8 mm × 12 mm - 50% removed 1.5 mm foam - floats >44 h |
| 220 | 8 mm × 12 mm - 50% removed 1.5 mm foam - floats >44 h |
| 221 | 12 mm × 22 mm - 75% removed 3 mm foam - floats >44 h |
| 222 | 12 mm × 22 mm - 75% removed 3 mm foam - floats >44 h |
| 223 | 12 mm × 22 mm - 75% removed 3 mm foam - floats >44 h |
| 224 | 12 mm × 22 mm - 75% removed 3 mm foam - floats >44 h |
| 225 | 12 mm × 22 mm - 75% removed 3 mm foam - floats >44 h |
| 226 | 12 mm × 22 mm - 75% removed 3 mm foam - floats >44 h |
| 63 | Floats >48 hr |
| 64 | Floats >48 hr |
| 65 | Floats >48 hr |
| 66 | Floats >48 hr |
| 67 | Floats >48 hr |
| 68 | Floats >48 hr |
| 101 | Floats >48 hr |
| 105 | Floats >48 hr |
| 106 | Floats >48 hr |
| 107 | Floats >48 hr |
| 108 | Floats >48 hr |
| 109 | Floats >48 hr |
| 146 | 50% removed -floats >48 h |
| 147 | 50% removed -floats >48 h |
| 148 | 25% removed -floats >48 h |
| 174 | 25% removed - floats >48 h |
| 182 | 18 mm × 6 mm - 50% removed - floats >48 h |
| 183 | 18 mm × 6 mm - 50% removed - floats >48 h |
| 189 | 16 mm × 16 mm - 50% removed - floats half-way >48 |
| 190 | 16 mm × 16 mm - 50% removed - floats half-way >48 |
| 191 | 16 mm × 16 mm - 50% removed - floats half-way >48 |
| 192 | 16 mm × 16 mm - 25% removed- floats horizontal position >48 hrs |
| 193 | 16 mm × 16 mm - 25% removed- floats horizontal position >48 hrs |
| 194 | 16 mm × 16 mm - 25% removed- floats horizontal position >48 hrs |
| 203 | 18 mm × 6 mm - 50% removed (left top) - floats >48 |
| 204 | 18 mm × 6 mm - 50% removed (left top) - floats >48 |
| 206 | 18 mm × 6 mm - 25% removed (left top)- floats >48 |
| 163 | 50% removed - floats >50 h |
| 320 | 8 mm × 15 mm - floats >2.5 d |
| 321 | 8 mm × 15 mm - floats >2.5 d |
| 322 | 8 mm × 15 mm - floats >2.5 d |
| 72 | Float >72 hrs |
| 73 | Floats >72 hr |
| 74 | Floats >72 hr |
| 77 | Float >72 hrs. |
| 115 | Floats >72 h |
| 129 | When immersed in Formalin, foam soaked, but the three samples were floating |
| | for >72 hr |
| 233 | 7 mm × 12.5 mm - 50% removed - floats >72 h |
| 234 | 7 mm × 12.5 mm - 50% removed - floats >72 h |
| 237 | 7 mm × 12.5 mm - 50% removed - floats >72 h |
| 238 | 12 mm × 22 mm - floats >72 h |
| 239 | 12 mm × 22 mm - floats >72 h |
| 240 | 12 mm × 22 mm - floats >72 h |
| 242 | 12 mm × 22 mm - floats >72 h |
| 243 | 12 mm × 22 mm - floats >72 h |
| 279 | 8 mm × 25 mm - 0% removed - floats >3 d |
| 280 | 8 mm × 25 mm - 0% removed - floats >3 d |
| 281 | 8 mm × 25 mm - 0% removed - floats >3 d |
| 283 | 8 mm × 25 mm - 0% removed - floats >3 d |
| 287 | 8 mm × 25 mm - 0% removed - floats >3 d |
| 309 | 8 mm × 7 mm - floats >3 d |
| 310 | 15 mm × 15 mm - floats >3 d |
| 311 | 15 mm × 15 mm - floats >3 d |
| 259 | 8 mm × 15 mm - 0% removed - floats >3 d 20 h |
| 162 | 75% removed - floats >95 h |
| 138 | floats after 4 days |
| 244 | 8 mm × 15 mm, 3 mm foam 0% removed - floats >5 d |
| 306 | 8 mm × 7 mm - floats >3 d |
| 43 | n/a |
| 60 | n/a |
| 61 | n/a |
| 62 | n/a |
| 90 | n/a |
| 91 | n/a |
| 92 | n/a |
| 93 | n/a |
| 104 | n/a |
| 116 | n/a |
| 117 | n/a |
| 118 | n/a |
| 119 | n/a |
| 136 | n/a |
| 137 | No experiment, didn't dry completely |
| 211 | Will be used in coating with solution experiments |
| 289 | No sinking experiment |
| 290 | No sinking experiment |

Although various embodiments of the invention are disclosed herein, many adaptations and modifications may be made within the scope of the invention in accordance with the common general knowledge of those skilled in this art. Such modifications include the substitution of known equivalents for any aspect of the invention in order to achieve the same result in substantially the same way. Numeric ranges are inclusive of the numbers defining the range. Furthermore, numeric ranges are provided so that the range of values is recited in addition to the individual values within the recited range being specifically recited in the absence of the range. The word “comprising” is used herein as an open-ended term, substantially equivalent to the phrase “including, but not limited to”, and the word “comprises” has a corresponding meaning. As used herein, the singular forms “a”, “an” and “the” include plural references unless the context clearly dictates otherwise. Thus, for example, reference to “a thing” includes more than one such thing. Citation of references herein is not an admission that such references are prior art to the present invention. Furthermore, material appearing in the background section of the specification is not an admission that such material is prior art to the invention. Any priority document(s) are incorporated herein by reference as if each individual priority document were specifically and individually indicated to be incorporated by reference herein and though fully set forth herein. The invention includes all embodiments and variations substantially as hereinbefore described and with reference to the examples and drawings.

1. A device for measuring an adequate exposure of a tissue sample to a treatment medium, wherein visual inspection of the device after the device and the tissue sample are contacted with the treatment medium provides for measuring the adequate exposure without direct inspection of the tissue sample, the device comprising:
a) a compound operable to change a perceived colour of the device when the compound is adequately exposed to the treatment medium;
b) a surface for supporting the compound; and
c) a transparent body connected to the surface, the transparent body being impenetrable by the treatment medium and being operable to control contact between the compound and the treatment medium when in the treatment container, wherein the compound is protected from complete immediate exposure to the treatment medium by being between the surface and the transparent body.

2. The device of claim 1 wherein:
a) the compound comprises at least one high dispersed colloidal particle component selected from the group consisting of Silica, Alumina, Titania, mixed oxides, and mixtures thereof and the compound further comprises the at least one component mixed with a polymer; and
b) the surface for supporting the compound is coloured to provide a contrast to enhance a colour change effected by the compound when the compound is adequately exposed to the treatment medium and the change to the perceived colour of the device is effected by an increase in the transparency of the compound.

3. The device of claim 2 wherein the polymer is selected from the group consisting of: a polyvinylpyrrolidone (PVP), a poly-butyl-methacrylate (PBMA), a polypropylene, and a complex copolymer.

4. The device of claim 3 wherein the polymer is a complex of poly-vinyl-butyral co-vinyl-alcohol-co-vinyl acetate (PVB-PVA).

5. The device of claim 1 wherein the transparent body comprises a hole.

6. The device of claim 1 wherein the surface for supporting the compound is a polymeric film selected from the group consisting of: polyvinyl, polyethylene, polypropylene or copolymers.

7. The device of claim 1 wherein the surface for supporting the compound is coloured to provide a contrast to enhance the perception of a colour change effected by the compound when the compound is exposed to the treatment medium and the change to the perceived colour of the device is effected by an increase in the transparency of the compound.

8. The device of claim 7 wherein the surface is red.

9. The device of claim 1 wherein the surface is a surface of a treatment container.

10. The device of claim 1 wherein the transparent body is glass.

11. The device of claim 1 wherein the transparent body is a polymeric film.

12. The device of claim 11 wherein the polymeric film is selected from the group consisting of: a polyvinylpyrrolidone (PVP), a poly-butyl-methacrylate (PBMA), a polypropylene, and a complex copolymer.

13. The device of claim 11 wherein the polymeric film is a complex of poly-vinyl-butyral co-vinyl-alcohol-co-vinyl acetate (PVB-PVA).

14. A device for measuring an adequate exposure of a tissue sample to a treatment medium, wherein visual inspection of the device after the device and the tissue sample are contacted with the treatment medium provides for measuring the adequate exposure without direct inspection of the tissue sample, the device comprising:
a) a foam layer;
b) a film layer coating at least a portion of the outside of the foam layer;
c) a density increasing agent;
d) a softening agent; and
e) at least one foam stabilizing agent.

15. The device of claim 14 wherein the adequate exposure is indicated by a change in a position of the device relative to a top surface of the treatment medium.

16. The device of claim 14 wherein the foam layer comprises gelatin.

17. The device of claim 14 wherein the film layer comprises gelatin.

18. The device of claim 14 wherein the density increasing agent is selected from at least one of the group consisting of Aluminosilicate, and Titanium Dioxide.

19. The device of claim 14 wherein the softening agent comprises at least one selected from the group consisting of: polypropylene glycol, and glycerin.

20. The device of claim 14 wherein the foam stabilizing agent comprises Sodium Dodecyl Sulfonate, N-Hydroxysuccinimde, and 1-ethyl-3-(3-dimethylaminoproply)carbodiimide.

21. The device of claim 14 wherein
a) the foam layer comprises gelatin;
b) the film layer comprises gelatin;
c) the density increasing agent is selected from at least one of the group consisting of Aluminosilicate, and Titanium Dioxide;
d) the softening agent comprises at least one selected from the group consisting of: polypropylene glycol, and glycerin; and
e) the foam stabilizing agent comprises Sodium Dodecyl Sulfonate, N-Hydroxysuccinimde, and 1-ethyl-3-(3-dimethylaminoproply)carbodiimide.

22. A device for measuring an exposure of a tissue sample to a treatment medium, wherein visual inspection of the device after the device and the tissue sample are contacted with the treatment medium provides for measuring the exposure without direct inspection of the tissue sample and the visual inspection comprises a change in a position of the device relative to a top surface of the treatment medium.

23. The device of claim 1 wherein the treatment medium comprises at least one of formalin, ethanol or xylene.

24. A method for visually determining that a tissue sample has been adequately exposed to a treatment medium, the method comprising:
a) adding a tissue sample to a treatment container;
b) adding the device of claim 1 to the treatment container;
c) adding the treatment medium to the treatment container; and
d) exposing the tissue sample and the device to the treatment medium at about the same time and until the device provides a visual indication that adequate exposure has been attained.

25. The method of claim 24 wherein the treatment container is provided with the treatment medium already within the treatment container prior to adding the tissue sample and the device.

26. The method of claim 24 wherein the device is included as part of the treatment container and upon adding the tissue sample, the device is exposed to the treatment medium at about the same time as the tissue sample.

27. The method of claim 24 wherein the treatment container comprises the device attached to a surface of the treatment container, which surface is exposed to the treatment medium when the tissue sample is added.

28. The method of claim 24 wherein the method further comprises inspection of the device by a computerized method wherein an output of a digital image capture device is further processed by a computer to quantify a change in the device, thereby determining adequate exposure.

29. A treatment container for exposing a tissue sample to a treatment medium, the treatment container comprising the device of claim 1.

30. The treatment container of claim 29 wherein the device is affixed to an inside surface of the treatment container.

31. The treatment container of 29 wherein the treatment container is a flask, a Petri dish, a test tube, bottle, jar, tub, bucket, cassette, a specially designed container for tissue sample processing, a specially designed container for tissue sample handling, or a specially designed container for tissue sample storage.
